(19) United States
(12) Patent Application Publication
(10) Pub. No.: US 2025/0220248 A1
(43) Pub. Date: Jul. 3, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Yue LI, Los Angeles, CA (US); Ye-Kui WANG, Los Angeles, CA (US); Junru LI, Los Angeles, CA (US); Chaoyi LIN, Beijing (CN); Kai ZHANG, Los Angeles, CA (US); Li ZHANG, Los Angeles, CA (US)

(21) Appl. No.: 19/087,286

(22) Filed: Mar. 21, 2025

Related U.S. Application Data
(63) Continuation of application No. PCT/CN2023/120486, filed on Sep. 21, 2023.

(30) Foreign Application Priority Data
Sep. 21, 2022 (WO) PCT/CN2022/120116

(51) Int. Cl. H04N 19/86; H04N 19/117; H04N 19/159; H04N 19/172; H04N 19/70

(52) U.S. Cl. CPC H04N 19/86; H04N 19/117; H04N 19/159; H04N 19/172; H04N 19/70

(57) ABSTRACT

Embodiments of the present disclosure provide a solution for video processing. A method for video processing is proposed. The method comprises: applying, for a conversion between a current video unit of a video and a bitstream of the video, a neural network filter to the current video unit at least based on auxiliary information associated with the current video unit, the auxiliary information including at least one of: prediction information of the current video unit, partitioning information of the current video unit, or coding information of a previously coded video unit; and performing the conversion based on the applying.

### CROSS-REFERENCE TO RELATED APPLICATIONS

This application is a continuation of International Application No. PCT/CN2023/120486, filed on Sep. 21, 2023, which claims the benefit of International Application No. PCT/CN2022/120116 filed on Sep. 21, 2022. The entire contents of these applications are hereby incorporated by reference in their entireties.

### FIELDS

Embodiments of the present disclosure relates generally to video processing techniques, and more particularly, to neural network filter for video processing.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: applying, for a conversion between a current video unit of a video and a bitstream of the video, a neural network filter to the current video unit at least based on auxiliary information associated with the current video unit, the auxiliary information including at least one of: prediction information of the current video unit, partitioning information of the current video unit, or coding information of a previously coded video unit; and performing the conversion based on the applying. The method in accordance with the first aspect of the present disclosure uses the auxiliary information to improve the performance of the neural network filter such as the neural network post-processing filter, and thus can improve the coding efficiency and coding effectiveness of video coding.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: applying a neural network filter to a current video unit of the video at least based on auxiliary information associated with the current video unit, the auxiliary information including at least one of: prediction information of the current video unit, partitioning information of the current video unit, or coding information of a previously coded video unit; and generating the bitstream based on the applying.

In a fifth aspect, a method for storing a bitstream of a video is proposed. The method comprises: applying a neural network filter to a current video unit of the video at least based on auxiliary information associated with the current video unit, the auxiliary information including at least one of: prediction information of the current video unit, partitioning information of the current video unit, or coding information of a previously coded video unit; generating the bitstream based on the applying; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRA WINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

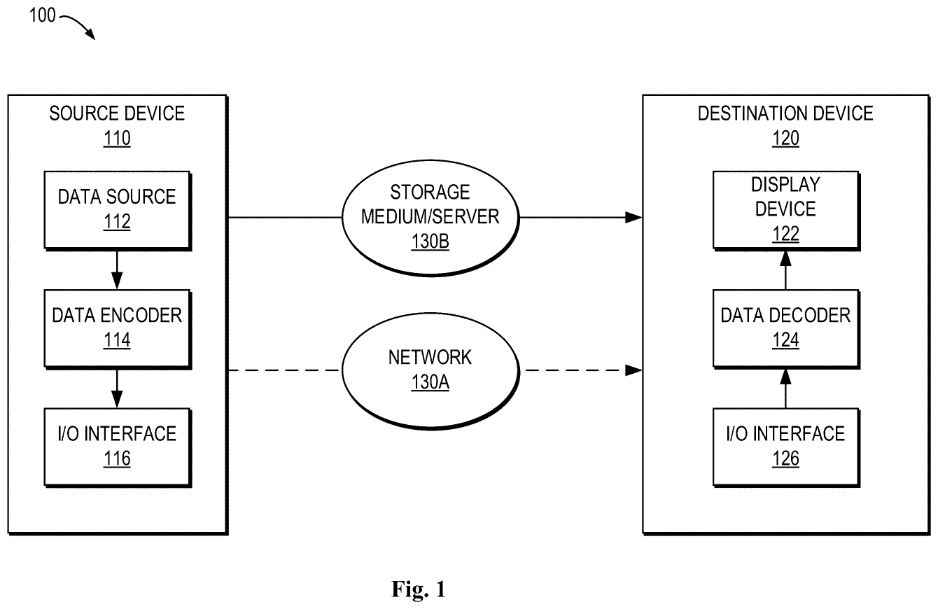

FIG. 1 illustrates a block diagram that illustrates an example video coding system, in accordance with some embodiments of the present disclosure;

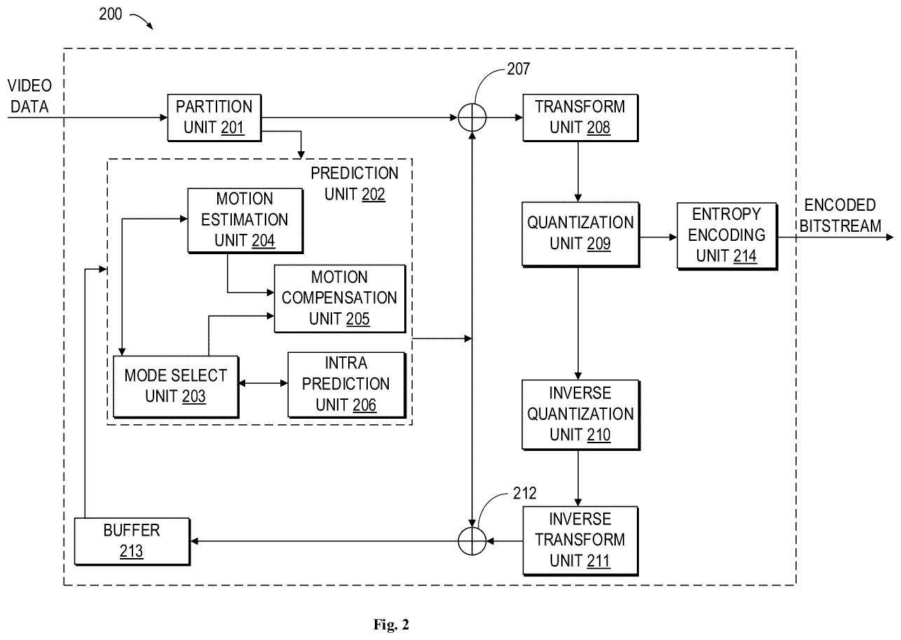

FIG. 2 illustrates a block diagram that illustrates a first example video encoder, in accordance with some embodiments of the present disclosure;

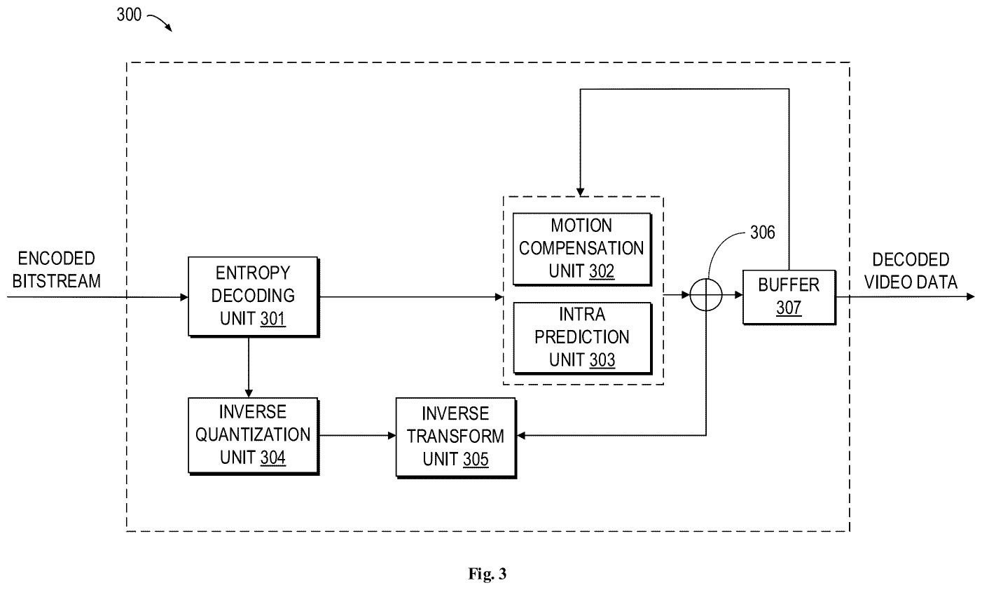

FIG. 3 illustrates a block diagram that illustrates an example video decoder, in accordance with some embodiments of the present disclosure;

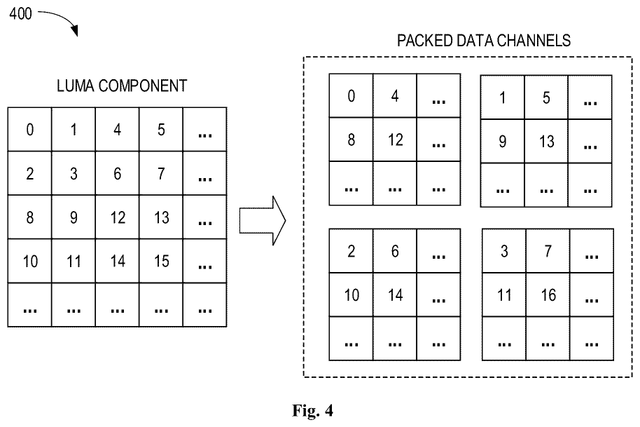

FIG. 4 illustrates an illustration of luma data channels of nnpfc_inp_order_idc equal to 3 (informative);

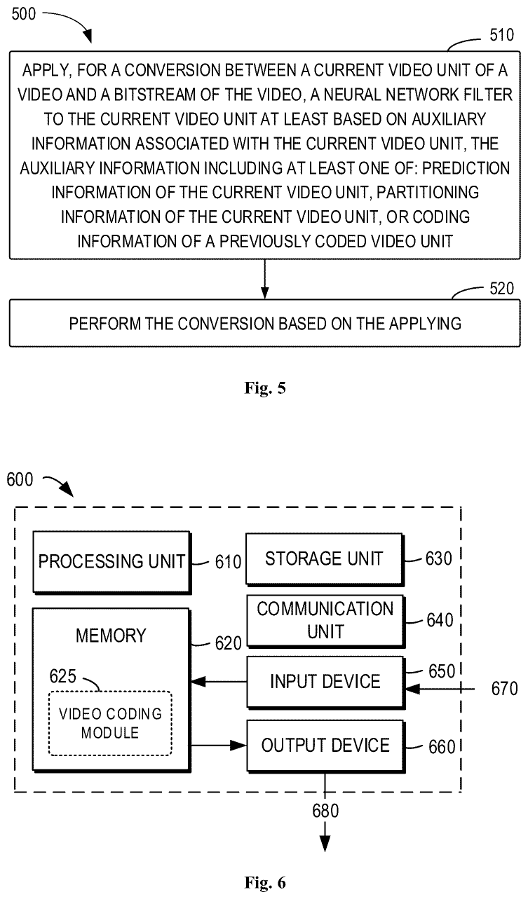

FIG. 5 illustrates a flowchart of a method for video processing in accordance with embodiments of the present disclosure;

FIG. 6 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment.” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

This disclosure is related to image/video coding technologies. Specifically, it is related to the improvement of neural-network post-processing filters. The improvements include signalling of visual quality improvement types, signalling of more auxiliary input data, dealing with different chroma components, and removing invalid operation from existing neural-network post-processing filters. The ideas may be applied individually or in various combinations, for video bitstreams coded by any codec, e.g., the versatile video coding (VVC) standard and/or the versatile SEI messages for coded video bitstreams (VSEI) standard.

### 2. ABBREVIATIONS

APS Adaptation Parameter Set
AU Access Unit
CLVS Coded Layer Video Sequence
CLVSS Coded Layer Video Sequence Start
CRC Cyclic Redundancy Check
CVS Coded Video Sequence
FIR Finite Impulse Response
IRAP Intra Random Access Point
NAL Network Abstraction Layer
PPS Picture Parameter Set
PU Picture Unit
RASL Random Access Skipped Leading
SEI Supplemental Enhancement Information
STSA Step-wise Temporal Sublayer Access
VCL Video Coding Layer
VSEI versatile supplemental enhancement information (Rec. ITU-T H.274|ISO/IEC 23002-7)
VUI Video Usability Information
VVC versatile video coding (Rec. ITU-T H.266|ISO/IEC 23090-3)

### 3. INTRODUCTION

### 3.1. Video Coding Standards

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET was later renamed to be the Joint Video Experts Team (JVET) when the Versatile Video Coding (VVC) project officially started. VVC is the new coding standard, targeting at 50% bitrate reduction as compared to HEVC, that has been finalized by the JVET at its 19th meeting ended at Jul. 1, 2020.

The Versatile Video Coding (VVC) standard (ITU-T H.266|ISO/IEC 23090-3) and the associated Versatile Supplemental Enhancement Information for coded video bitstreams (VSEI) standard (ITU-T H.274|ISO/IEC 23002-7) have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard that has recently been developed by MPEG.

### 3.2. SEI Messages in General and in VVC and VSEI

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

Annex D of VVC specifies syntax and semantics for SEI message payloads for some SEI messages, and specifies the use of the SEI messages and VUI parameters for which the syntax and semantics are specified in ITU-T H.274| ISO/IEC 23002-7.

### 3.3. Signalling of Neural-Network Post-Filters

The specification of two SEI messages for signalling of neural-network post-filters is shown as follows.

### Neural-Network Post-Filter Characteristics SEI Message

### Neural-Network Post-Filter Characteristics SEI Message Syntax

| | Descriptor |
|---|---|
| nn_post_filter_characteristics( payloadSize ) { | |
| nnpfc_id | ue(v) |
| nnpfc_mode_idc | ue(v) |
| nnpfc_purpose_and_formatting_flag | u(1) |
| if( nnpfc_purpose_and_formatting_flag ) { | |
| nnpfc_purpose | ue(v) |
| if( nnpfc_purpose = = 2 ∥ nnpfc_purpose = = 4 ) | |
| nnpfc_out_sub_c_flag | u(1) |
| if( nnpfc_purpose = = 3 ∥ nnpfc_purpose = = 4 ) { | |
| nnpfc_pic_width_in_luma_samples | ue(v) |
| nnpfc_pic_height_in_luma_samples | ue(v) |
| } | |
| nnpfc_component_last_flag | u(1) |
| nnpfc_inp_format_flag | u(1) |
| if( nnpfc_inp_format_flag = = 1 ) | |
| nnpfc_inp_tensor_bitdepth_minus8 | ue(v) |
| nnpfc_inp_order_idc | ue(v) |
| nnpfc_auxiliary_inp_idc | ue(v) |
| nnpfc_separate_colour_description_present_flag | u(1) |
| if( nnpfc_separate_colour_description_present_flag ) { | |
| nnpfc_colour_primaries | u(8) |
| nnpfc_transfer_characteristics | u(8) |
| nnpfc_matrix_coeffs | u(8) |
| } | |
| nnpfc_out_format_flag | u(1) |
| if( nnpfc_out_format_flag = = 1 ) | |
| nnpfc_out_tensor_bitdepth_minus8 | ue(v) |
| nnpfc_out_order_idc | ue(v) |
| nnpfc_constant_patch_size_flag | u(1) |
| nnpfc_patch_width_minus1 | ue(v) |
| nnpfc_patch_height_minus1 | ue(v) |
| nnpfc_overlap | ue(v) |
| nnpfc_padding_type | ue(v) |
| if( nnpfc_padding_type = = 4 ){ | |
| nnpfc_luma_padding_val | ue(v) |
| nnpfc_cb_padding_val | ue(v) |
| nnpfc_cr_padding_val | ue(v) |
| } | |
| nnpfc_complexity_idc | ue(v) |
| if( nnpfc_complexity_idc > 0 ) | |
| nnpfc_complexity_element( nnpfc_complexity_idc ) | |
| if( nnpfc_mode_idc = = 2 ) { | |
| while( !byte_aligned( ) ) | |
| nnpfc_reserved_zero_bit | u(1) |
| nnpfc_uri_tag[ i ] | st(v) |
| nnpfc_uri[ i ] | st(v) |
| } | |
| } | |
| /* filter specified or updated by ISO/IEC 15938-17 bitstream */ | |
| if( nnpfc_mode_idc = = 1 ) { | |
| while( !byte_aligned( ) ) | |
| nnpfc_reserved_zero_bit | u(1) |
| for( i = 0; more_data_in_payload( ); i++ ) | |
| nnpfc_payload_byte[ i ] | b(8) |
| } | |
| } | |

| | Descriptor |
|---|---|
| nnpfc_complexity_element( nnpfc_complexity_idc ) { | |
| if( nnpfc_complexity_idc = = 1 ) { | |
| nnpfc_parameter_type_idc | u(2) |
| if (nnpfc_parameter_type_idc ! = 2) | |
| nnpfc_log2_parameter_bit_length_minus3 | u(2) |
| nnpfc_num_parameters_idc | u(6) |
| nnpfc_num_kmac_operations_idc | ue(v) |
| } | |
| } | |

### Neural-Network Post-Filter Characteristics SEI Message Semantics

This SEI message specifies a neural network that may be used as a post-processing filter. The use of specified post-processing filters for specific pictures is indicated with neural-network post-filter activation SEI messages. Use of this SEI message requires the definition of the following variables:
Cropped decoded output picture width and height in units of luma samples, denoted herein by CroppedWidth and CroppedHeight, respectively.
Luma sample array CroppedYPic[x][y] and chroma sample arrays CroppedCbPic[x][y] and CroppedCrPic[x][y], when present, of the cropped decoded output picture for vertical coordinates y and horizontal coordinates x, where the top-left corner of the sample array has coordinates y equal to 0 and x equal to 0.
Bit depth BitDepth_{Y} for the luma sample array of the cropped decoded output picture.
Bit depth BitDepth_{C} for the chroma sample arrays, if any, of the cropped decoded output picture.
A chroma format indicator, denoted herein by ChromaFormatIdc, as described in clause 7.3.
When nnpfc_auxiliary_inp_idc is equal to 1, a quantization strength value StrengthControlVal.

When this SEI message specifies a neural network that may be used as a post-processing filter, the semantics specify the derivation of the luma sample array FilteredYPic[x][y] and chroma sample arrays FilteredCbPic[x][y] and FilteredCrPic[x][y], as indicated by the value of nnpfc_out_order_idc, that contain the output of the post-processing filter.

The variables SubWidthC and SubHeightC are derived from ChromaFormatIdc as specified by Table 2. nnpfc_id contains an identifying number that may be used to identify a post-processing filter. The value of nnpfc_id shall be in the range of 0 to 2³²-2, inclusive.

Values of nnpfc_id from 256 to 511, inclusive, and from 2³¹ to 2³²-2, inclusive, are reserved for future use by ITU-T|ISO/IEC. Decoders encountering a value of nnpfc_id in the range of 256 to 511, inclusive, or in the range of 2³¹ to 2³²-2, inclusive, shall ignore it.

nnpfc_mode_idc equal to 0 specifies that the post-processing filter associated with the nnpfc_id value is determined by external means not specified in this Specification.

nnpfc_mode_idc equal to 1 specifies that the post-processing filter associated with the nnpfc_id value is a neural network represented by the ISO/IEC 15938-17 bitstream contained in this SEI message.

nnpfc_mode_idc equal to 2 specifies that the post-processing filter associated with the nnpfc_id value is a neural network identified by a specified tag Uniform Resource Identifier (URI) (nnpfc_uri_tag[i]) and neural network information URI (nnpfc_uri[i]).

The value of nnpfc_mode_idc shall be in the range of 0 to 255, inclusive. Values of nnpfc_mode_idc greater than 2 are reserved for future specification by ITU-T|ISO/IEC and shall not be present in bitstreams conforming to this version of this Specification. Decoders conforming to this version of this Specification shall ignore SEI messages that contain reserved values of nnpfc_mode_idc.

nnpfc_purpose_and_formatting_flag equal to 0 specifies that no syntax elements related to the filter purpose, input formatting, output formatting, and complexity are present. nnpfc_purpose_and_formatting_flag equal to 1 specifies that syntax elements related to the filter purpose, input formatting, output formatting, and complexity are present.

When nnpfc_mode_idc is equal to 1 and the current CLVS does not contain a preceding neural-network post-filter characteristics SEI message, in decoding order, that has the value of nnpfc_id equal to the value of nnpfc_id in this SEI message, nnpfc_purpose_and_formatting_flag shall be equal to 1.

When the current CLVS contains a preceding neural-network post-filter characteristics SEI message, in decoding order, that has the same value of nnpfc_id equal to the value of nnpfc_id in this SEI message, at least one of the following conditions shall apply:
This SEI message has nnpfc_mode_idc equal to 1 and nnpfc_purpose_and_formatting_flag equal to 0 in order to provide a neural network update.
This SEI message has the same content as the preceding neural-network post-filter characteristics SEI message.

When this SEI message is the first neural-network post-filter characteristics SEI message, in decoding order, that has a particular nnpfc_id value within the current CLVS, it specifies a base post-processing filter that pertains to the current decoded picture and all subsequent decoded pictures of the current layer, in output order, until the end of the current CLVS. When this SEI message is not the first neural-network post-filter characteristics SEI message, in decoding order, that has a particular nnpfc_id value within the current CLVS, this SEI message pertains to the current decoded picture and all subsequent decoded pictures of the current layer, in output order, until the end of the current CLVS or the next neural-network post-filter characteristics SEI message having that particular nnpfc_id value, in output order, within the current CLVS.

nnpfc_purpose indicates the purpose of post-processing filter as specified in Table 1. The value of nnpfc_purpose shall be in the range of 0 to 2³²-2, inclusive. Values of nnpfc_purpose that do not appear in Table 1 are reserved for future specification by ITU-T|ISO/IEC and shall not be present in bitstreams conforming to this version of this Specification. Decoders conforming to this version of this Specification shall ignore SEI messages that contain reserved values of nnpfc_purpose.

TABLE 1
Definition of nnpfc_purpose

| Value | Interpretation |
|---|---|
| 0 | Unknown or unspecified |
| 1 | Visual quality improvement |
| 2 | Chroma upsampling from the 4:2:0 chroma format |
| | to the 4:2:2 or 4:4:4 chroma format, or from |
| | the 4:2:2 chroma format to the 4:4:4 chroma format |
| 3 | Increasing the width or height of the cropped decoded |
| | output picture without changing the chroma format |
| 4 | Increasing the width or height of the cropped decoded |
| | output picture and upsampling the chroma format |

NOTE 1—When a reserved value of nnpfc_purpose is taken into use in the future by ITU-T|ISO/IEC, the syntax of this SEI message could be extended with syntax elements whose presence is conditioned by nnpfc_purpose being equal to that value.

When SubWidthC is equal to 1 and SubHeightC is equal to 1, nnpfc_purpose shall not be equal to 2 or 4. nnpfc_out_sub_c_flag equal to 1 specifies that outSubWidthC is equal to 1 and outSubHeightC is equal to 1. nnpfc_out_sub_c_flag equal to 0 specifies that outSubWidthC is equal to 2 and outSubHeightC is equal to 1. When nnpfc_out_sub_c_flag is not present, outSubWidthC is inferred to be equal to SubWidthC and outSubHeightC is inferred to be equal to SubHeightC. If SubWidthC is equal to 2 and SubHeightC is equal to 1, nnpfc_out_sub_c_flag shall not be equal to 0.

nnpfc_pic_width_in_luma_samples and nnpfc_pic_height_in_luma_samples specify the width and height, respectively, of the luma sample array of the picture resulting by applying the post-processing filter identified by nnpfc_id to a cropped decoded output picture. When nnpfc_pic_width_in_luma_samples and nnpfc_pic_height_in_luma_samples are not present, they are inferred to be equal to CroppedWidth and CroppedHeight, respectively.

nnpfc_component_last_flag equal to 0 specifies that the second dimension in the input tensor inputTensor to the post-processing filter and the output tensor outputTensor resulting from the post-processing filter is used for the channel. nnpfc_component_last_flag equal to 1 specifies that the last dimension in the input tensor inputTensor to the post-processing filter and the output tensor outputTensor resulting from the post-processing filter is used for the channel.
NOTE 2—The first dimension in the input tensor and in the output tensor is used for the batch index, which is a practice in some neural network frameworks. While the semantics of this SEI message use batch size equal to 1, it is up to the post-processing implementation to determine the batch size used as input to the neural network inference.
NOTE 3—A colour component is an example of a channel.

nnpfc_inp_format_flag indicates the method of converting a sample value of the cropped decoded output picture to an input value to the post-processing filter. When nnpfc_inp_format_flag is equal to 0, the input values to the post-processing filter are real numbers and the functions InpY and InpC are specified as follows:

$$InpY ( x ) = x \div ( ( 1 << {BitDepth}_{Y} ) - 1 ) \qquad ( 75 )$$

$$InpC ( x ) = x \div ( ( 1 << {BitDepth}_{C} ) - 1 ) \qquad ( 76 )$$

When nnpfc_inp_format_flag is equal to 1, the input values to the post-processing filter are unsigned integer numbers and the functions InpY and InpC are specified as follows:

```
shift = BitDepth_{Y} − inpTensorBitDepth
if( inpTensorBitDepth >= BitDepth_{Y})
  InpY( x ) = x << ( inpTensorBitDepth − BitDepth_{Y} )
else
  InpY( x ) = Clip3(0, ( 1 << inpTensorBitDepth ) − 1, ( x + ( 1 << (shift − 1 ) ) ) >> shift ) (77)
shift = BitDepth_{C} − inpTensorBitDepth
if( inpTensorBitDepth >= BitDepth_{C} )
  InpC( x ) = x << ( inpTensorBitDepth − BitDepth_{C} )
else
  InpC( x ) = Clip3(0, ( 1 << inpTensorBitDepth ) − 1, ( x + ( 1 << ( shift − 1 ) ) ) >> shift )
```

The variable inpTensorBitDepth is derived from the syntax element nnpfc_inp_tensor_bitdepth_minus8 as specified below.

nnpfc_inp_tensor_bitdepth_minus8 plus 8 specifies the bit depth of luma sample values in the input integer tensor. The value of inpTensorBitDepth is derived as follows:

$$inpTensorBitDepth = nnpfc\_inp \_tensor \_bitdepth \_minus8 + 8 \qquad ( 78 )$$

It is a requirement of bitstream conformance that the value of nnpfc_inp_tensor_bitdepth_minus8 shall be in the range of 0 to 24, inclusive.

nnpfc_auxiliary_inp_idc not equal to 0 specifies auxiliary input data is present in the input tensor of the neural-network post-filter. nnpfc_auxiliary_inp_idc equal to 0 indicates that auxiliary input data is not present in the input tensor. nnpfc_auxiliary_inp_idc equal to 1 specifies that auxiliary input data is derived as specified in Table 4 below. The value of nnpfc_auxiliary_inp_idc shall be in the range of 0 to 255, inclusive. Values of nnpfc_auxiliary_inp_idc greater than 1 are reserved for future specification by ITU-T|ISO/IEC and shall not be present in bitstreams conforming to this version of this Specification. Decoders conforming to this version of this Specification shall ignore SEI messages that contain reserved values of nnpfc_auxiliary_inp_idc.

nnpfc_separate_colour_description_present_flag equal to 1 indicates that a distinct combination of colour primaries, transfer characteristics, and matrix coefficients for the picture resulting from the post-processing filter is specified in the SEI message syntax structure. nnfpc_separate_colour_description_present_flag equal to 0 indicates that the combination of colour primaries, transfer characteristics, and matrix coefficients for the picture resulting from the post-processing filter is the same as indicated in VUI parameters for the CLVS.

nnpfc_colour_primaries has the same semantics as specified in clause 7.3 for the vui_colour_primaries syntax element, except as follows:
nnpfc_colour_primaries specifies the colour primaries of the picture resulting from applying the neural-network post-filter specified in the SEI message, rather than the colour primaries used for the CLVS.
When nnpfc_colour_primaries is not present in the neural-network post-filter characteristics SEI message, the value of nnpfc_colour_primaries is inferred to be equal to vui_colour_primaries.

nnpfc_transfer_characteristics has the same semantics as specified in clause 7.3 for the

vui_transfer_characteristics syntax element, except as follows:
nnpfc_transfer_characteristics specifies the transfer characteristics of the picture resulting from applying the neural-network post-filter specified in the SEI message, rather than the transfer characteristics used for the CLVS.
When nnpfc_transfer_characteristics is not present in the neural-network post-filter characteristics SEI message, the value of nnpfc_transfer_characteristics is inferred to be equal to vui_transfer_characteristics. nnpfc_matrix_coeffs has the same semantics as specified in clause 7.3 for the vui_matrix_coeffs syntax element, except as follows:
nnpfc_matrix_coeffs specifies the matrix coefficients of the picture resulting from applying the neural-network post-filter specified in the SEI message, rather than the matrix coefficients used for the CLVS.
When nnpfc_matrix_coeffs is not present in the neural-network post-filter characteristics SEI message, the value of nnpfc_matrix_coeffs is inferred to be equal to vui_matrix_coeffs.
The values allowed for nnpfc_matrix_coeffs are not constrained by the chroma format of the decoded video pictures that is indicated by the value of ChromaFormatIdc for the semantics of the VUI parameters.
When nnpfc_matrix_coeffs is equal to 0, nnpfc_out_order_idc shall not be equal to 1 or 3.

nnpfc_inp_order_idc indicates the method of ordering the sample arrays of a cropped decoded output picture as the input to the post-processing filter. Table 2 below contains an informative description of nnpfc_inp_order_idc values. The semantics of nnpfc_inp_order_idc in the range of 0 to 3, inclusive, are specified in Table 3 below, which specifies a process for deriving the input tensors inputTensor for different values of nnpfc_inp_order_idc and a given vertical sample coordinate cTop and a horizontal sample coordinate cLeft specifying the top-left sample location for the patch of samples included in the input tensors. When the chroma format of the cropped decoded output picture is not 4:2:0, nnpfc_inp_order_idc shall not be equal to 3. The value of nnpfc_inp_order_idc shall be in the range of 0 to 255, inclusive. Values of nnpfc_inp_order_idc greater than 3 are reserved for future specification by ITU-T|ISO/IEC and shall not be present in bitstreams conforming to this version of this Specification. Decoders conforming to this version of this Specification shall ignore SEI messages that contain reserved values of nnpfc_inp_order_idc.

TABLE 2
Informative description of nnpfc_inp_order_idc values

| nnpfc_inp_{—} | |
|---|---|
| order_idc | Description |
| 0 | If nnpfc_auxiliary_inp_idc is equal to 0, one luma matrix is present in the input tensor, |
| | thus the number of channels is 1. Otherwise, nnpfc_auxiliary_inp_idc is not equal to 0 |
| | and one luma matrix and one auxiliary input matrix are present, thus the number of |
| | channels is 2. |
| 1 | If nnpfc_auxiliary_inp_idc is equal to 0, two chroma matrices are present in the input |
| | tensor, thus the number of channels is 2. Otherwise, nnpfc_auxiliary_inp_idc is not equal |
| | to 0 and two chroma matrices and one auxiliary input matrix are present, thus the number |
| | of channels is 3. |
| 2 | If nnpfc_auxiliary_inp_idc is equal to 0, one luma and two chroma matrices are present |
| | in the input tensor, thus the number of channels is 3. Otherwise, nnpfc_auxiliary_inp_idc |
| | is not equal to 0 and one luma matrix, two chroma matrices and one auxiliary input |
| | matrix are present, thus the number of channels is 4. |
| 3 | If nnpfc_auxiliary_inp_idc is equal to 0, four luma matrices and two chroma matrices are |
| | present in the input tensor, thus the number of channels is 6. Otherwise, |
| | nnpfc_auxiliary_inp_idc is not equal to 0 and four luma matrices, two chroma matrices, |
| | and one auxiliary input matrix are present in the input tensor, thus the number of |
| | channels is 7. The luma channels are derived in an interleaved manner as illustrated in |
| | Fig. 4. This nnpfc_inp_order_idc can only be used when the chroma format is 4:2:0. |
| 4..255 | reserved |

FIG. 4 illustrates an illustration 400 of luma data channels of nnpfc_inp_order_idc equal to 3 (informative). A patch is a rectangular array of samples from a component (e.g., a luma or chroma component) of a picture.

nnpfc_constant_patch_size_flag equal to 0 specifies that the post-processing filter accepts any patch size that is a positive integer multiple of the patch size indicated by nnpfc_patch_width_minus1 and nnpfc_patch_height_minus1 as input. When nnpfc_constant_patch_size_flag is equal to 0 the patch size width shall be less than or equal to CroppedWidth. When nnpfc_constant_patch_size_flag is equal to 0 the patch size height shall be less than or equal to CroppedHeight. nnpfc_constant_patch_size_flag equal to 1 specifies that the post-processing filter accepts exactly the patch size indicated by nnpfc_patch_width_minus1 and nnpfc_patch_height_minus1 as input.

nnpfc_patch_width_minus1+1, when nnpfc_constant_patch_size_flag equal to 1, specifies the horizontal sample counts of the patch size required for the input to the post-processing filter. When nnpfc_constant_patch_size_flag is equal to 0, any positive integer multiple of (nnpfc_patch_width_minus1+1) may be used as the horizontal sample counts of the patch size used for the input to the post-processing filter. The value of nnpfc_patch_width_minus1 shall be in the range of 0 to Min (32766, CroppedWidth−1), inclusive. nnpfc_patch_height_minus1+1, when nnpfc_constant_patch_size_flag equal to 1, specifies the vertical sample counts of the patch size required for the input to the post-processing filter. When nnpfc_constant_patch_size_flag is equal to 0, any positive integer multiple of (nnpfc_patch_height_minus1+1) may be used as the vertical sample counts of the patch size used for the input to the post-processing filter. The value of nnpfc_patch_height_minus1 shall be in the range of 0 to Min (32766, CroppedHeight−1), inclusive.

nnpfc_overlap specifies the overlapping horizontal and vertical sample counts of adjacent input tensors of the post-processing filter. The value of nnpfc_overlap shall be in the range of 0 to 16383, inclusive. The variables inpPatch Width, inpPatchHeight, outPatchWidth, outPatchHeight, horCScaling, verCScaling, outPatchCWidth, outPatchCHeight, and overlapSize are derived as follows:

$$inpPatchWidth = nnpfc\_patch \_width \_minus1 + 1 \qquad ( 79 )$$

$$inpPatch Height = nnpfc\_patch \_ height \_minus1 + 1$$

$$outPatchWidth = ( nnpfc\_pic \_width \_in \_luma \_samples * inpPatchWidth ) / CroppedWidth$$

$$outPatchHeight = ( nnpfc\_pic \_height \_in \_luma \_samples * inpPatchHeight ) / CroppedHeight$$

$$horCScaling = SubWidthC / outSubWidthC$$

$$verCScaling = SubHeightC / outSubHeightC$$

$$outPatchCWidth = outPatchWidth * horCScaling$$

$$outPatchCHeight = outPatchHeight * verCScaling$$

$$overlapSize = nnpfc\_overlap$$

It is a requirement of bitstream conformance that outPatch Width*CroppedWidth shall be equal to nnpfc_pic_width_in_luma_samples*inpPatchWidth and outPatchHeight*CroppedHeight shall be equal to nnpfc_pic_height_in_luma_samples*inpPatchHeight.

nnpfc_padding_type specifies the process of padding when referencing sample locations outside the boundaries of the cropped decoded output picture as described in Table 3 below. The value of nnpfc_padding_type shall be in the range of 0 to 15, inclusive.

TABLE 3
Informative description of nnpfc_padding_type values

| nnpfc_padding_type | Description |
|---|---|
| 0 | zero padding |
| 1 | replication padding |
| 2 | reflection padding |
| 3 | wrap-around padding |
| 4 | fixed padding |
| 5..15 | reserved |

nnpfc_luma_padding_val specifies the luma value to be used for padding when nnpfc_padding_type is equal to 4.

nnpfc_cb_padding_val specifies the Cb value to be used for padding when nnpfc_padding_type is equal to 4.

nnpfc_cr_padding_val specifies the Cr value to be used for padding when nnpfc_padding_type is equal to 4. The function InpSampleVal(y, x, picHeight, picWidth, croppedPic) with inputs being a vertical sample location y, a horizontal sample location x, a picture height picHeight, a picture width picWidth, and sample array croppedPic returns the value of sampleVal derived as follows:

```
if( nnpfc_padding_type == 0 )
  if( y < 0 | | x < 0 | | y >= picHeight | | x >= picWidth )
    sampleVal = 0
  else
    sampleVal = croppedPic[ x ][ y ]
else if( nnpfc_padding_type == 1 )
  sampleVal = croppedPic[ Clip3( 0, picWidth − 1, x) ][ Clip3( 0, picHeight − 1, y ) ]
else if( nnpfc_padding_type == 2 )
  sampleVal = croppedPic[ Reflect( picWidth − 1, x) ][ Reflect( picHeight − 1, y ) ]
else if( nnpfc_padding_type == 3 )
  if(y >= 0 && y < picHeight)
    sampleVal = croppedPic[ Wrap( picWidth − 1, x ) ][ y ]
else if( nnpfc_padding_type == 4 )
  if( y < 0 | | x <0 | | y >= picHeight | | x >= picWidth )
    sampleVal[ 0 ] = nnpfc_luma_padding_val
    sampleVal[ 1 ] = nnpfc_cb_padding_val
    sampleVal[ 2 ] = nnpfc_cr_padding_val
  else
    sampleVal = croppedPic[ x ][ y ]
```

TABLE 4
Process for deriving the input tensors inputTensor for a given vertical sample
coordinate cTop and a horizontal sample coordinate cLeft specifying the top-
left sample location for the patch of samples included in the input tensors

| nnpfc_inp_{—} | |
|---|---|
| order_idc | Process DeriveInputTensors( ) for deriving input tensors |
| 0 | for( yP = −overlapSize; yP < inpPatchHeight + overlapSize; yP++) |
| | for( xP = −overlapSize; xP < inpPatchWidth + overlapSize; xP++ ) { |
| | inpVal = InpY( InpSampleVal( cTop + yP, cLeft + xP, CroppedHeight, |
| | CroppedWidth, CroppedYPic ) ) |
| | if( nnpfc_component_last_flag == 0 ) |
| | inputTensor[ 0 ][ 0 ][ yP + overlapSize ][ xP + overlapSize ] = inpVal |
| | else |
| | inputTensor[ 0 ][ yP + overlapSize ][ xP + overlapSize ][ 0 ] = inpVal |
| | if(nnpfc_auxiliary_inp_idc == 1) { |
| | if( nnpfc_component_last_flag == 0 ) |
| | inputTensor[ 0 ][ 1 ][ yP + overlapSize ][ xP + overlapSize ] = 2^{(StrengthControlVal - 42)/6} |
| | else |
| | inputTensor[ 0 ][ yP + overlapSize ][ xP + overlapSize ][ 1 ] = 2^{(StrengthControlVal - 42)/6} |
| | } |
| | } |
| 1 | for( yP = −overlapSize; yP < inpPatchHeight + overlapSize; yP++) |
| | for( xP = −overlapSize; xP < inpPatchWidth + overlapSize; xP++ ) { |
| | inpCbVal = InpC( InpSampleVal( cTop + yP, cLeft + xP, CroppedHeight / SubHeightC, |
| | CroppedWidth / SubWidthC, CroppedCbPic ) ) |
| | inpCrVal = InpC( InpSampleVal( cTop + yP, cLeft + xP, CroppedHeight / SubHeightC, |
| | CroppedWidth / SubWidthC, CroppedCrPic ) ) |
| | if( nnpfc_component_last_flag == 0 ) { |
| | inputTensor[ 0 ][ 0 ][ yP + overlapSize ][ xP + overlapSize ] = inpCbVal |
| | inputTensor[ 0 ][ 1 ][ yP + overlapSize ][ xP + overlapSize ] = inpCrVal |
| | } else { |
| | inputTensor[ 0 ][ yP + overlapSize ][ xP + overlapSize ][ 0 ] = inpCbVal |
| | inputTensor[ 0 ][ yP + overlapSize ][ xP + overlapSize ][ 1 ] = inpCrVal |
| | } |
| | if(nnpfc_auxiliary_inp_idc == 1) { |
| | if( nnpfc_component_last_flag == 0 ) |
| | inputTensor[ 0 ][ 2 ][ yP + overlapSize ][ xP + overlapSize ] = 2^{(StrengthControlVal - 42)/6} |
| | else |
| | inputTensor[ 0 ][ yP + overlapSize ][ xP + overlapSize ][ 2 ] = 2^{(StrengthControlVal - 42)/6} |
| | } |
| | } |
| 2 | for( yP = −overlapSize; yP < inpPatchHeight + overlapSize; yP++) |
| | for( xP = −overlapSize; xP < inpPatchWidth + overlapSize; xP++ ) { |
| | yY = cTop + yP |
| | xY = cLeft + xP |
| | yC = yY / SubHeightC |
| | xC = xY / SubWidthC |
| | inp YVal = InpY( InpSampleVal( yY, xY, CroppedHeight, |
| | CroppedWidth, CroppedYPic ) ) |
| | inpCbVal = InpC( InpSampleVal( yC, xC, CroppedHeight / SubHeightC, |
| | CroppedWidth / SubWidthC, CroppedCbPic ) ) |
| | inpCrVal = InpC( InpSampleVal( yC, xC, CroppedHeight / SubHeightC, |
| | CroppedWidth / SubWidthC, CroppedCrPic ) ) |
| | if( nnpfc_component_last_flag == 0 ) { |
| | inputTensor[ 0 ][ 0 ][ yP + overlapSize ][ xP + overlapSize ] = inpYVal |
| | inputTensor[ 0 ][ 1 ][ yP + overlapSize ][ xP + overlapSize ] = inpCbVal |
| | inputTensor[ 0 ][ 2 ][ yP + overlapSize ][ xP + overlapSize ] = inpCrVal |
| | } else { |
| | inputTensor[ 0 ][ yP + overlapSize ][ xP + overlapSize ][ 0 ] = inpYVal |
| | inputTensor[ 0 ][ yP + overlapSize ][ xP + overlapSize ][ 1 ] = inpCbVal |
| | inputTensor[ 0 ][ yP + overlapSize ][ xP + overlapSize ][ 2 ] = inpCrVal |
| | } |
| | if(nnpfc_auxiliary_inp_idc == 1) { |
| | if( nnpfc_component_last_flag == 0 ) |
| | inputTensor[ 0 ][ 3 ][ yP + overlapSize ][ xP + overlapSize ] = 2^{(StrengthControlVal - 42)/6} |
| | else |
| | inputTensor[ 0 ][ yP + overlapSize ][ xP + overlapSize ][ 3 ] = 2^{(StrengthControlVal - 42)/6} |
| | } |
| | } |
| 3 | for( yP = −overlapSize; yP < inpPatchHeight + overlapSize; yP++) |
| | for( xP = −overlapSize; xP < inpPatchWidth + overlapSize; xP++ ) { |
| | yTL = cTop + yP * 2 |
| | xTL = cLeft + xP * 2 |
| | yBR = yTL + 1 |
| | xBR = xTL + 1 |
| | yC = cTop / 2 + yP |
| | xC = cLeft / 2 + xP |
| | inpTLVal = InpY( InpSampleVal( yTL, xTL, CroppedHeight, |
| | CroppedWidth, CroppedYPic ) ) |
| | inpTRVal = InpY( InpSampleVal( yTL, xBR, CroppedHeight, |
| | CroppedWidth, CroppedYPic ) ) |
| | inpBLVal = InpY( InpSampleVal( yBR, xTL, CroppedHeight, |
| | CroppedWidth, CroppedYPic ) ) |
| | inpBRVal = InpY( InpSampleVal( yBR, xBR, CroppedHeight, |
| | CroppedWidth, CroppedYPic ) ) |
| | inpCbVal = InpC( InpSampleVal( yC, xC, CroppedHeight / 2, |
| | CroppedWidth / 2, CroppedCbPic ) ) |
| | inpCrVal = InpC( InpSampleVal( yC, xC, CroppedHeight / 2, |
| | CroppedWidth / 2, CroppedCrPic ) ) |
| | if( nnpfc_component_last_flag == 0 ) { |
| | inputTensor[ 0 ][ 0 ][ yP + overlapSize ][ xP + overlapSize ] = inpTLVal |
| | inputTensor[ 0 ][ 1 ][ yP + overlapSize ][ xP + overlapSize ] = inpTRVal |
| | inputTensor[ 0 ][ 2 ][ yP + overlapSize ][ xP + overlapSize ] = inpBLVal |
| | inputTensor[ 0 ][ 3 ][ yP + overlapSize ][ xP + overlapSize ] = inpBRVal |
| | inputTensor[ 0 ][ 4 ][ yP + overlapSize ][ xP + overlapSize ] = inpCbVal |
| | inputTensor[ 0 ][ 5 ][ yP + overlapSize ][ xP + overlapSize ] = inpCrVal |
| | inputTensor[ 0 ][ 6 ][ yP + overlapSize ][ xP + overlapSize ] = 2^{(StrengthControlVal - 42)/6} |
| | } else { |
| | inputTensor[ 0 ][ yP + overlapSize ][ xP + overlapSize ][ 0 ] = inpTLVal |
| | inputTensor[ 0 ][ yP + overlapSize ][ xP + overlapSize ][ 1 ] = inpTRVal |
| | inputTensor[ 0 ][ yP + overlapSize ][ xP + overlapSize ][ 2 ] = inpBLVal |
| | inputTensor[ 0 ][ yP + overlapSize ][ xP + overlapSize ][ 3 ] = inpBRVal |
| | inputTensor[ 0 ][ yP + overlapSize ][ xP + overlapSize ][ 4 ] = inpCbVal |
| | inputTensor[ 0 ][ yP + overlapSize ][ xP + overlapSize ][ 5 ] = inpCrVal } |
| | if(nnpfc_auxiliary_inp_idc == 1) { |
| | if( nnpfc_component_last_flag == 0 ) |
| | inputTensor[ 0 ][ 6 ][ yP + overlapSize ][ xP + overlapSize ] = 2^{(StrengthControlVal - 42)/6} |
| | else |
| | inputTensor[ 0 ][ yP + overlapSize ][ xP + overlapSize ][ 6 ] = 2^{(StrengthControlVal - 42)/6} |
| | } |
| | } |
| 4..255 | reserved |

nnpfc_complexity_idc greater than 0 specifies that one or more syntax elements that indicate the complexity of the post-processing filter associated with the nnpfc_id may be present. nnpfc_complexity_idc equal to 0 specifies that no syntax element that indicates the complexity of the post-processing filter associated with the nnpfc_id is present. The value nnpfc_complexity_idc shall be in the range of 0 to 255, inclusive. Values of nnpfc_complexity_idc greater than 1 are reserved for future specification by ITU-T|ISO/IEC and shall not be present in bitstreams conforming to this version of this Specification. Decoders conforming to this version of this Specification shall ignore SEI messages that contain reserved values of nnpfc_complexity_idc.

nnpfc_out_format_flag equal to 0 indicates that the sample values output by the post-processing filter are real numbers and the functions OutY and OutC for converting luma sample values and chroma sample values, respectively, output by the post-processing, to integer values at bit depths BitDepth_{Y} and BitDepth_{C}, respectively, are specified as follows:

$$OutY ( x ) = Clip 3 ( 0 , ( 1 << {BitDepth}_{Y} ) - 1 , Round ( x * ( ( 1 << {BitDepth}_{Y} ) - 1 ) ) ) \qquad ( 81 )$$

$$OutC ( x ) = Clip 3 ( 0 , ( 1 << {BitDepth}_{C} ) - 1 , Round ( x * ( ( 1 << {BitDepth}_{C} ) - 1 ) ) ) \qquad ( 82 )$$

nnpfc_out_format_flag equal to 1 indicates that the sample values output by the post-processing filter are unsigned integer numbers and the functions OutY and OutC are specified as follows:

```
shift = outTensorBitDepth − BitDepth_{Y}
if( shift > 0 )
  OutY( x ) = Clip3( 0, ( 1 << BitDepth_{Y} ) − 1, ( x + ( 1 << ( shift −
  1 ) ) ) >> shift )
else
  OutY( x ) = x << ( BitDepth_{Y} − outTensorBitDepth ) (83)
shift = outTensorBitDepth − BitDepth_{C}
if( shift > 0 )
  OutC( x )= Clip3( 0, ( 1 << BitDepth_{C} ) − 1, ( x + ( 1 << ( shift −
  1 ) ) ) >> shift )
else
  OutC( x ) = x << ( BitDepth_{C} − outTensorBitDepth )
```

The variable outTensorBitDepth is derived from the syntax element nnpfc_out_tensor_bitdepth_minus8 as described below.

nnpfc_out_tensor_bitdepth_minus8 plus 8 specifies the bit depth of sample values in the output integer tensor. The value of outTensorBitDepth is derived as follows:

outTensorBitDepth=nnpfc_out_tensor_bitdepth_minus8+8 (84)

It is a requirement of bitstream conformance that the value of nnpfc_out_tensor_bitdepth_minus8 shall be in the range of 0 to 24, inclusive.

nnpfc_out_order_idc indicates the output order of samples resulting from the post-processing filter. Table 5 contains an informative description of nnpfc_out_order_idc values. The semantics of nnpfc_out_order_idc in the range of 0 to 3, inclusive, are specified in Table 6, which specifies a process for deriving sample values in the filtered output sample arrays FilteredYPic, FilteredCbPic, and FilteredCrPic from the output tensors outputTensor for different values of nnpfc_out_order_idc and a given vertical sample coordinate cTop and a horizontal sample coordinate cLeft specifying the top-left sample location for the patch of samples included in the input tensors. When nnpfc_purpose is equal to 2 or 4, nnpfc_out_order_idc shall not be equal to 3. The value of nnpfc_out_order_idc shall be in the range of 0 to 255, inclusive. Values of nnpfc_out_order_idc greater than 3 are reserved for future specification by ITU-T|ISO/IEC and shall not be present in bitstreams conforming to this version of this Specification. Decoders conforming to this version of this Specification shall ignore SEI messages that contain reserved values of nnpfc_out_order_idc.

TABLE 5
Informative description of nnpfc_out_order_idc values

| nnpfc_out_{—} | |
|---|---|
| order_idc | Description |
| 0 | Only the luma matrix is present in the output |
| | tensor, thus the number of channels is 1. |
| 1 | Only the chroma matrices are present in the output |
| | tensor, thus the number of channels is 2. |
| 2 | The luma and chroma matrices are present in the output |
| | tensor, thus the number of channels is 3. |
| 3 | Four luma matrices and two chroma matrices are |
| | present in the output tensor, thus the number |
| | of channels is 6. This nnpfc_out_order_idc can only |
| | be used when the chroma format is 4:2:0. |
| 4..255 | reserved |

TABLE 6
Process for deriving sample values in the filtered output sample arrays FilteredYPic,
Filtered CbPic, and FilteredCrPic from the output tensors outputTensor for a given
vertical sample coordinate cTop and a horizontal sample coordinate cLeft specifying
the top-left sample location for the patch of samples included in the input tensors

| nnpfc_out_{—} | Process StoreOutputTensors( ) for deriving sample values in the |
|---|---|
| order_idc | filtered picture from the output tensors |
| 0 | for( yP = 0; yP < outPatchHeight; yP++) |
| | for( xP = 0; xP < outPatchWidth; xP++ ) { |
| | yY = cTop * outPatchHeight / inpPatchHeight + yP |
| | xY = cLeft * outPatchWidth / inpPatchWidth + xP |
| | if ( yY < nnpfc_pic_height_in_luma_samples && xY < |
| | nnpfc_pic_width_in_luma_samples ) |
| | if( nnpfc_component_last_flag = = 0 ) |
| | FilteredYPic[ xY ][yY ] = OutY( outputTensor[ 0 ][ 0 ][ yP ][ xP ] ) |
| | else |
| | FilteredYPic[ xY ][ yY ] = OutY( outputTensor[ 0 ][ yP ][ xP ][ 0 ] ) |
| | } |
| 1 | for( yP = 0; yP < outPatchCHeight; yP++) |
| | for( xP = 0; xP < outPatchCWidth; xP++ ) { |
| | xSrc = cLeft * horCScaling + xP |
| | ySrc = cTop * verCScaling + yP |
| | if ( ySrc < nnpfc_pic_height_in_luma_samples / outSubHeightC && |
| | xSrc < nnpfc_pic_width_in_luma_samples / outSubWidthC ) |
| | if( nnpfc_component_last_flag = = 0 ) { |
| | FilteredCbPic[ xSrc ][ ySrc ] = OutC( outputTensor[ 0 ][ 0 ][ yP ][ xP ] ) |
| | FilteredCrPic[ xSrc ][ ySrc ] = OutC( outputTensor[ 0 ][ 1 ][ yP ][ xP ] ) |
| | } else { |
| | FilteredCbPic[ xSrc ][ ySrc ] = OutC( outputTensor[ 0 ][ yP ][ xP ][ 0 ] ) |
| | FilteredCrPic[ xSrc ][ ySrc ] = OutC( outputTensor[ 0 ][ yP ][ xP ][ 1 ] ) |
| | } |
| | } |
| 2 | for( yP = 0; yP < outPatchHeight; yP++) |
| | for( xP = 0; xP < outPatchWidth; xP++ ) { |
| | yY = cTop * outPatchHeight / inpPatchHeight + yP |
| | xY = cLeft * outPatchWidth / inpPatchWidth + xP |
| | yC = yY / outSubHeightC |
| | xC = xY / outSubWidthC |
| | yPc = ( yP / outSubHeightC ) * outSubHeightC |
| | xPc = ( xP / outSubWidthC ) * outSubWidthC |
| | if ( yY < nnpfc_pic_height_in_luma_samples && xY < |
| | nnpfc_pic_width_in_luma_samples) |
| | if( nnpfc_component_last_flag = = 0 ) { |
| | FilteredYPic[ xY ][ yY ] = OutY( outputTensor[ 0 ][ 0 ][ yP ][ xP ] ) |
| | FilteredCbPic[ xC ][ yC ] = OutC( outputTensor[ 0 ][ 1 ][ yPc ][ xPc ] ) |
| | FilteredCrPic[ xC ][ yC ] = OutC( outputTensor[ 0 ][ 2 ][ yPc ][ xPc ] ) |
| | } else { |
| | FilteredYPic[ xY ][ yY ] = OutY( outputTensor[ 0 ][ yP ][ xP ][ 0 ] ) |
| | FilteredCbPic[ xC ][ yC ] = OutC( outputTensor[ 0 ][ yPc ][ xPc ][ 1 ] ) |
| | FilteredCrPic[ xC ][ yC ] = OutC( outputTensor[ 0 ][ yPc ][ xPc ][ 2 ] ) |
| | } |
| | } |
| 3 | for( yP = 0; yP < outPatchHeight; yP++ ) |
| | for( xP = 0; xP < outPatchWidth; xP++ ) { |
| | ySrc = cTop / 2 * outPatchHeight / inpPatchHeight + yP |
| | xSrc = cLeft / 2 * outPatchWidth / inpPatchWidth + xP |
| | if ( ySrc < nnpfc_pic_height_in_luma_samples / 2 && |
| | xSrc < nnpfc_pic_width_in_luma_samples / 2 ) |
| | if( nnpfc_component_last_flag = = 0 ) { |
| | FilteredYPic[ xSrc * 2 ][ ySrc * 2 ] = OutY( outputTensor[ 0 ][ 0 ][ yP ][ xP ] ) |
| | FilteredYPic[ xSrc * 2 + 1 ][ ySrc * 2 ] = OutY( outputTensor[ 0 ][ 1 ][ yP ][ xP ] ) |
| | FilteredYPic[ xSrc * 2 ][ ySrc * 2 + 1 ] = OutY( outputTensor[ 0 ][ 2 ][ yP ][ xP ] ) |
| | FilteredYPic[ xSrc * 2 + 1][ ySrc * 2 + 1 ] = OutY( outputTensor[ 0 ][ 3 ][ yP ][ xP ] ) |
| | FilteredCbPic[ xSrc ][ ySrc ] = OutC( outputTensor[ 0 ][ 4 ][ yP ][ xP ] ) |
| | FilteredCrPic[ xSrc ][ ySrc ] = OutC( outputTensor[ 0 ][ 5 ][ yP ][ xP ] ) |
| | } else { |
| | FilteredYPic[ xSrc * 2 ][ ySrc * 2 ] = OutY( outputTensor[ 0 ][ yP ][ xP ][ 0 ] ) |
| | FilteredYPic[ xSrc * 2 + 1 ][ ySrc * 2 ] = OutY( outputTensor[ 0 ][ yP ][ xP ][ 1 ] ) |
| | FilteredYPic[ xSrc * 2 ][ ySrc * 2 + 1 ] = OutY( outputTensor[ 0 ][ yP ][ xP ][ 2 ] ) |
| | FilteredYPic[ xSrc * 2 + 1][ ySrc * 2 + 1 ] = OutY( outputTensor[ 0 ][ yP ][ xP ][ 3 ] ) |
| | FilteredCbPic[ xSrc ][ ySrc ] = OutC( outputTensor[ 0 ][ yP ][ xP ][ 4 ] ) |
| | FilteredCrPic[ xSrc ][ ySrc ] = OutC( outputTensor[ 0 ][ yP ][ xP ][ 5 ] ) |
| | } |
| | } |
| 4 . . . 255 | reserved |

A base post-processing filter for a cropped decoded output picture picA is the filter that is identified by the first neural-network post-filter characteristics SEI message, in decoding order, that has a particular nnpfc_id value within a CLVS.

If there is another neural-network post-filter characteristics SEI message that has the same nnpfc_id value, has nnpfc_mode_idc equal to 1, has different content than the neural-network post-filter characteristics SEI message that defines the base post-processing filter, and pertains to the picture picA, the base post-processing filter is updated by decoding the ISO/IEC 15938-17 bitstream in that neural-network post-filter characteristics SEI message to obtain a post-processing filter PostProcessingFilter( ) Otherwise, the post-processing processing filter PostProcessingFilter( ) is assigned to be the same as the base post-processing filter.

The following process is used to filter the cropped decoded output picture with the post-processing filter PostProcessingFilter( ) to generate the filtered picture, which contains Y, Cb, and Cr sample arrays FilteredYPic, FilteredCbPic, and FilteredCrPic, respectively, as indicated by nnpfc_out_order_idc.

```
if( nnpfc_inp_order_idc = = 0 )
  for( cTop = 0; cTop < CroppedHeight; cTop += inpPatchHeight )
    for( cLeft = 0; cLeft < CroppedWidth; cLeft += inpPatchWidth ) {
      DeriveInputTensors( )
      outputTensor = PostProcessingFilter( inputTensor )
      StoreOutputTensors( )
    }
else if( nnpfc_inp_order_idc = = 1 )
  for( cTop = 0; cTop < CroppedHeight / SubHeightC; cTop += inpPatchHeight )
    for( cLeft = 0; cLeft < CroppedWidth / SubWidthC; cLeft += inpPatchWidth ) {
      DeriveInputTensors( )
      outputTensor = PostProcessingFilter( inputTensor )
      Store OutputTensors( )
    }
else if( nnpfc_inp_order_idc = = 2 )
  for( cTop = 0; cTop < CroppedHeight; cTop += inpPatchHeight) (85)
    for( cLeft = 0; cLeft < CroppedWidth; cLeft += inpPatchWidth) {
      DeriveInputTensors( )
      outputTensor = PostProcessingFilter( inputTensor )
      StoreOutputTensors( )
    }
else if( nnpfc_inp_order_idc = = 3 )
  for( cTop = 0; cTop < CroppedHeight; cTop += inpPatchHeight * 2 )
    for( cLeft = 0; cLeft < CroppedWidth; cLeft += inpPatchWidth * 2 ) {
      DeriveInputTensors( )
      outputTensor = PostProcessingFilter( inputTensor )
      StoreOutputTensors( )
    }
```

nnpfc_reserved_zero_bit shall be equal to 0.

nnpfc_uri_tag[i] contains a NULL-terminated UTF-8 character string specifying a tag URI. The UTF-8 character string contains a URI, with syntax and semantics as specified in IETF RFC 4151, uniquely identifying the format and associated information about the neural network used as the post-processing filter specified by nnrpf_uri[i] values.
NOTE 4—nnrpf_uri_tag[i] elements represent a ‘tag’ URI, which allows uniquely identifying the format of neural network data specified by nnrpf_uri[i] values without needing a central registration authority.

nnpfc_uri[i] contains a NULL-terminated UTF-8 character string, as specified in IETF Internet Standard 63. The UTF-8 character string contains a URI, with syntax and semantics as specified in IETF Internet Standard 66, identifying the neural network information (e.g. data representation) used as the post-processing filter. nnpfc_payload_byte[i] contains the i-th byte of a bitstream conforming to ISO/IEC 15938-17. The byte sequence nnpfc_payload_byte[i] for all present values of i shall be a complete bitstream that conforms to ISO/IEC 15938-17.

nnpfc_parameter_type_idc equal to 0 indicates that the neural network uses only integer parameters. nnpfc_parameter_type_flag equal to 1 indicates that the neural network may use floating point or integer parameters. nnpfc_parameter_type_idc equal to 2 indicates that the neural network uses only binary parameters. nnpfc_parameter_type_idc equal to 3 is reserved for future specification by ITU-T|ISO/IEC and shall not be present in bitstreams conforming to this version of this Specification. Decoders conforming to this version of this Specification shall ignore SEI messages that contain reserved value of nnpfc_parameter_type_idc.

nnpfc_log2_parameter_bit_length_minus3 equal to 0, 1, 2, and 3 indicates that the neural network does not use parameters of bit length greater than 8, 16, 32, and 64, respectively. When nnpfc_parameter_type_idc is present and nnpfc_log2_parameter_bit_length_minus3 is not present the neural network does not use parameters of bit length greater than 1.

nnpfc_num_parameters_idc indicates the maximum number of neural network parameters for the post processing filter in units of a power of 2048. nnpfc_num_parameters_idc equal to 0 indicates that the maximum number of neural network parameters is not specified. The value nnpfc_num_parameters_idc shall be in the range of 0 to 52, inclusive. Values of nnpfc_num_parameters_idc greater than 52 are reserved for future specification by ITU-T| ISO/IEC and shall not be present in bitstreams conforming to this version of this Specification. Decoders conforming to this version of this Specification shall ignore SEI messages that contain reserved values of nnpfc_num_parameters_idc.

If the value of nnpfc_num_parameters_idc is greater than zero, the variable maxNumParameters is derived as follows:

$$maxNumParameters = ( 2048 << nnpfc\_num\_parameters\_idc ) - 1 \qquad ( 86 )$$

It is a requirement of bitstream conformance that the number of neural network parameters of the post-processing filter shall be less than or equal to maxNumParameters.

nnpfc_num_kmac_operations_idc greater than 0 specifies that the maximum number of multiply-accumulate operations per sample of the post-processing filter is less than or equal to nnpfc_num_kmac_operations_idc*1000. nnpfc_num_kmac_operations_idc equal to 0 specifies that the maximum number of multiply-accumulate operations of the network is not specified. The value of nnpfc_num_kmac_operations_idc shall be in the range of 0 to 2³²-1, inclusive.

### Neural-Network Post-Filter Activation SEI Message

### Neural-Network Post-Filter Activation SEI Message Syntax

| | Descriptor |
|---|---|
| nn_post_filter_activation( payloadSize ) { | |
| nnpfa_id | ue(v) |
| } | |

### Neural-Network Post-Filter Activation SEI Message Semantics

This SEI message specifies the neural-network post-processing filter that may be used for post-processing filtering for the current picture.

The neural-network post-processing filter activation SEI message persists only for the current picture.
NOTE—There may be several neural-network post-processing filter activation SEI messages present for the same picture, for example, when the post-processing filters are meant for different purposes or filter different colour components.

nnpfa_id specifies that the neural-network post-processing filter specified by one or more neural-network post-processing filter characteristics SEI messages that pertain to the current picture and have nnpfc_id equal to nnfpa_id may be used for post-processing filtering for the current picture.

### 4. PROBLEMS

The current design for the neural-network post-filter characteristics (NNPFC) SEI message has the following problems:
1) The NNPFC SEI message specifies that the purpose of a neural-network post-processing filter may be for visual quality improvement. However, visual quality improvement may have different interpretations, such as fidelity-constrained visual quality improvement, GAN-based (Generative Adversarial Network-based) visual quality improvement, film grain-based visual quality improvement, etc. Different video applications may prefer different types of visual quality improvements. For example, fidelity is important in surveillance scenario, but may not be so critical in some user-generated videos. Therefore, there is a need to be able to identify the type of visual quality improvement.
2) The NNPFC SEI message specifies the auxiliary input to the neural network, which only includes quantization parameter-related data. However, there are other auxiliary inputs which may also be very helpful in terms of improving the performance of post-processing filtering. Therefore, there is a need to specify more auxiliary inputs.
3) The NNPFC SEI message specifies that the chroma matrices presented in the output tensor of NN filter include two channels. However, the capability of processing two chroma components separately can be useful. Therefore, there is a need to enable applying NN filter only on one of the chroma components.
4) The NNPFC SEI message specifies the process for deriving the input tensor inputTensor in Table 4. When nnpfc_inp_order_idc is equal to 3, nnpfc_component_last_flag is equal to 0, and nnpfc_auxiliary_inp_idc is equal to 0, no auxiliary input matrix is supposed to be present. Therefore, the assignment operation “inputTensor[0][6][yP+overlapSize][xP+overlapSize]=2^{(StrengthControlVal-42)/6}” should be removed in this case.
5) The value of nnpfc_constant_patch_size_flag equal to 0 specifies that the post-processing filter accepts any patch size that is a positive integer multiple of the patch size indicated by nnpfc_patch_width_minus1 and nnpfc_patch_height_minus1 as input. nnpfc_constant_patch_size_flag equal to 1 specifies that the post-processing filter accepts exactly the patch size indicated by nnpfc_patch_width_minus1 and nnpfc_patch_height_minus1 as input. However, on the one hand, it is allowed for nnpfc_constant_patch_size_flag to be equal to 0, while on the other, regardless of the value of nnpfc_constant_patch_size_flag, the filtering process specified as part of the semantics of the NNPFC SEI message always use exactly the patch size indicated by nnpfc_patch_width_minus1 and nnpfc_patch_height_minus1 as input. In other words, the actual support of taking as input any patch size that is a positive integer multiple of the patch size indicated by nnpfc_patch_width_minus1 and nnpfc_patch_height_minus1 is missing.

### 5. DETAILED SOLUTIONS

To solve the above problems, methods as summarized below are disclosed. The embodiments should be considered as examples to explain the general concepts and should not be interpreted in a narrow way. Furthermore, these embodiments can be applied individually or combined in any manner.

In the following description, the term “picture” may be replaced with any video unit, such as “slice”.
1) To solve problem 1, one or more types of visual quality improvements are defined, and the visual quality improvement type of a neural-network post-processing filter with the visual quality improvement purpose is signalled in the NNPFC SEI message:
   a. In one example, a type of visual quality improvement is defined as objective-oriented/fidelity-oriented, targeting at increasing the fidelity of the reconstructed picture after applying the neural-network post-processing filter. The fidelity may be measured by PSNR (Peak Signal-to-Noise Ratio), Ms-SSIM (Multi-scale Structural Similarity), etc.
   b. In one example, a type of visual quality improvement is defined as subjective-oriented, targeting at increasing the subjective visual quality of the reconstructed picture after applying the neural-network post-processing filter. The subjective visual quality may be measured by LPIPS (Learned Perceptual Image Patch Similarity), MOS (Mean Opinion Score), etc.
   c. In one example, a type of visual quality improvement is defined as film grain-oriented, with synthesizing film grain on the reconstructed picture after applying the neural-network post-processing filter.
2) To solve problem 2, more auxiliary inputs to the neural network post-processing filter are defined.
   a. In one example, the auxiliary input includes prediction information such as prediction samples, prediction modes, etc.
   b. In one example, the auxiliary input includes partitioning information such partitioning boundary.
   c. In one example, the auxiliary input includes information from previously decoded pictures such as samples of collocated blocks or motion compensated blocks of current to-be-processed block in previously decoded pictures.
   d. In one example, different color components share or are allowed to share the same auxiliary input.
   e. In one example, different color components use or are allowed to use different auxiliary inputs.
   f. In one example, two chroma components use or are allowed to use the same auxiliary input, which is different from the auxiliary input of the luma component.
3) To solve problem 3, the matrices presented in the input and/or output tensor of an NN filter may include luma, and/or cb, and/or cr components, or any combination of these components.
   a. In one example, only a chroma matrix is present in the input and/or output tensor, the number of channels is 1, and the component is Cb.
   b. In one example, only a chroma matrix is present in the input and/or output tensor, the number of channels is 1, and the component is Cr.
   c. In one example, only a luma matrix and a chroma matrix are present in the input and/or output tensor, the number of channels is 2, and the components are luma and Cb.
   d. In one example, only a luma matrix and a chroma matrix are present in the input and/or output tensor, the number of channels is 2, and the components are luma and Cr.
   e. In one example, only four luma matrices and one chroma matrix are present in the input and/or output tensor, the number of channels is 5, and the components are luma and Cb. This can only be used when the chroma format is 4:2:0.
   f. In one example, only four luma matrices and one chroma matrix are present in the input and/or output tensor, the number of channels is 5, and the components are luma and Cr. This can only be used when the chroma format is 4:2:0.
4) To solve problem 4, when nnpfc_inp_order_idc is equal to 3, nnpfc_component_last_flag is equal to 0, and nnpfc_auxiliary_inp_idc is equal to 0, no auxiliary input matrix is used.
5) To solve problem 5, one more of the following aspects are specified:
   a. In one example, when nnpfc_constant_patch_size_flag is equal to 0, the patch size width, denoted by inpPatchWidth, and the patch size height, denoted by inpPatchHeight, are provided by external means not specified in this document. The value of inpPatchWidth shall be a positive integer multiple of nnpfc_patch_width_minus1+1 and shall be less than or equal to CroppedWidth. The value of PatchSizeH shall be a positive integer multiple of nnpfc_patch_height_minus1+1 and shall be less than or equal to CroppedHeight.
      i. An example of such external means is an API that passes the values of inpPatch Width and inpPatchHeight to the decoder and render entity in a video application system, and the values may be configured by a user through a user interface of the application.
   b. In one example, when nnpfc_constant_patch_size_flag is equal to 1, the value of inpPatchWidth is set equal to nnpfc_patch_width_minus1+1 and the value of inpPatchHeight is set equal to nnpfc_patch_height_minus1+1.
   c. In one example, regardless of the value of nnpfc_constant_patch_size_flag, the filtering process takes as input the patch size width inpPatchWidth and the patch size height inpPatchHeight as specified above.

### 6. EMBODIMENTS

Below are some example embodiments for the case when a video unit is a picture for the embodiment items 1, 2, 3, 4, and their subitems summarized above in Section 5.

Most relevant parts that have been added or modified are shown by using bolded words (e.g., this format indicates added text), and some of the deleted parts are shown by using words in italics between double curly bracket (e.g., {{this format indicates deleted text}}. There may be some other changes that are editorial in nature and thus not highlighted. It should be understood that only markings in this section are intended to represent changes.

### 6.1. Embodiment 1

This embodiment is for the case when a video unit is a picture for the embodiment item 1 and all its subitems summarized above in Section 5.

### Neural-Network Post-Filter Characteristics SEI Message Syntax

| | Descriptor |
|---|---|
| nn_post_filter_characteristics( payloadSize ) { | |
| nnpfc_id | ue(v) |
| nnpfc_mode_idc | ue(v) |
| nnpfc_purpose_and_formatting_flag | u(1) |
| if( nnpfc_purpose_and_formatting_flag ) { | |
| nnpfc_purpose | ue(v) |
| if( nnpfc_purpose = = 1 ) | |
| nnpfc_visual_quality_improvement_type | ue(v) |
| if( nnpfc_purpose = = 2 ∥ nnpfc_purpose = = 4 ) | |
| nnpfc_out_sub_c_flag | u(1) |
| if( nnpfc_purpose = = 3 ∥ nnpfc_purpose = = 4 ) { | |
| nnpfc_pic_width_in_luma_samples | ue(v) |
| nnpfc_pic_height_in_luma_samples | ue(v) |
| } | |
| ... | |
| } | |
| ... | |
| } | |

### Neural-Network Post-Filter Activation SEI Message Semantics

nnpfc_purpose indicates the purpose of post-processing filter as specified in Table 1. The value of nnpfc_purpose shall be in the range of 0 to 2³²-2, inclusive. Values of nnpfc_purpose that do not appear in Table 1 are reserved for future specification by ITU-T|ISO/IEC and shall not be present in bitstreams conforming to this version of this Specification. Decoders conforming to this version of this Specification shall ignore SEI messages that contain reserved values of nnpfc_purpose.

When SubWidthC is equal to 1 and SubHeightC is equal to 1, nnpfc_purpose shall not be equal to 2 or 4. nnpfc_visual_quality_improvement_type indicates the type of visual quality improvement as specified in Table 7. The value of nnpfc_visual_quality_improvement_type shall be in the range of 0 to 255, inclusive. Values of nnpfc_visual_quality_improvement_type that do not appear in Table 7 are reserved for future specification by ITU-T|ISO/IEC and shall not be present in bitstreams conforming to this version of this Specification. Decoders conforming to this version of this Specification encountering a value of nnpfc_visual_quality_improvement_type greater than 3 shall ignore it.

TABLE 7
Definition of nnpfc_visual_quality_improvement_type

| Value | Interpretation |
|---|---|
| 0 | General visual quality improvement, targeting at increasing either the fidelity or the |
| | subjective visual quality of the reconstructed picture after applying the neural-network |
| | post-processing filter. The improvement may be measured by any objective or subjective |
| | metric. |
| 1 | Objective-oriented/fidelity-oriented visual quality improvement, targeting at increasing the |
| | fidelity of the reconstructed picture after applying the neural-network post-processing |
| | filter. The fidelity may be measured by PSNR, Ms-SSIM etc. |
| 2 | Subjective-oriented visual quality improvement, targeting at increasing the subjective |
| | visual quality of the reconstructed picture after applying the neural-network post- |
| | processing filter. The subjective visual quality may be measured by LPIPS or MOS. |
| 3 | Film grain-oriented visual quality improvement, with synthesizing filter grain on the |
| | reconstructed picture after applying the neural-network post-processing filter. |

NOTE x—When a reserved value of nnpfc_visual_quality_improvement_type is taken into use in the future by ITU-T|ISO/IEC, the syntax of this SEI message could be extended with syntax elements whose presence is conditioned by nnpfc_visual_quality_improvement_type being equal to that value.

### 6.2. Embodiment 2

This embodiment is for the case when a video unit is a picture for the embodiment item 2, item 3, item4 and all its subitems summarized above in Section 5.

### Neural-Network Post-Filter Activation SEI Message Semantics

This SEI message specifies a neural network that may be used as a post-processing filter. The use of specified post-processing filters for specific pictures is indicated with neural-network post-filter activation SEI messages. Use of this SEI message requires the definition of the following variables:
Cropped decoded output picture width and height in units of luma samples, denoted herein by CroppedWidth and CroppedHeight, respectively.
Luma sample array CroppedYPic[x][y] and chroma sample arrays CroppedCbPic[x][y] and CroppedCrPic[x][y], when present, of the cropped decoded output picture for vertical coordinates y and horizontal coordinates x, where the top-left corner of the sample array has coordinates y equal to 0 and x equal to 0.
Bit depth BitDepth_{Y} for the luma sample array of the cropped decoded output picture.
Bit depth BitDepth_{C} for the chroma sample arrays, if any, of the cropped decoded output picture.
A chroma format indicator, denoted herein by ChromaFormatIdc, as described in clause 7.3.
When nnpfc_auxiliary_inp_idc is equal to 1, a quantization strength value StrengthControlVal.
When nnpfc_auxiliary_inp_idc is equal to 2 or 3, the cropped decoded prediction picture with the same size as the cropped decoded output picture.
When nnpfc_auxiliary_inp_idc is equal to 2 or 3, luma prediction array CroppedYPred[x][y] and chroma prediction arrays CroppedCbPred[x][y] and CroppedCrPred[x][y], when present, of the cropped decoded prediction picture for vertical coordinates y and horizontal coordinates x, where the top-left corner of the sample array has coordinates y equal to 0 and x equal to 0.

When this SEI message specifies a neural network that may be used as a post-processing filter, the semantics specify the derivation of the luma sample array FilteredYPic[x][y] and chroma sample arrays FilteredCbPic[x][y] and FilteredCrPic[x][y], as indicated by the value of nnpfc_out_order_idc, that contain the output of the post-processing filter.

The variables SubWidthC and SubHeightC are derived from ChromaFormatIdc as specified by Table 2. nnpfc_id contains an identifying number that may be used to identify a post-processing filter. The value of nnpfc_id shall be in the range of 0 to 2³²-2, inclusive.

Values of nnpfc_id from 256 to 511, inclusive, and from 2³¹ to 2³²-2, inclusive, are reserved for future use by ITU-T|ISO/IEC. Decoders encountering a value of nnpfc_id in the range of 256 to 511, inclusive, or in the range of 2³¹ to 2³²-2, inclusive, shall ignore it.

nnpfc_mode_idc equal to 0 specifies that the post-processing filter associated with the nnpfc_id value is determined by external means not specified in this Specification.

nnpfc_mode_idc equal to 1 specifies that the post-processing filter associated with the nnpfc_id value is a neural network represented by the ISO/IEC 15938-17 bitstream contained in this SEI message.

nnpfc_mode_idc equal to 2 specifies that the post-processing filter associated with the nnpfc_id value is a neural network identified by a specified tag Uniform Resource Identifier (URI) (nnpfc_uri_tag[i]) and neural network information URI (nnpfc_uri[i]).

The value of nnpfc_mode_idc shall be in the range of 0 to 255, inclusive. Values of nnpfc_mode_idc greater than 2 are reserved for future specification by ITU-T|ISO/IEC and shall not be present in bitstreams conforming to this version of this Specification. Decoders conforming to this version of this Specification shall ignore SEI messages that contain reserved values of nnpfc_mode_idc.

nnpfc_purpose_and_formatting_flag equal to 0 specifies that no syntax elements related to the filter purpose, input formatting, output formatting, and complexity are present. nnpfc_purpose_and_formatting_flag equal to 1 specifies that syntax elements related to the filter purpose, input formatting, output formatting, and complexity are present. When nnpfc_mode_idc is equal to 1 and the current CLVS does not contain a preceding neural-network post-filter characteristics SEI message, in decoding order, that has the value of nnpfc_id equal to the value of nnpfc_id in this SEI message, nnpfc_purpose_and_formatting_flag shall be equal to 1.

When the current CLVS contains a preceding neural-network post-filter characteristics SEI message, in decoding order, that has the same value of nnpfc_id equal to the value of nnpfc_id in this SEI message, at least one of the following conditions shall apply:
This SEI message has nnpfc_mode_idc equal to 1 and nnpfc_purpose_and_formatting_flag equal to 0 in order to provide a neural network update.
This SEI message has the same content as the preceding neural-network post-filter characteristics SEI message.

When this SEI message is the first neural-network post-filter characteristics SEI message, in decoding order, that has a particular nnpfc_id value within the current CLVS, it specifies a base post-processing filter that pertains to the current decoded picture and all subsequent decoded pictures of the current layer, in output order, until the end of the current CLVS. When this SEI message is not the first neural-network post-filter characteristics SEI message, in decoding order, that has a particular nnpfc_id value within the current CLVS, this SEI message pertains to the current decoded picture and all subsequent decoded pictures of the current layer, in output order, until the end of the current CLVS or the next neural-network post-filter characteristics SEI message having that particular nnpfc_id value, in output order, within the current CLVS.

nnpfc_purpose indicates the purpose of post-processing filter as specified in Table 1. The value of nnpfc_purpose shall be in the range of 0 to 2³²-2, inclusive. Values of nnpfc_purpose that do not appear in Table 1 are reserved for future specification by ITU-T|ISO/IEC and shall not be present in bitstreams conforming to this version of this Specification. Decoders conforming to this version of this Specification shall ignore SEI messages that contain reserved values of nnpfc_purpose.

When SubWidthC is equal to 1 and SubHeightC is equal to 1, nnpfc_purpose shall not be equal to 2 or 4. nnpfc_out_sub_c_flag equal to 1 specifies that outSubWidthC is equal to 1 and outSubHeightC is equal to 1. nnpfc_out_sub_c_flag equal to 0 specifies that outSubWidthC is equal to 2 and outSubHeightC is equal to 1. When nnpfc_out_sub_c_flag is not present, outSubWidthC is inferred to be equal to SubWidthC and outSubHeightC is inferred to be equal to SubHeightC. If SubWidthC is equal to 2 and SubHeightC is equal to 1, nnpfc_out_sub_c_flag shall not be equal to 0.

nnpfc_pic_width_in_luma_samples and nnpfc_pic_height_in_luma_samples specify the width and height, respectively, of the luma sample array of the picture resulting by applying the post-processing filter identified by nnpfc_id to a cropped decoded output picture. When nnpfc_pic_width_in_luma_samples and nnpfc_pic_height_in_luma_samples are not present, they are inferred to be equal to CroppedWidth and CroppedHeight, respectively.

nnpfc_component_last_flag equal to 0 specifies that the second dimension in the input tensor inputTensor to the post-processing filter and the output tensor outputTensor resulting from the post-processing filter is used for the channel. nnpfc_component_last_flag equal to 1 specifies that the last dimension in the input tensor inputTensor to the post-processing filter and the output tensor outputTensor resulting from the post-processing filter is used for the channel.
NOTE 2—The first dimension in the input tensor and in the output tensor is used for the batch index, which is a practice in some neural network frameworks. While the semantics of this SEI message use batch size equal to 1, it is up to the post-processing implementation to determine the batch size used as input to the neural network inference.
NOTE 3-A colour component is an example of a channel.

nnpfc_inp_format_flag indicates the method of converting a sample value of the cropped decoded output picture to an input value to the post-processing filter. When nnpfc_inp_format_flag is equal to 0, the input values to the post-processing filter are real numbers and the functions InpY and InpC are specified as follows:

$$InpY ( x ) = x \div ( ( 1 << {BitDepth}_{Y} ) - 1 ) \qquad ( 75 )$$

$$InpC ( x ) = x \div ( ( 1 << {BitDepth}_{C} ) - 1 ) \qquad ( 76 )$$

When nnpfc_inp_format_flag is equal to 1, the input values to the post-processing filter are unsigned integer numbers and the functions InpY and InpC are specified as follows:

```
shift = BitDepth_{Y} − inpTensorBitDepth
if( inpTensorBitDepth >= BitDepth_{Y} )
  InpY( x ) = x << ( inpTensorBitDepth − BitDepth_{Y} )
else
  InpY( x ) = Clip3(0, ( 1 << inpTensorBitDepth ) − 1, ( x + ( 1 << ( shift − 1) ) ) >> shift ) (77)
shift = BitDepth_{C} − inpTensorBitDepth
if( inpTensorBitDepth >= BitDepth_{C} )
  InpC( x ) = x << ( inpTensorBitDepth − BitDepth_{C} )
else
  InpC( x ) = Clip3(0, ( 1 << inpTensorBitDepth ) − 1, ( x + ( 1 << ( shift − 1 ) ) ) >> shift )
```

The variable inpTensorBitDepth is derived from the syntax element nnpfc_inp_tensor_bitdepth_minus8 as specified below.

nnpfc_inp_tensor_bitdepth_minus8 plus 8 specifies the bit depth of luma sample values in the input integer tensor. The value of inpTensorBitDepth is derived as follows:

$$inpTensorBitDepth = nnpfc\_inp \_tensor \_bitdepth \_minus8 + 8 \qquad ( 78 )$$

It is a requirement of bitstream conformance that the value of nnpfc_inp_tensor_bitdepth_minus8 shall be in the range of 0 to 24, inclusive.

nnpfc_auxiliary_inp_idc not equal to 0 specifies auxiliary input data is present in the input tensor of the neural-network post-filter. nnpfc_auxiliary_inp_idc equal to 0 indicates that auxiliary input data is not present in the input tensor. nnpfc_auxiliary_inp_idc equal to 1, 2, or 3 specifies that auxiliary input data is derived as specified in Table 4. The value of nnpfc_auxiliary_inp_idc shall be in the range of 0 to 255, inclusive. Values of nnpfc_auxiliary_inp_idc greater than {{1}} 3 are reserved for future specification by ITU-T|ISO/IEC and shall not be present in bitstreams conforming to this version of this Specification. Decoders conforming to this version of this Specification shall ignore SEI messages that contain reserved values of nnpfc_auxiliary_inp_idc. nnpfc_separate_colour_description_present_flag equal to 1 indicates that a distinct combination of colour primaries, transfer characteristics, and matrix coefficients for the picture resulting from the post-processing filter is specified in the SEI message syntax structure. nnfpc_separate_colour_description_present_flag equal to 0 indicates that the combination of colour primaries, transfer characteristics, and matrix coefficients for the picture resulting from the post-processing filter is the same as indicated in VUI parameters for the CLVS. nnpfc_colour_primaries has the same semantics as specified in clause 7.3 for the vui_colour_primaries syntax element, except as follows:
nnpfc_colour_primaries specifies the colour primaries of the picture resulting from applying the neural-network post-filter specified in the SEI message, rather than the colour primaries used for the CLVS.
When nnpfc_colour_primaries is not present in the neural-network post-filter characteristics SEI message, the value of nnpfc_colour_primaries is inferred to be equal to vui_colour_primaries.
nnpfc_transfer_characteristics has the same semantics as specified in clause 7.3 for the vui_transfer_characteristics syntax element, except as follows:
nnpfc_transfer_characteristics specifies the transfer characteristics of the picture resulting from applying the neural-network post-filter specified in the SEI message, rather than the transfer characteristics used for the CLVS.
When nnpfc_transfer_characteristics is not present in the neural-network post-filter characteristics SEI message, the value of nnpfc_transfer_characteristics is inferred to be equal to vui_transfer_characteristics. nnpfc_matrix_coeffs has the same semantics as specified in clause 7.3 for the vui_matrix_coeffs syntax element, except as follows:
nnpfc_matrix_coeffs specifies the matrix coefficients of the picture resulting from applying the neural-network post-filter specified in the SEI message, rather than the matrix coefficients used for the CLVS.
When nnpfc_matrix_coeffs is not present in the neural-network post-filter characteristics SEI message, the value of nnpfc_matrix_coeffs is inferred to be equal to vui_matrix_coeffs.
The values allowed for nnpfc_matrix_coeffs are not constrained by the chroma format of the decoded video pictures that is indicated by the value of ChromaFormatIdc for the semantics of the VUI parameters.
When nnpfc_matrix_coeffs is equal to 0, nnpfc_out_order_idc shall not be equal to 1 or 3. nnpfc_inp_order_idc indicates the method of ordering the sample arrays of a cropped decoded output picture as the input to the post-processing filter. Table 8 contains an informative description of nnpfc_inp_order_idc values. The semantics of nnpfc_inp_order_idc in the range of 0 to {{3}} 9, inclusive, are specified in Table 9, which specifies a process for deriving the input tensors inputTensor for different values of nnpfc_inp_order_idc and a given vertical sample coordinate cTop and a horizontal sample coordinate cLeft specifying the top-left sample location for the patch of samples included in the input tensors. When the chroma format of the cropped decoded output picture is not 4:2:0, nnpfc_inp_order_idc shall not be equal to {{3}} 7, 8, or 9. The value of nnpfc_inp_order_idc shall be in the range of 0 to 255. inclusive. Values of nnpfe_inp_order_idc greater than {{3}} 9 are reserved for future specification by ITU-T|ISO/IEC and shall not be present in bitstreams conforming to this version of this Specification. Decoders conforming to this version of this Specification shall ignore SEI messages that contain reserved values of nnpfe_inp_order_ide.

TABLE 8
Informative description of nnpfc_inp_order_idc values

| nnpfc_inp_{—} | |
|---|---|
| order_idc | Description |
| 0 | When{{If}} nnpfc_auxiliary_inp_idc is equal to 0, the input tensor consists of one luma |
| | matrix {{is present in the input tensor}}, thus the number of channels is 1. |
| | {{Otherwise, }}When nnpfc_auxiliary_inp_idc is {{not}} equal to {{0 }}1 or 2, {{and}} |
| | the input tensor consists of one luma matrix and one auxiliary input matrix {{are |
| | present}}, thus the number of channels is 2. When nnpfc_auxiliary_inp_idc is equal to |
| | 3, the input tensor consists of one luma matrix and two auxiliary input matrices, |
| | thus the number of channels is 3. |
| 1 | When nnpfc_auxiliary_inp_idc is equal to 0, the input tensor consists of one chroma |
| | matrix corresponding to the Cb component, thus the number of channels is 1. When |
| | nnpfc_auxiliary_inp_idc is equal to 1 or 2, the input tensor consists of one chroma |
| | matrix corresponding to the Cb component and one auxiliary input matrix, thus the |
| | number of channels is 2. When nnpfc_auxiliary_inp_idc is equal to 3, the input |
| | tensor consists of one chroma matrix corresponding to the Cb component and two |
| | auxiliary input matrices, thus the number of channels is 3. |
| 2 | When nnpfc_auxiliary_inp_idc is equal to 0, the input tensor consists of one chroma |
| | matrix corresponding to the Cr component, thus the number of channels is 1. When |
| | nnpfc_auxiliary_inp_idc is equal to 1 or 2, the input tensor consists of one chroma |
| | matrix corresponding to the Cr component and one auxiliary input matrix, thus the |
| | number of channels is 2. When nnpfc_auxiliary_inp_idc is equal to 3, the input |
| | tensor consists of one chroma matrix corresponding to the Cr component and two |
| | auxiliary input matrices, thus the number of channels is 3. |
| {{1}}3 | When{{If }} nnpfc_auxiliary_inp_idc is equal to 0, the input tensor consists of two |
| | chroma matrices, thus the number of channels is 2. {{Otherwise, }}When |
| | nnpfc_auxiliary_inp_idc is{{ not}} equal to {{0 }} 1, {{and}} the input tensor consists |
| | of two chroma matrices and one auxiliary input matrix{{ are present}}, thus the number |
| | of channels is 3. When nnpfc_auxiliary_inp_idc is equal to 2, the input tensor |
| | consists of two chroma matrices and two auxiliary input matrices, thus the number |
| | of channels is 4. When nnpfc_auxiliary_inp_idc is equal to 3, the input tensor |
| | consists of two chroma matrices and three auxiliary input matrices, thus the |
| | number of channels is 5. |
| 4 | When nnpfc_auxiliary_inp_idc is equal to 0, the input tensor consists of one luma |
| | and one chroma matrix corresponding to the Cb component, thus the number of |
| | channels is 2. When nnpfc_auxiliary_inp_idc is equal to 1, the input tensor consists |
| | of one luma matrix, one chroma matrix corresponding to the Cb component and |
| | one auxiliary input matrix, thus the number of channels is 3. When |
| | nnpfc_auxiliary_inp_idc is equal to 2, the input tensor consists of one luma matrix, |
| | one chroma matrix corresponding to the Cb component, and two auxiliary input |
| | matrices, thus the number of channels is 4. When nnpfc_auxiliary_inp_idc is equal |
| | to 3, the input tensor consists of one luma matrix, one chroma matrix |
| | corresponding to the Cb component, and three auxiliary input matrices, thus the |
| | number of channels is 5. |
| 5 | When nnpfc_auxiliary_inp_idc is equal to 0, the input tensor consists of one luma |
| | and one chroma matrix corresponding to the Cr component, thus the number of |
| | channels is 2. When nnpfc_auxiliary_inp_idc is equal to 1, the input tensor consists |
| | of one luma matrix, one chroma matrix corresponding to the Cr component and |
| | one auxiliary input matrix, thus the number of channels is 3. When |
| | nnpfc_auxiliary_inp_idc is equal to 2, the input tensor consists of one luma matrix, |
| | one chroma matrix corresponding to the Cr component and two auxiliary input |
| | matrices, thus the number of channels is 4. When nnpfc_auxiliary_inp_idc is equal |
| | to 3, the input tensor consists of one luma matrix, one chroma matrix |
| | corresponding to cr component and three auxiliary input matrices, thus the number |
| | of channels is 5. |
| {{2}}6 | When{{If }} nnpfc_auxiliary_inp_idc is equal to 0, the input tensor consists of one |
| | luma and two chroma matrices{{ are present in the input tensor}}, thus the number of |
| | channels is 3. {{ Otherwise,}}When nnpfc_auxiliary_inp_idc is {{not}}equal to {{0 |
| | and}} 1, the input tensor consists of one luma matrix, two chroma matrices and one |
| | auxiliary input matrix {{are present}}, thus the number of channels is 4. When |
| | nnpfc_auxiliary_inp_idc is equal to 2, the input tensor consists of one luma matrix, |
| | two chroma matrices and three auxiliary input matrices, thus the number of |
| | channels is 6. When nnpfc_auxiliary_inp_idc is equal to 3, the input tensor consists |
| | of one luma matrix, two chroma matrices and four auxiliary input matrices, thus |
| | the number of channels is 7. |
| 7 | When nnpfc_auxiliary_inp_idc is equal to 0, the input tensor consists of four luma |
| | matrices and one chroma matrix corresponding to the Cb component, thus the |
| | number of channels is 5. When nnpfc_auxiliary_inp_idc is equal to 1, the input |
| | tensor consists of four luma matrices, one chroma matrix corresponding to the Cb |
| | component, and one auxiliary input matrix, thus the number of channels is 6. When |
| | nnpfc_auxiliary_inp_idc is equal to 2, the input tensor consists of four luma |
| | matrices, one chroma matrix corresponding to the Cb component and five auxiliary |
| | input matrices, thus the number of channels is 10. When nnpfc_auxiliary_inp_idc is |
| | equal to 3, the input tensor consists of four luma matrices, one chroma matrix |
| | corresponding to the Cb component and six auxiliary input matrices, thus the |
| | number of channels is 11. The luma channels are derived in an interleaved manner |
| | as illustrated in Fig. 4. This nnpfc_inp_order_idc value can only be used when the |
| | chroma format is 4:2:0. |
| 8 | When nnpfc_auxiliary_inp_idc is equal to 0, the input tensor consists of four luma |
| | matrices and one chroma matrix corresponding to the Cr component, thus the |
| | number of channels is 5. When nnpfc_auxiliary_inp_idc is equal to 1, the input |
| | tensor consists of four luma matrices, one chroma matrix corresponding to the Cr |
| | component, and one auxiliary input matrix, thus the number of channels is 6. When |
| | nnpfc_auxiliary_inp_idc is equal to 2, the input tensor consists of four luma |
| | matrices, one chroma matrix corresponding to the Cr component and five auxiliary |
| | input matrices, thus the number of channels is 10. When nnpfc_auxiliary_inp_idc is |
| | equal to 3, the input tensor consists of four luma matrices, one chroma matrix |
| | corresponding to the Cr component and six auxiliary input matrices, thus the |
| | number of channels is 11. The luma channels are derived in an interleaved manner |
| | as illustrated in Fig. 4. This nnpfc_inp_order_idc value can only be used when the |
| | chroma format is 4:2:0. |
| {{3}}9 | When{{If }} nnpfc_auxiliary_inp_idc is equal to 0, the input tensor consists of four |
| | luma matrices and two chroma matrices{{are present in the input tensor}}, thus the |
| | number of channels is 6. {{Otherwise,}}When nnpfc_auxiliary_inp_idc is {{not}}equal |
| | to 1, {{0 and}}the input tensor consists of four luma matrices, two chroma matrices, |
| | and one auxiliary input matrix {{are present in the input tensor}}, thus the number of |
| | channels is 7. When nnpfc_auxiliary_inp_idc is equal to 2, the input tensor consists |
| | of four luma matrices, two chroma matrices, and six auxiliary input matrices, thus |
| | the number of channels is 12. When nnpfc_auxiliary_inp_idc is equal to 3, the input |
| | tensor consists of four luma matrices, two chroma matrices, and seven auxiliary |
| | input matrices, thus the number of channels is 13. The luma channels are derived in |
| | an interleaved manner as illustrated in Fig. 4. This nnpfc_inp_order_idc value can only |
| | be used when the chroma format is 4:2:0. |
| {{4..255}} | reserved |
| 10..255 | |

A patch is a rectangular array of samples from a component (e.g., a luma or chroma component) of a picture.

nnpfc_constant_patch_size_flag equal to 0 specifies that the post-processing filter accepts any patch size that is a positive integer multiple of the patch size indicated by nnpfc_patch_width_minus1 and nnpfc_patch_height_minus1 as input. When nnpfc_constant_patch_size_flag is equal to 0 the patch size width shall be less than or equal to CroppedWidth. When nnpfc_constant_patch_size_flag is equal to 0 the patch size height shall be less than or equal to CroppedHeight. nnpfc_constant_patch_size_flag equal to 1 specifies that the post-processing filter accepts exactly the patch size indicated by nnpfc_patch_width_minus1 and nnpfc_patch_height_minus1 as input.

nnpfc_patch_width_minus1+1, when nnpfc_constant_patch_size_flag equal to 1, specifies the horizontal sample counts of the patch size required for the input to the post-processing filter. When nnpfc_constant_patch_size_flag is equal to 0, any positive integer multiple of (nnpfc_patch_width_minus1+1) may be used as the horizontal sample counts of the patch size used for the input to the post-processing filter. The value of nnpfc_patch_width_minus1 shall be in the range of 0 to Min (32766, CroppedWidth−1), inclusive. nnpfc_patch_height_minus1+1, when nnpfc_constant_patch_size_flag equal to 1, specifies the vertical sample counts of the patch size required for the input to the post-processing filter. When nnpfc_constant_patch_size_flag is equal to 0, any positive integer multiple of (nnpfc_patch_height_minus1+1) may be used as the vertical sample counts of the patch size used for the input to the post-processing filter. The value of nnpfc_patch_height_minus1 shall be in the range of 0 to Min (32766, CroppedHeight−1), inclusive. nnpfc_overlap specifies the overlapping horizontal and vertical sample counts of adjacent input tensors of the post-processing filter. The value of nnpfc_overlap shall be in the range of 0 to 16383, inclusive.

The variables inpPatchWidth, inpPatchHeight, outPatchWidth, outPatchHeight, horCScaling, verCScaling, outPatchCWidth, outPatchCHeight, and overlapSize are derived as follows:

$$inpPatchWidth = nnpfc\_patch \_width \_minus1 + 1 \qquad ( 79 )$$

$$inpPatch Height = nnpfc\_patch \_ height \_minus1 + 1$$

$$outPatchWidth = ( nnpfc\_pic \_width \_in \_luma \_samples * inpPatchWidth ) / CroppedWidth$$

$$outPatchHeight = ( nnpfc\_pic \_height \_in \_luma \_samples * inpPatchHeight ) / CroppedHeight$$

$$horCScaling = SubWidthC / outSubWidthC$$

$$verCScaling = SubHeightC / outSubHeightC$$

$$outPatchCWidth = outPatchWidth * horCScaling$$

$$outPatchCHeight = outPatchHeight * verCScaling$$

$$overlapSize = nnpfc\_overlap$$

It is a requirement of bitstream conformance that outPatchWidth*CroppedWidth shall be equal to nnpfc_pic_width_in_luma_samples*inpPatchWidth and outPatchHeight*CroppedHeight shall be equal to nnpfc_pic_height_in_luma_samples*inpPatchHeight.

nnpfc_padding_type specifies the process of padding when referencing sample locations outside the boundaries of the cropped decoded output picture as described in Table 3. The value of nnpfc_padding_type shall be in the range of 0 to 15, inclusive.

nnpfc_luma_padding_val specifies the luma value to be used for padding when nnpfc_padding_type is equal to 4.

nnpfc_cb_padding_val specifies the Cb value to be used for padding when nnpfc_padding_type is equal to 4. nnpfc_cr_padding_val specifies the Cr value to be used for padding when nnpfc_padding_type is equal to 4. The function InpSampleVal(y, x, picHeight, picWidth, croppedPic) with inputs being a vertical sample location y, a horizontal sample location x, a picture height picHeight, a picture width picWidth, and sample array croppedPic returns the value of sample Val derived as follows:

```
if( nnpfc_padding_type = = 0 )
  if( y < 0 || x <0 || y >= picHeight || x >= picWidth )
    sampleVal = 0
  else
    sampleVal = croppedPic[ x ][ y ] (80)
else if( nnpfc_padding_type = = 1 )
  sampleVal = croppedPic[ Clip3( 0, picWidth − 1, x) ][ Clip3( 0,
  picHeight − 1, y ) ]
else if( nnpfc_padding_type = = 2 )
  sampleVal = croppedPic[ Reflect( picWidth − 1, x) ][ Reflect(
  picHeight − 1, y ) ]
else if( nnpfc_padding_type = = 3 )
  if(y >= 0 && y < picHeight)
    sampleVal = croppedPic[ Wrap( picWidth − 1, x ) ][ y ]
else if( nnpfc_padding_type = = 4 )
  if( y < 0 || x < 0 || y >= picHeight || x >= picWidth )
    sampleVal[ 0 ] = nnpfc_luma_padding_val
    sampleVal[ 1 ] = nnpfc_cb_padding_val
    sampleVal[ 2 ] = nnpfc_cr_padding_val
  else
    sampleVal = croppedPic[ x ][ y ]
```

TABLE 9
Process for deriving the input tensors inputTensor for a given vertical sample
coordinate cTop and a horizontal sample coordinate cLeft specifying the top-
left sample location for the patch of samples included in the input tensors

| nnpfc_inp_{—} | | |
|---|---|---|
| order_idc | Process DeriveInputTensors( ) for deriving input tensors | |
| 0 | for( yP = −overlapSize; yP < inpPatchHeight + overlapSize; yP++) | |
| | for( xP = −overlapSize; xP < inpPatchWidth + overlapSize; xP++ ) { | |
| | inpVal = InpY( InpSampleVal( cTop + yP, cLeft + xP, CroppedHeight, | |
| | | CroppedWidth, CroppedYPic ) ) |
| | if( nnpfc_component_last_flag = = 0 ) | |
| | | inputTensor[ 0 ][ 0 ][ yP + overlapSize ][ xP + overlapSize ] = inpVal |
| | else | |
| | | inputTensor[ 0 ][ yP + overlapSize ][ xP + overlapSize ][ 0 ] = inpVal |
| | if(nnpfc_auxiliary_inp_idc = = 1) { | |
| | | if( nnpfc_component_last_flag = = 0 ) |
| | | inputTensor[ 0 ][ 1 ][ yP + overlapSize ][ xP + overlapSize ] = 2^{(StrengthControlVal - 42)/6} |
| | | else |
| | | inputTensor[ 0 ][ yP + overlapSize ][ xP + overlapSize ][ 1 ] = 2^{(StrengthControlVal - 42)/6} |
| | } else if (nnpfc_auxiliary_inp_idc = = 2) { | |
| | | inpPred = InpY( InpSampleVal( cTop + yP, cLeft + xP, CroppedHeight, |
| | | CroppedWidth, CroppedYPred ) ) |
| | if( nnpfc_component_last_flag = = 0 ) | |
| | | inputTensor[ 0 ][ 1 ][ yP + overlapSize ][ xP + overlapSize ] = inpPred |
| | | else |
| | | inputTensor[ 0 ][ yP + overlapSize ][ xP + overlapSize ][ 1 ] = inpPred |
| | } else if (nnpfc_auxiliary_inp_idc = = 3) { | |
| | | inpPred = InpY( InpSampleVal( cTop + yP, cLeft + xP, CroppedHeight, |
| | | CroppedWidth, CroppedYPred ) ) |
| | | if( nnpfc_component_last_flag = = 0 ) { |
| | | inputTensor[ 0 ][ 1 ][ yP + overlapSize ][ xP + overlapSize ] = 2^{(StrengthControlVal - 42)/6} |
| | | inputTensor[ 0 ][ 2 ][ yP + overlapSize ][ xP + overlapSize ] = inpPred |
| | | } else { |
| | | inputTensor[ 0 ][ yP + overlapSize ][ xP + overlapSize ][ 1 ] = 2^{(StrengthControlVal - 42)/6} |
| | | inputTensor[ 0 ][ yP + overlapSize ][ xP + overlapSize ][ 2 ] = inpPred |
| | | } |
| | } | |
| | } | |
| 1 | for( yP = −overlapSize; yP < inpPatchHeight + overlapSize; yP++) | |
| | for( xP = −overlapSize; xP < inpPatchWidth + overlapSize; xP++ ) { | |
| | inpCbVal = InpC( InpSampleVal( cTop + yP, cLeft + xP, CroppedHeight / | |
| | SubHeightC, | |
| | | CroppedWidth / SubWidthC, CroppedCbPic ) ) |
| | if( nnpfc_component_last_flag = = 0 ) | |
| | | inputTensor[ 0 ][ 0 ][ yP + overlapSize ][ xP + overlapSize ] = inpCbVal |
| | else | |
| | | inputTensor[ 0 ][ yP + overlapSize ][ xP + overlapSize ][ 0 ] = inpCbVal |
| | if(nnpfc_auxiliary_inp_idc = = 1) { | |
| | | if( nnpfc_component_last_flag = = 0 ) |
| | | inputTensor[ 0 ][ 1 ][ yP + overlapSize ][ xP + overlapSize ] = 2^{(StrengthControlVal - 42)/6} |
| | | else |
| | | inputTensor[ 0 ][ yP + overlapSize ][ xP + overlapSize ][ 1 ] = 2^{(StrengthControlVal - 42)/6} |
| | } else if (nnpfc_auxiliary_inp_idc = = 2) { | |
| | | inpCbPred = InpC( InpSampleVal( cTop + yP, cLeft + xP, CroppedHeight, |
| | | CroppedWidth, CroppedCbPred ) ) |
| | | if( nnpfc_component_last_flag = = 0 ) |
| | | inputTensor[ 0 ][ 1 ][ yP + overlapSize ][ xP + overlapSize ] = inpCbPred |
| | | else |
| | | inputTensor[ 0 ][ yP + overlapSize ][ xP + overlapSize ][ 1 ] = inpCbPred |
| | } else if (nnpfc_auxiliary_inp_idc = = 3) { | |
| | | inpCbPred = InpC( InpSampleVal( cTop + yP, cLeft + xP, CroppedHeight, |
| | | CroppedWidth, CroppedCbPred ) ) |
| | | if( nnpfc_component_last_flag = = 0 ) { |
| | | inputTensor[ 0 ][ 1 ][ yP + overlapSize ][ xP + overlapSize ] = 2^{(StrengthControlVal - 42)/6} |
| | | inputTensor[ 0 ][ 2 ][ yP + overlapSize ][ xP + overlapSize ] = inpCbPred |
| | | } else { |
| | | inputTensor[ 0 ][ yP + overlapSize ][ xP + overlapSize ][ 1 ] = 2^{(StrengthControlVal - 42)/6} |
| | | inputTensor[ 0 ][ yP + overlapSize ][ xP + overlapSize ][ 2 ] = inpCbPred |
| | | } |
| | } | |
| | } | |
| 2 | for( yP = −overlapSize; yP < inpPatchHeight + overlapSize; yP++) | |
| | for( xP = −overlapSize; xP < inpPatchWidth + overlapSize; xP++ ) { | |
| | inpCrVal = InpC( InpSampleVal( cTop + yP, cLeft + xP, CroppedHeight / | |
| | SubHeightC, | |
| | | CroppedWidth / SubWidthC, CroppedCrPic ) ) |
| | if( nnpfc_component_last_flag = = 0 ) | |
| | | inputTensor[ 0 ][ 0 ][ yP + overlapSize ][ xP + overlapSize ] = inpCrVal |
| | else | |
| | | inputTensor[ 0 ][ yP + overlapSize ][ xP + overlapSize ][ 0 ] = inpCrVal |
| | if(nnpfc_auxiliary_inp_idc = = 1) { | |
| | | if( nnpfc_component_last_flag = = 0 ) |
| | | inputTensor[ 0 ][ 1 ][ yP + overlapSize ][ xP + overlapSize ] = 2^{(StrengthControlVal - 42)/6} |
| | | else |
| | | inputTensor[ 0 ][ yP + overlapSize ][ xP + overlapSize ][ 1 ] = 2^{(StrengthControlVal - 42)/6} |
| | } else if (nnpfc_auxiliary_inp_idc = = 2) { | |
| | | inpCrPred = InpC( InpSampleVal( cTop + yP, cLeft + xP, CroppedHeight, |
| | | CroppedWidth, CroppedCrPred ) ) |
| | | if( nnpfc_component_last_flag = = 0 ) |
| | | inputTensor[ 0 ][ 1 ][ yP + overlapSize ][ xP + overlapSize ] = inpCrPred |
| | | else |
| | | inputTensor[ 0 ][ yP + overlapSize ][ xP + overlapSize ][ 1 ] = inpCrPred |
| | } else if (nnpfc_auxiliary_inp_idc = = 3) { | |
| | | inpCbPred = InpC( InpSampleVal( cTop + yP, cLeft + xP, CroppedHeight, |
| | | CroppedWidth, CroppedCbPred ) ) |
| | | inpCrPred = InpC( InpSampleVal( cTop + yP, cLeft + xP, CroppedHeight, |
| | | CroppedWidth, CroppedCrPred ) ) |
| | | if( nnpfc_component_last_flag = = 0 ) { |
| | | inputTensor[ 0 ][ 2 ][ yP + overlapSize ][ xP + overlapSize ] = 2^{(StrengthControlVal - 42)/6} |
| | | inputTensor[ 0 ][ 3 ][ yP + overlapSize ][ xP + overlapSize ] = inpCbPred |
| | | inputTensor[ 0 ][ 4 ][ yP + overlapSize ][ xP + overlapSize ] = inpCrPred |
| | | } else { |
| | | inputTensor[ 0 ][ yP + overlapSize ][ xP + overlapSize ][ 2 ] = 2^{(StrengthControlVal - 42)/6} |
| | | inputTensor[ 0 ][ yP + overlapSize ][ xP + overlapSize ][ 3 ] = inpCbPred |
| | | inputTensor[ 0 ][ yP + overlapSize ][ xP + overlapSize ][ 4 ] = inpCrPred |
| | | } |
| | } | |
| | } | |
| {{1}}3 | for( yP = −overlapSize; yP < inpPatchHeight + overlapSize; yP++) | |
| | for( xP = −overlapSize; xP < inpPatchWidth + overlapSize; xP++ ) { | |
| | inpCbVal = InpC( InpSampleVal( cTop + yP, cLeft + xP, CroppedHeight / SubHeightC, | |
| | | CroppedWidth / SubWidthC, CroppedCbPic ) ) |
| | inpCrVal = InpC( InpSampleVal( cTop + yP, cLeft + xP, CroppedHeight / SubHeightC, | |
| | | CroppedWidth / SubWidthC, CroppedCrPic ) ) |
| | if( nnpfc_component_last_flag = = 0 ) { | |
| | | inputTensor[ 0 ][ 0 ][ yP + overlapSize ][ xP + overlapSize ] = inpCbVal |
| | | inputTensor[ 0 ][ 1 ][ yP + overlapSize ][ xP + overlapSize ] = inpCrVal |
| | } else { | |
| | | inputTensor[ 0 ][ yP + overlapSize ][ xP + overlapSize ][ 0 ] = inpCbVal |
| | | inputTensor[ 0 ][ yP + overlapSize ][ xP + overlapSize ][ 1 ] = inpCrVal |
| | } | |
| | if(nnpfc_auxiliary_inp_idc = = 1) { | |
| | | if( nnpfc_component_last_flag = = 0 ) |
| | | inputTensor[ 0 ][ 2 ][ yP + overlapSize ][ xP + overlapSize ] = 2^{(StrengthControlVal - 42)/6} |
| | | else |
| | | inputTensor[ 0 ][ yP + overlapSize ][ xP + overlapSize ][ 2 ] = 2^{(StrengthControlVal - 42)/6} |
| | } else if (nnpfc_auxiliary_inp_idc = = 2) { | |
| | | inpCbPred = InpC( InpSampleVal( cTop + yP, cLeft + xP, CroppedHeight, |
| | | CroppedWidth, CroppedCbPred ) ) |
| | | inpCrPred = InpC( InpSampleVal( cTop + yP, cLeft + xP, CroppedHeight, |
| | | CroppedWidth, CroppedCrPred ) ) |
| | | if( nnpfc_component_last_flag = = 0 ) { |
| | | inputTensor[ 0 ][ 2 ][ yP + overlapSize ][ xP + overlapSize ] = inpCbPred |
| | | inputTensor[ 0 ][ 3 ][ yP + overlapSize ][ xP + overlapSize ] = inpCrPred |
| | | } else { |
| | | inputTensor[ 0 ][ yP + overlapSize ][ xP + overlapSize ][ 2 ] = inpCbPred |
| | | inputTensor[ 0 ][ yP + overlapSize ][ xP + overlapSize ][ 3 ] = inpCrPred |
| | | } |
| | } else if (nnpfc_auxiliary_inp_idc = = 3) { | |
| | | inpCrPred = InpC( InpSampleVal( cTop + yP, cLeft + xP, CroppedHeight, |
| | | CroppedWidth, CroppedCrPred ) ) |
| | | if( nnpfc_component_last_flag = = 0 ) { |
| | | inputTensor[ 0 ][ 1 ][ yP + overlapSize ][ xP + overlapSize ] = 2^{(StrengthControlVal - 42)/6Z} |
| | | inputTensor[ 0 ][ 2 ][ yP + overlapSize ][ xP + overlapSize ] = inpCrPred |
| | | } else { |
| | | inputTensor[ 0 ][ yP + overlapSize ][ xP + overlapSize ][ 1 ] = 2^{(StrengthControlVal - 42)/6} |
| | | inputTensor[ 0 ][ yP + overlapSize ][ xP + overlapSize ][ 2 ] = inpCrPred |
| | | } |
| | } | |
| | } | |
| 4 | for( yP = −overlapSize; yP < inpPatchHeight + overlapSize; yP++) | |
| | for( xP = −overlapSize; xP < inpPatchWidth + overlapSize; xP++ ) { | |
| | yY = cTop + yP | |
| | xY = cLeft + xP | |
| | yC = yY / SubHeightC | |
| | xC = xY / SubWidthC | |
| | inpYVal = InpY( InpSampleVal( yY, xY, CroppedHeight, | |
| | | CroppedWidth, CroppedYPic ) ) |
| | inpCbVal = InpC( InpSampleVal( yC, xC, CroppedHeight / SubHeightC, | |
| | | CroppedWidth / SubWidthC, CroppedCbPic ) ) |
| | if( nnpfc_component_last_flag = = 0 ) { | |
| | | inputTensor[ 0 ][ 0 ][ yP + overlapSize ][ xP + overlapSize ] = inpYVal |
| | | inputTensor[ 0 ][ 1 ][ yP + overlapSize ][ xP + overlapSize ] = inpCbVal |
| | } else { | |
| | | inputTensor[ 0 ][ yP + overlapSize ][ xP + overlapSize ][ 0 ] = inpYVal |
| | | inputTensor[ 0 ][ yP + overlapSize ][ xP + overlapSize ][ 1 ] = inpCbVal |
| | } | |
| | if(nnpfc_auxiliary_inp_idc = = 1) { | |
| | | if( nnpfc_component_last_flag = = 0 ) |
| | | inputTensor[ 0 ][ 2 ][ yP + overlapSize ][ xP + overlapSize ] = 2^{(StrengthControlVal - 42)/6} |
| | | else |
| | | inputTensor[ 0 ][ yP + overlapSize ][ xP + overlapSize ][ 2 ] = 2^{(StrengthControlVal - 42)/6} |
| | } else if (nnpfc_auxiliary_inp_idc = = 2) { | |
| | | inpYPred = InpY( InpSampleVal( yY, xY, CroppedHeight, |
| | | CroppedWidth, CroppedYPred ) ) |
| | | inpCbPred = InpC( InpSampleVal( yC, xC, CroppedHeight / SubHeightC, |
| | | CroppedWidth / SubWidthC, CroppedCbPred ) ) |
| | | if( nnpfc_component_last_flag = = 0 ) { |
| | | inputTensor[ 0 ][ 2 ][ yP + overlapSize ][ xP + overlapSize ] = inpYPred |
| | | inputTensor[ 0 ][ 3 ][ yP + overlapSize ][ xP + overlapSize ] = inpCbPred |
| | | } else { |
| | | inputTensor[ 0 ][ yP + overlapSize ][ xP + overlapSize ][ 2 ] = inpYPred |
| | | inputTensor[ 0 ][ yP + overlapSize ][ xP + overlapSize ][ 3 ] = inpCbPred |
| | | } |
| | } else if (nnpfc_auxiliary_inp_idc = = 3) { | |
| | | inpYPred = InpY( InpSampleVal( yY, xY, CroppedHeight, |
| | | CroppedWidth, CroppedYPred ) ) |
| | | inpCbPred = InpC( InpSampleVal( yC, xC, CroppedHeight / SubHeightC, |
| | | CroppedWidth / SubWidthC, CroppedCbPred ) ) |
| | | if( nnpfc_component_last_flag = = 0 ) { |
| | | inputTensor[ 0 ][ 2 ][ yP + overlapSize ][ xP + overlapSize ] = 2^{(StrengthControlVal - 42)/6} |
| | | inputTensor[ 0 ][ 3 ][ yP + overlapSize ][ xP + overlapSize ] = inpYPred |
| | | inputTensor[ 0 ][ 4 ][ yP + overlapSize ][ xP + overlapSize ] = inpCbPred |
| | | } else { |
| | | inputTensor[ 0 ][ yP + overlapSize ][ xP + overlapSize ][ 2 ] = 2^{(StrengthControlVal - 42)/6} |
| | | inputTensor[ 0 ][ yP + overlapSize ][ xP + overlapSize ][ 3 ] = inpYPred |
| | | inputTensor[ 0 ][ yP + overlapSize ][ xP + overlapSize ][ 4 ] = inpCbPred |
| | | } |
| | } | |
| | } | |
| 5 | for( yP = −overlapSize; yP < inpPatchHeight + overlapSize; yP++) | |
| | for( xP = −overlapSize; xP < inpPatchWidth + overlapSize; xP++ ) { | |
| | yY = cTop + yP | |
| | xY = cLeft + xP | |
| | yC = yY / SubHeightC | |
| | xC = xY / SubWidth C | |
| | inpYVal = InpY( InpSampleVal( yY, xY, CroppedHeight, | |
| | | CroppedWidth, CroppedYPic ) ) |
| | inpCrVal = InpC( InpSampleVal( yC, xC, CroppedHeight / SubHeightC, | |
| | | CroppedWidth / SubWidthC, CroppedCrPic ) ) |
| | if( nnpfc_component_last_flag = = 0 ) { | |
| | | inputTensor[ 0 ][ 0 ][ yP + overlapSize ][ xP + overlapSize ] = inpYVal |
| | | inputTensor[ 0 ][ 1 ][ yP + overlapSize ][ xP + overlapSize ] = inpCrVal |
| | } else { | |
| | | inputTensor[ 0 ][ yP + overlapSize ][ xP + overlapSize ][ 0 ] = inpYVal |
| | | inputTensor[ 0 ][ yP + overlapSize ][ xP + overlapSize ][ 1 ] = inpCrVal |
| | } | |
| | if(nnpfc_auxiliary_inp_idc = = 1) { | |
| | | if( nnpfc_component_last_flag = = 0 ) |
| | | inputTensor[ 0 ][ 2 ][ yP + overlapSize ][ xP + overlapSize ] = 2^{(StrengthControlVal - 42)/6} |
| | | else |
| | | inputTensor[ 0 ][ yP + overlapSize ][ xP + overlapSize ][ 2 ] = 2^{(StrengthControlVal - 42)/6} |
| | } else if (nnpfc_auxiliary_inp_idc = = 2) { | |
| | | inpYPred = InpY( InpSampleVal( yY, xY, CroppedHeight, |
| | | CroppedWidth, CroppedYPred ) ) |
| | | inpCrPred = InpC( InpSampleVal( yC, xC, CroppedHeight / SubHeightC, |
| | | CroppedWidth / SubWidthC, CroppedCrPred ) ) |
| | | if( nnpfc_component_last_flag = = 0 ) { |
| | | inputTensor[ 0 ][ 2 ][ yP + overlapSize ][ xP + overlapSize ] = inpYPred |
| | | inputTensor[ 0 ][ 3 ][ yP + overlapSize ][ xP + overlapSize ] = inpCrPred |
| | | } else { |
| | | inputTensor[ 0 ][ yP + overlapSize ][ xP + overlapSize ][ 2 ] = inpYPred |
| | | inputTensor[ 0 ][ yP + overlapSize ][ xP + overlapSize ][ 3 ] = inpCrPred |
| | | } |
| | } else if (nnpfc_auxiliary_inp_idc = = 3) { | |
| | | inpYPred = InpY( InpSampleVal( yY, xY, CroppedHeight, |
| | | CroppedWidth, CroppedYPred ) ) |
| | | inpCrPred = InpC( InpSampleVal( yC, xC, CroppedHeight / SubHeightC, |
| | | CroppedWidth / SubWidthC, CroppedCrPred ) ) |
| | | if( nnpfc_component_last_flag = = 0 ) { |
| | | inputTensor[ 0 ][ 2 ][ yP + overlapSize ][ xP + overlapSize ] = 2^{(StrengthControlVal - 42)/6} |
| | | inputTensor[ 0 ][ 3 ][ yP + overlapSize ][ xP + overlapSize ] = inpYPred |
| | | inputTensor[ 0 ][ 4 ][ yP + overlapSize ][ xP + overlapSize ] = inpCrPred |
| | | } else { |
| | | inputTensor[ 0 ][ yP + overlapSize ][ xP + overlapSize ][ 2 ] = 2^{(StrengthControlVal - 42)/6} |
| | | inputTensor[ 0 ][ yP + overlapSize ][ xP + overlapSize ][ 3 ] = inpYPred |
| | | inputTensor[ 0 ][ yP + overlapSize ][ xP + overlapSize ][ 4 ] = inpCrPred |
| | | } |
| | } | |
| | } | |
| {{2}}6 | for( yP = −overlapSize; yP < inpPatchHeight + overlapSize; yP++) | |
| | for( xP = −overlapSize; xP < inpPatchWidth + overlapSize; xP++ ) { | |
| | yY = cTop + yP | |
| | xY = cLeft + xP | |
| | yC = yY / SubHeightC | |
| | xC = xY / SubWidthC | |
| | inpYVal = InpY( InpSampleVal( yY, xY, CroppedHeight, | |
| | | CroppedWidth, CroppedYPic ) ) |
| | inpCbVal = InpC( InpSampleVal( yC, xC, CroppedHeight / SubHeightC, | |
| | | CroppedWidth / SubWidthC, CroppedCbPic ) ) |
| | inpCrVal = InpC( InpSampleVal( yC, xC, CroppedHeight / SubHeightC, | |
| | | CroppedWidth / SubWidthC, CroppedCrPic ) ) |
| | if( nnpfc_component_last_flag = = 0 ) { | |
| | | inputTensor[ 0 ][ 0 ][ yP + overlapSize ][ xP + overlapSize ] = inpYVal |
| | | inputTensor[ 0 ][ 1 ][ yP + overlapSize ][ xP + overlapSize ] = inpCbVal |
| | | inputTensor[ 0 ][ 2 ][ yP + overlapSize ][ xP + overlapSize ] = inpCrVal |
| | } else { | |
| | | inputTensor[ 0 ][ yP + overlapSize ][ xP + overlapSize ][ 0 ] = inpYVal |
| | | inputTensor[ 0 ][ yP + overlapSize ][ xP + overlapSize ][ 1 ] = inpCbVal |
| | | inputTensor[ 0 ][ yP + overlapSize ][ xP + overlapSize ][ 2 ] = inpCrVal |
| | } | |
| | if(nnpfc_auxiliary_inp_idc = = 1) { | |
| | | if( nnpfc_component_last_flag = = 0 ) |
| | | inputTensor[ 0 ][ 3 ][ yP + overlapSize ][ xP + overlapSize ] = 2^{(StrengthControlVal - 42)/6} |
| | | else |
| | | inputTensor[ 0 ][ yP + overlapSize ][ xP + overlapSize ][ 3 ] = 2^{(StrengthControlVal - 42)/6} |
| | } else if (nnpfc_auxiliary_inp_idc = = 2) { | |
| | | inpYPred = InpY( InpSampleVal( yY, xY, CroppedHeight, |
| | | CroppedWidth, CroppedYPred ) ) |
| | | inpCbPred = InpC( InpSampleVal( yC, xC, CroppedHeight / SubHeightC, |
| | | CroppedWidth / SubWidthC, CroppedCbPred ) ) |
| | | inpCrPred = InpC( InpSampleVal( yC, xC, CroppedHeight / SubHeightC, |
| | | CroppedWidth / SubWidthC, CroppedCrPred ) ) |
| | | if( nnpfc_component_last_flag = = 0 ) { |
| | | inputTensor[ 0 ][ 3 ][ yP + overlapSize ][ xP + overlapSize ] = inpYPred |
| | | inputTensor[ 0 ][ 4 ][ yP + overlapSize ][ xP + overlapSize ] = inpCbPred |
| | | inputTensor[ 0 ][ 5 ][ yP + overlapSize ][ xP + overlapSize ] = inpCrPred |
| | | } else { |
| | | inputTensor[ 0 ][ yP + overlapSize ][ xP + overlapSize ][ 3 ] = inpYPred |
| | | inputTensor[ 0 ][ yP + overlapSize ][ xP + overlapSize ][ 4 ] = inpCbPred |
| | | inputTensor[ 0 ][ yP + overlapSize ][ xP + overlapSize ][ 5 ] = inpCrPred |
| | | } |
| | } else if (nnpfc_auxiliary_inp_idc = = 3) { | |
| | | inpYPred = InpY( InpSampleVal( yY, xY, CroppedHeight, |
| | | CroppedWidth, CroppedYPred ) ) |
| | | inpCbPred = InpC( InpSampleVal( yC, xC, CroppedHeight / SubHeightC, |
| | | CroppedWidth / SubWidthC, CroppedCbPred ) ) |
| | | inpCrPred = InpC( InpSampleVal( yC, xC, CroppedHeight / SubHeightC, |
| | | CroppedWidth / SubWidthC, CroppedCrPred ) ) |
| | | if( nnpfc_component_last_flag = = 0 ) { |
| | | inputTensor[ 0 ][ 3 ][ yP + overlapSize ][ xP + overlapSize ] = 2^{(StrengthControlVal - 42)/6} |
| | | inputTensor[ 0 ][ 4 ][ yP + overlapSize ][ xP + overlapSize ] = inpYPred |
| | | inputTensor[ 0 ][ 5 ][ yP + overlapSize ][ xP + overlapSize ] = inpCbPred |
| | | inputTensor[ 0 ][ 6 ][ yP + overlapSize ][ xP + overlapSize ] = inpCrPred |
| | | } else { |
| | | inputTensor[ 0 ][ yP + overlapSize ][ xP + overlapSize ][ 3 ] = 2^{(StrengthControlVal - 42)/6} |
| | | inputTensor[ 0 ][ yP + overlapSize ][ xP + overlapSize ][ 4 ] = inpYPred |
| | | inputTensor[ 0 ][ yP + overlapSize ][ xP + overlapSize ][ 5 ] = inpCbPred |
| | | inputTensor[ 0 ][ yP + overlapSize ][ xP + overlapSize ][ 6 ] = inpCrPred |
| | | } |
| | } | |
| | } | |
| 7 | for( yP = −overlapSize; yP < inpPatchHeight + overlapSize; yP++) | |
| | for( xP = −overlapSize; xP < inpPatchWidth + overlapSize; xP++ ) { | |
| | yTL = cTop + yP * 2 | |
| | xTL = cLeft + xP * 2 | |
| | yBR = yTL + 1 | |
| | xBR = xTL + 1 | |
| | yC = cTop / 2 + yP | |
| | xC = cLeft / 2 + xP | |
| | inpTLVal = InpY( InpSampleVal( yTL, xTL, CroppedHeight, | |
| | | CroppedWidth, CroppedYPic ) ) |
| | inpTRVal = InpY( InpSampleVal( yTL, xBR, CroppedHeight, | |
| | | CroppedWidth, CroppedYPic ) ) |
| | inpBLVal = InpY( InpSampleVal( yBR, xTL, CroppedHeight, | |
| | | CroppedWidth, CroppedYPic ) ) |
| | inpBRVal = InpY( InpSampleVal( yBR, xBR, CroppedHeight, | |
| | | CroppedWidth, CroppedYPic ) ) |
| | inpCbVal = InpC( InpSampleVal( yC, xC, CroppedHeight / 2, | |
| | | CroppedWidth / 2, CroppedCbPic ) ) |
| | if( nnpfc_component_last_flag = = 0 ) { | |
| | | inputTensor[ 0 ][ 0 ][ yP + overlapSize ][ xP + overlapSize ] = inpTLVal |
| | | inputTensor[ 0 ][ 1 ][ yP + overlapSize ][ xP + overlapSize ] = inpTRVal |
| | | inputTensor[ 0 ][ 2 ][ yP + overlapSize ][ xP + overlapSize ] = inpBLVal |
| | | inputTensor[ 0 ][ 3 ][ yP + overlapSize ][ xP + overlapSize ] = inpBRVal |
| | | inputTensor[ 0 ][ 4 ][ yP + overlapSize ][ xP + overlapSize ] = inpCbVal |
| | } else { | |
| | | inputTensor[ 0 ][ yP + overlapSize ][ xP + overlapSize ][ 0 ] = inpTLVal |
| | | inputTensor[ 0 ][ yP + overlapSize ][ xP + overlapSize ][ 1 ] = inpTRVal |
| | | inputTensor[ 0 ][ yP + overlapSize ][ xP + overlapSize ][ 2 ] = inpBLVal |
| | | inputTensor[ 0 ][ yP + overlapSize ][ xP + overlapSize ][ 3 ] = inpBRVal |
| | | inputTensor[ 0 ][ yP + overlapSize ][ xP + overlapSize ][ 4 ] = inpCbVal |
| | } | |
| | if(nnpfc_auxiliary_inp_idc = = 1) { | |
| | | if( nnpfc_component_last_flag = = 0 ) |
| | | inputTensor[ 0 ][ 5 ][ yP + overlapSize ][ xP + overlapSize ] = 2^{(StrengthControlVal - 42)/6} |
| | | else |
| | | inputTensor[ 0 ][ yP + overlapSize ][ xP + overlapSize ][ 5 ] = 2^{(StrengthControlVal - 42)/6} |
| | } else if (nnpfc_auxiliary_inp_idc = = 2) { | |
| | | inpTLPred = InpY( InpSampleVal( yTL, xTL, CroppedHeight, |
| | | CroppedWidth, CroppedYPred ) ) |
| | | inpTRPred = InpY( InpSampleVal( yTL, xBR, CroppedHeight, |
| | | CroppedWidth, CroppedYPred ) ) |
| | | inpBLPred = InpY( InpSampleVal( yBR, xTL, CroppedHeight, |
| | | CroppedWidth, CroppedYPred ) ) |
| | | inpBRPred = InpY( InpSampleVal( yBR, xBR, CroppedHeight, |
| | | CroppedWidth, CroppedYPred ) ) |
| | | inpCbPred = InpC( InpSampleVal( yC, xC, CroppedHeight / 2, |
| | | CroppedWidth / 2, CroppedCbPred ) ) |
| | | if( nnpfc_component_last_flag = = 0 ) { |
| | | inputTensor[ 0 ][ 5 ][ yP + overlapSize ][ xP + overlapSize ] = inpTLPred |
| | | inputTensor[ 0 ][ 6 ][ yP + overlapSize ][ xP + overlapSize ] = inpTRPred |
| | | inputTensor[ 0 ][ 7 ][ yP + overlapSize ][ xP + overlapSize ] = inpBLPred |
| | | inputTensor[ 0 ][ 8 ][ yP + overlapSize ][ xP + overlapSize ] = inpBRPred |
| | | inputTensor[ 0 ][ 9 ][ yP + overlapSize ][ xP + overlapSize ] = inpCbPred |
| | | } else { |
| | | inputTensor[ 0 ][ yP + overlapSize ][ xP + overlapSize ][ 5 ] = inpTLPred |
| | | inputTensor[ 0 ][ yP + overlapSize ][ xP + overlapSize ][ 6 ] = inpTRPred |
| | | inputTensor[ 0 ][ yP + overlapSize ][ xP + overlapSize ][ 7 ] = inpBLPred |
| | | inputTensor[ 0 ][ yP + overlapSize ][ xP + overlapSize ][ 8 ] = inpBRPred |
| | | inputTensor[ 0 ][ yP + overlapSize ][ xP + overlapSize ][ 9 ] = inpCbPred |
| | | } |
| | } else if (nnpfc_auxiliary_inp_idc = = 3) { | |
| | | inpTLPred = InpY( InpSampleVal( yTL, xTL, CroppedHeight, |
| | | CroppedWidth, CroppedYPred ) ) |
| | | inpTRPred = InpY( InpSampleVal( yTL, xBR, CroppedHeight, |
| | | CroppedWidth, CroppedYPred ) ) |
| | | inpBLPred = InpY( InpSampleVal( yBR, xTL, CroppedHeight, |
| | | CroppedWidth, CroppedYPred ) ) |
| | | inpBRPred = InpY( InpSampleVal( yBR, xBR, CroppedHeight, |
| | | CroppedWidth, CroppedYPred ) ) |
| | | inpCbPred = InpC( InpSampleVal( yC, xC, CroppedHeight / 2, |
| | | CroppedWidth / 2, CroppedCbPred ) ) |
| | | if( nnpfc_component_last_flag = = 0 ) { |
| | | inputTensor[ 0 ][ 5 ][ yP + overlapSize ][ xP + overlapSize ] = 2^{(StrengthControlVal - 42)/6} |
| | | inputTensor[ 0 ][ 6 ][ yP + overlapSize ][ xP + overlapSize ] = inpTLPred |
| | | inputTensor[ 0 ][ 7 ][ yP + overlapSize ][ xP + overlapSize ] = inpTRPred |
| | | inputTensor[ 0 ][ 8 ][ yP + overlapSize ][ xP + overlapSize ] = inpBLPred |
| | | inputTensor[ 0 ][ 9 ][ yP + overlapSize ][ xP + overlapSize ] = inpBRPred |
| | | inputTensor[ 0 ][ 10 ][ yP + overlapSize ][ xP + overlapSize ] = inpCbPred |
| | | } else { |
| | | inputTensor[ 0 ][ yP + overlapSize ][ xP + overlapSize ][ 5 ] = 2^{(StrengthControlVal - 42)/6} |
| | | inputTensor[ 0 ][ yP + overlapSize ][ xP + overlapSize ][ 6 ] = inpTLPred |
| | | inputTensor[ 0 ][ yP + overlapSize ][ xP + overlapSize ][ 7 ] = inpTRPred |
| | | inputTensor[ 0 ][ yP + overlapSize ][ xP + overlapSize ][ 8 ] = inpBLPred |
| | | inputTensor[ 0 ][ yP + overlapSize ][ xP + overlapSize ][ 9 ] = inpBRPred |
| | | inputTensor[ 0 ][ yP + overlapSize ][ xP + overlapSize ][ 10 ] = inpCbPred |
| | | } |
| | } | |
| | } | |
| 8 | for( yP = −overlapSize; yP < inpPatchHeight + overlapSize; yP++) | |
| | for( xP = −overlapSize; xP < inpPatchWidth + overlapSize; xP++ ) { | |
| | yTL = cTop + yP * 2 | |
| | xTL= cLeft + xP * 2 | |
| | yBR = yTL + 1 | |
| | xBR = xTL + 1 | |
| | yC = cTop / 2 + yP | |
| | xC = cLeft / 2 + xP | |
| | inpTLVal = InpY( InpSampleVal( yTL, xTL, CroppedHeight, | |
| | | CroppedWidth, CroppedYPic ) ) |
| | inpTRVal = InpY( InpSampleVal( yTL, xBR, CroppedHeight, | |
| | | CroppedWidth, CroppedYPic ) ) |
| | inpBLVal = InpY( InpSampleVal( yBR, xTL, CroppedHeight, | |
| | | CroppedWidth, CroppedYPic ) ) |
| | inpBRVal = InpY( InpSampleVal( yBR, xBR, CroppedHeight, | |
| | | CroppedWidth, CroppedYPic ) ) |
| | inpCrVal = InpC( InpSampleVal( yC, xC, CroppedHeight / 2, | |
| | | CroppedWidth / 2, CroppedCrPic ) ) |
| | if( nnpfc_component_last_flag = = 0 ) { | |
| | | inputTensor[ 0 ][ 0 ][ yP + overlapSize ][ xP + overlapSize ] = inpTLVal |
| | | inputTensor[ 0 ][ 1 ][ yP + overlapSize ][ xP + overlapSize ] = inpTRVal |
| | | inputTensor[ 0 ][ 2 ][ yP + overlapSize ][ xP + overlapSize ] = inpBLVal |
| | | inputTensor[ 0 ][ 3 ][ yP + overlapSize ][ xP + overlapSize ] = inpBRVal |
| | | inputTensor[ 0 ][ 4 ][ yP + overlapSize ][ xP + overlapSize ] = inpCrVal |
| | } else { | |
| | | inputTensor[ 0 ][ yP + overlapSize ][ xP + overlapSize ][ 0 ] = inpTLVal |
| | | inputTensor[ 0 ][ yP + overlapSize ][ xP + overlapSize ][ 1 ] = inpTRVal |
| | | inputTensor[ 0 ][ yP + overlapSize ][ xP + overlapSize ][ 2 ] = inpBLVal |
| | | inputTensor[ 0 ][ yP + overlapSize ][ xP + overlapSize ][ 3 ] = inpBRVal |
| | | inputTensor[ 0 ][ yP + overlapSize ][ xP + overlapSize ][ 4 ] = inpCrVal |
| | } | |
| | if(nnpfc_auxiliary_inp_idc = = 1) { | |
| | | if( nnpfc_component_last_flag = = 0 ) |
| | | inputTensor[ 0 ][ 5 ][ yP + overlapSize ][ xP + overlapSize ] = 2^{(StrengthControlVal - 42)/6} |
| | | else |
| | | inputTensor[ 0 ][ yP + overlapSize ][ xP + overlapSize ][ 5 ] = 2^{(StrengthControlVal - 42)/6} |
| | } else if (nnpfc_auxiliary_inp_idc = = 2) { | |
| | | inpTLPred = InpY( InpSampleVal( yTL, xTL, CroppedHeight, |
| | | CroppedWidth, CroppedYPred ) ) |
| | | inpTRPred = InpY( InpSampleVal( yTL, xBR, CroppedHeight, |
| | | CroppedWidth, CroppedYPred ) ) |
| | | inpBLPred = InpY( InpSampleVal( yBR, xTL, CroppedHeight, |
| | | CroppedWidth, CroppedYPred ) ) |
| | | inpBRPred = InpY( InpSampleVal( yBR, xBR, CroppedHeight, |
| | | CroppedWidth, CroppedYPred ) ) |
| | | inpCrPred = InpC( InpSampleVal( yC, xC, CroppedHeight / 2, |
| | | CroppedWidth / 2, CroppedCrPred ) ) |
| | | if( nnpfc_component_last_flag = = 0 ) { |
| | | inputTensor[ 0 ][ 5 ][ yP + overlapSize ][ xP + overlapSize ] = inpTLPred |
| | | inputTensor[ 0 ][ 6 ][ yP + overlapSize ][ xP + overlapSize ] = inpTRPred |
| | | inputTensor[ 0 ][ 7 ][ yP + overlapSize ][ xP + overlapSize ] = inpBLPred |
| | | inputTensor[ 0 ][ 8 ][ yP + overlapSize ][ xP + overlapSize ] = inpBRPred |
| | | inputTensor[ 0 ][ 9 ][ yP + overlapSize ][ xP + overlapSize ] = inpCrPred |
| | | } else { |
| | | inputTensor[ 0 ][ yP + overlapSize ][ xP + overlapSize ][ 5 ] = inpTLPred |
| | | inputTensor[ 0 ][ yP + overlapSize ][ xP + overlapSize ][ 6 ] = inpTRPred |
| | | inputTensor[ 0 ][ yP + overlapSize ][ xP + overlapSize ][ 7 ] = inpBLPred |
| | | inputTensor[ 0 ][ yP + overlapSize ][ xP + overlapSize ][ 8 ] = inpBRPred |
| | | inputTensor[ 0 ][ yP + overlapSize ][ xP + overlapSize ][ 9 ] = inpCrPred |
| | | } |
| | } else if (nnpfc_auxiliary_inp_idc = = 3) { | |
| | | inpTLPred = InpY( InpSampleVal( yTL, xTL, CroppedHeight, |
| | | CroppedWidth, CroppedYPred ) ) |
| | | inpTRPred = InpY( InpSampleVal( yTL, xBR, CroppedHeight, |
| | | CroppedWidth, CroppedYPred ) ) |
| | | inpBLPred = InpY( InpSampleVal( yBR, xTL, CroppedHeight, |
| | | CroppedWidth, CroppedYPred ) ) |
| | | inpBRPred = InpY( InpSampleVal( yBR, xBR, CroppedHeight, |
| | | CroppedWidth, CroppedYPred ) ) |
| | | inpCrPred = InpC( InpSampleVal( yC, xC, CroppedHeight / 2, |
| | | CroppedWidth / 2, CroppedCrPred ) ) |
| | | if( nnpfc_component_last_flag = = 0 ) { |
| | | inputTensor[ 0 ][ 5 ][ yP + overlapSize ][ xP + overlapSize ] = 2^{(StrengthControlVal - 42)/6} |
| | | inputTensor[ 0 ][ 6 ][ yP + overlapSize ][ xP + overlapSize ] = inpTLPred |
| | | inputTensor[ 0 ][ 7 ][ yP + overlapSize ][ xP + overlapSize ] = inpTRPred |
| | | inputTensor[ 0 ][ 8 ][ yP + overlapSize ][ xP + overlapSize ] = inpBLPred |
| | | inputTensor[ 0 ][ 9 ][ yP + overlapSize ][ xP + overlapSize ] = inpBRPred |
| | | inputTensor[ 0 ][ 10 ][ yP + overlapSize ][ xP + overlapSize ] = inpCrPred |
| | | } else { |
| | | inputTensor[ 0 ][ yP + overlapSize ][ xP + overlapSize ][ 5 ] = 2^{(StrengthControlVal - 42)/6} |
| | | inputTensor[ 0 ][ yP + overlapSize ][ xP + overlapSize ][ 6 ] = inpTLPred |
| | | inputTensor[ 0 ][ yP + overlapSize ][ xP + overlapSize ][ 7 ] = inpTRPred |
| | | inputTensor[ 0 ][ yP + overlapSize ][ xP + overlapSize ][ 8 ] = inpBLPred |
| | | inputTensor[ 0 ][ yP + overlapSize ][ xP + overlapSize ][ 9 ] = inpBRPred |
| | | inputTensor[ 0 ][ yP + overlapSize ][ xP + overlapSize ][ 10 ] = inpCrPred |
| | | } |
| | } | |
| | } | |
| {{3}}9 | for( yP = −overlapSize; yP < inpPatchHeight + overlapSize; yP++) | |
| | for( xP = −overlapSize; xP < inpPatchWidth + overlapSize; xP++ ) { | |
| | yTL = cTop + yP * 2 | |
| | xTL = cLeft + xP * 2 | |
| | yBR = yTL + 1 | |
| | xBR = xTL + 1 | |
| | yC = cTop / 2 + yP | |
| | xC = cLeft / 2 + xP | |
| | inpTLVal = InpY( InpSampleVal( yTL, xTL, CroppedHeight, | |
| | | CroppedWidth, CroppedYPic ) ) |
| | inpTRVal = InpY( InpSampleVal( yTL, xBR, CroppedHeight, | |
| | | CroppedWidth, CroppedYPic ) ) |
| | inpBLVal = InpY( InpSampleVal( yBR, xTL, CroppedHeight, | |
| | | CroppedWidth, CroppedYPic ) ) |
| | inpBRVal = InpY( InpSampleVal( yBR, xBR, CroppedHeight, | |
| | | CroppedWidth, CroppedYPic ) ) |
| | inpCbVal = InpC( InpSampleVal( yC, xC, CroppedHeight / 2, | |
| | | CroppedWidth / 2, CroppedCbPic ) ) |
| | inpCrVal = InpC( InpSampleVal( yC, xC, CroppedHeight / 2, | |
| | | CroppedWidth / 2, CroppedCrPic ) ) |
| | if( nnpfc_component_last_flag = = 0 ) { | |
| | | inputTensor[ 0 ][ 0 ][ yP + overlapSize ][ xP + overlapSize ] = inpTLVal |
| | | inputTensor[ 0 ][ 1 ][ yP + overlapSize ][ xP + overlapSize ] = inpTRVal |
| | | inputTensor[ 0 ][ 2 ][ yP + overlapSize ][ xP + overlapSize ] = inpBLVal |
| | | inputTensor[ 0 ][ 3 ][ yP + overlapSize ][ xP + overlapSize ] = inpBRVal |
| | | inputTensor[ 0 ][ 4 ][ yP + overlapSize ][ xP + overlapSize ] = inpCbVal |
| | | inputTensor[ 0 ][ 5 ][ yP + overlapSize ][ xP + overlapSize ] = inpCrVal |
| | {{ | inputTensor[ 0 ][ 6 ][ yP + overlapSize ][ xP + overlapSize ] = 2^{(StrengthControlVal - 42 )/6}}} |

} else {

inputTensor[ 0 ][ yP + overlapSize ][ xP + overlapSize ][ 0 ] = inpTLVal
inputTensor[ 0 ][ yP + overlapSize ][ xP + overlapSize ][ 1 ] = inpTRVal
inputTensor[ 0 ][ yP + overlapSize ][ xP + overlapSize ][ 2 ] = inpBLVal
inputTensor[ 0 ][ yP + overlapSize ][ xP + overlapSize ][ 3 ] = inpBRVal
inputTensor[ 0 ][ yP + overlapSize ][ xP + overlapSize ][ 4 ] = inpCbVal
inputTensor[ 0 ][ yP + overlapSize ][ xP + overlapSize ][ 5 ] = inpCrVal }

if(nnpfc_auxiliary_inp_idc = = 1) {

```
if( nnpfc_component_last_flag = = 0 )
  inputTensor[ 0 ][ 6 ][ yP + overlapSize ][ xP + overlapSize ] = 2^{(StrengthControlVal - 42)/6}
else
  inputTensor[ 0 ][ yP + overlapSize ][ xP + overlapSize ][ 6 ] = 2^{(StrengthControlVal - 42)/6}
```

} else if (nnpfc_auxiliary_inp_idc = = 2) {

```
inpTLPred = InpY( InpSampleVal( yTL, xTL, CroppedHeight,
  CroppedWidth, CroppedYPred ) )
inpTRPred = InpY( InpSampleVal( yTL, xBR, CroppedHeight,
  CroppedWidth, CroppedYPred ) )
inpBLPred = InpY( InpSampleVal( yBR, xTL, CroppedHeight,
  CroppedWidth, CroppedYPred ) )
inpBRPred = InpY( InpSampleVal( yBR, xBR, CroppedHeight,
  CroppedWidth, CroppedYPred ) )
inpCbPred = InpC( InpSampleVal( yC, xC, CroppedHeight / 2,
  CroppedWidth / 2, CroppedCbPred ) )
inpCrPred = InpC( InpSampleVal( yC, xC, CroppedHeight / 2,
  CroppedWidth / 2, CroppedCrPred ) )
if( nnpfc_component_last_flag = = 0 ) {
  inputTensor[ 0 ][ 6 ][ yP + overlapSize ][ xP + overlapSize ] = inpTLPred
  inputTensor[ 0 ][ 7 ][ yP + overlapSize ][ xP + overlapSize ] = inpTRPred
  inputTensor[ 0 ][ 8 ][ yP + overlapSize ][ xP + overlapSize ] = inpBLPred
  inputTensor[ 0 ][ 9 ][ yP + overlapSize ][ xP + overlapSize ] = inpBRPred
  inputTensor[ 0 ][ 10 ][ yP + overlapSize ][ xP + overlapSize ] = inpCbPred
  inputTensor[ 0 ][ 11 ][ yP + overlapSize ][ xP + overlapSize ] = inpCrPred
} else {
  inputTensor[ 0 ][ yP + overlapSize ][ xP + overlapSize ][ 6 ] = inpTLPred
  inputTensor[ 0 ][ yP + overlapSize ][ xP + overlapSize ][ 7 ] = inpTRPred
  inputTensor[ 0 ][ yP + overlapSize ][ xP + overlapSize ][ 8 ] = inpBLPred
  inputTensor[ 0 ][ yP + overlapSize ][ xP + overlapSize ][ 9 ] = inpBRPred
  inputTensor[ 0 ][ yP + overlapSize ][ xP + overlapSize ][ 10 ] = inpCbPred
  inputTensor[ 0 ][ yP + overlapSize ][ xP + overlapSize ][ 11 ] = inpCrPred
}
```

} else if (nnpfc_auxiliary_inp_idc = = 3) {

```
inpTLPred = InpY( InpSampleVal( yTL, xTL, CroppedHeight,
  CroppedWidth, CroppedYPred ) )
inpTRPred = InpY( InpSampleVal( yTL, xBR, CroppedHeight,
  CroppedWidth, CroppedYPred ) )
inpBLPred = InpY( InpSampleVal( yBR, xTL, CroppedHeight,
  CroppedWidth, CroppedYPred ) )
inpBRPred = InpY( InpSampleVal( yBR, xBR, CroppedHeight,
  CroppedWidth, CroppedYPred ) )
inpCbPred = InpC( InpSampleVal( yC, xC, CroppedHeight / 2,
  CroppedWidth / 2, CroppedCbPred ) )
inpCrPred = InpC( InpSampleVal( yC, xC, CroppedHeight / 2,
  CroppedWidth / 2, CroppedCrPred ) )
if( nnpfc_component_last_flag = = 0 ) {
  inputTensor[ 0 ][ 6 ][ yP + overlapSize ][ xP + overlapSize ] = 2^{(StrengthControlVal - 42)/6}
  inputTensor[ 0 ][ 7 ][ yP + overlapSize ][ xP + overlapSize ] = inpTLPred
  inputTensor[ 0 ][ 8 ][ yP + overlapSize ][ xP + overlapSize ] = inpTRPred
  inputTensor[ 0 ][ 9 ][ yP + overlapSize ][ xP + overlapSize ] = inpBLPred
  inputTensor[ 0 ][ 10 ][ yP + overlapSize ][ xP + overlapSize ] = inpBRPred
  inputTensor[ 0 ][ 11 ][ yP + overlapSize ][ xP + overlapSize ] = inpCbPred
  inputTensor[ 0 ][ 12 ][ yP + overlapSize ][ xP + overlapSize ] = inpCrPred
} else {
  inputTensor[ 0 ][ yP + overlapSize ][ xP + overlapSize ][ 6 ] = 2^{(StrengthControlVal - 42)/6}
  inputTensor[ 0 ][ yP + overlapSize ][ xP + overlapSize ][ 7 ] = inpTLPred
  inputTensor[ 0 ][ yP + overlapSize ][ xP + overlapSize ][ 8 ] = inpTRPred
  inputTensor[ 0 ][ yP + overlapSize ][ xP + overlapSize ][ 9 ] = inpBLPred
  inputTensor[ 0 ][ yP + overlapSize ][ xP + overlapSize ][ 10 ] = inpBRPred
  inputTensor[ 0 ][ yP + overlapSize ][ xP + overlapSize ][ 11 ] = inpCbPred
  inputTensor[ 0 ][ yP + overlapSize ][ xP + overlapSize ][ 12 ] = inpCrPred
}
```

| | |
|---|---|
| | } |
| | } |
| 4 . . . 255 | reserved |

nnpfc_complexity_idc greater than 0 specifies that one or more syntax elements that indicate the complexity of the post-processing filter associated with the nnpfc_id may be present. nnpfc_complexity_idc equal to 0 specifies that no syntax element that indicates the complexity of the post-processing filter associated with the nnpfc_id is present. The value nnpfc_complexity_idc shall be in the range of 0 to 255, inclusive. Values of nnpfc_complexity_idc greater than 1 are reserved for future specification by ITU-T|ISO/IEC and shall not be present in bitstreams conforming to this version of this Specification. Decoders conforming to this version of this Specification shall ignore SEI messages that contain reserved values of nnpfc_complexity_idc. nnpfc_out_format_flag equal to 0 indicates that the sample values output by the post-processing filter are real numbers and the functions OutY and OutC for converting luma sample values and chroma sample values, respectively, output by the post-processing, to integer values at bit depths BitDepth_{Y} and BitDepth_{C}, respectively, are specified as follows:

$$OutY = Clip 3 ( 0 , ( 1 << {BitDepth}_{Y} ) - 1 , Round ( x * ( ( 1 << {BitDepth}_{Y} ) - 1 ) ) ) \qquad ( 81 )$$

$$OutC = Clip 3 ( 0 , ( 1 << {BitDepth}_{C} ) - 1 , Round ( x * ( ( 1 << {BitDepth}_{C} ) - 1 ) ) ) \qquad ( 82 )$$

nnpfc_out_format_flag equal to 1 indicates that the sample values output by the post-processing filter are unsigned integer numbers and the functions OutY and OutC are specified as follows:

```
shift = outTensorBitDepth − BitDepth_{Y}
if( shift > 0 )
  OutY( x ) = Clip3( 0, ( 1 << BitDepth_{Y} ) − 1,( x + ( 1 << ( shift − 1 ) ) ) >> shift )
else
  OutY( x ) = x << ( BitDepth_{Y} − outTensorBitDepth ) (83)
shift = outTensorBitDepth − BitDepth_{C}
if( shift > 0 )
  OutC( x )= Clip3( 0, ( 1 << BitDepth_{C} ) − 1, ( x + ( 1 << ( shift − 1 ) ) ) >> shift )
else
  OutC( x ) = x << ( BitDepth_{C} − outTensorBitDepth )
```

The variable outTensorBitDepth is derived from the syntax element nnpfc_out_tensor_bitdepth_minus8 as described below.

nnpfc_out_tensor_bitdepth_minus8 plus 8 specifies the bit depth of sample values in the output integer tensor. The value of outTensorBitDepth is derived as follows:

$$outTensorBitDepth = nnpfc\_out \_tensor \_bitdepth \_minus8 + 8 \qquad ( 84 )$$

It is a requirement of bitstream conformance that the value of nnpfc_out_tensor_bitdepth_minus8 shall be in the range of 0 to 24, inclusive.

nnpfc_out_order_idc indicates the output order of samples resulting from the post-processing filter. Table 10 contains an informative description of nnpfc_out_order_idc values. The semantics of nnpfc_out_order_idc in the range of 0 to {{3}} 9, inclusive, are specified in Table 11, which specifies a process for deriving sample values in the filtered output sample arrays FilteredYPic, FilteredCbPic, and FilteredCrPic from the output tensors outputTensor for different values of nnpfc_out_order_idc and a given vertical sample coordinate cTop and a horizontal sample coordinate cLeft specifying the top-left sample location for the patch of samples included in the input tensors. When nnpfc_purpose is equal to 2 or 4, nnpfc_out_order_idc shall not be equal to {{3}} 7, 8, or 9. The value of nnpfc_out_order_idc shall be in the range of 0 to 255, inclusive. Values of nnpfc_out_order_idc greater than {{3} 9 are reserved for future specification by ITU-T|ISO/IEC and shall not be present in bitstreams conforming to this version of this Specification. Decoders conforming to this version of this Specification shall ignore SEI messages that contain reserved values of nnpfc_out_order_idc.

TABLE 10
Informative description of nnpfc_out_order_idc values

| nnpfc_out_{—} | |
|---|---|
| order_idc | Description |
| 0 | Only the luma matrix is present in the output tensor, thus the number of channels is 1. |
| 1 | Only the chroma matrix corresponding to the Cb component is present in the output |
| | tensor, thus the number of channels is 1. |
| 2 | Only the chroma matrix corresponding to the Cr component is present in the output |
| | tensor, thus the number of channels is 1. |
| {{1}3 | Only the chroma matrices are present in the output tensor, thus the number of channels is 2. |
| 4 | Only the luma and the chroma matrix corresponding to the Cb component are present |
| | in the output tensor, thus the number of channels is 2. |
| 5 | Only the luma and the chroma matrix corresponding to the Cr component are present in |
| | the output tensor, thus the number of channels is 2. |
| {{2}6 | {{The}Only the luma and chroma matrices are present in the output tensor, thus the number of |
| | channels is 3. |
| 7 | Only four luma matrices and one chroma matrix corresponding to the Cb component |
| | are present in the output tensor, thus the number of channels is 5. This |
| | nnpfc_out_order_idc value can only be used when the chroma format is 4:2:0. |
| 8 | Only four luma matrices and one chroma matrix corresponding to the Cr component |
| | are present in the output tensor, thus the number of channels is 5. This |
| | nnpfc_out_order_idc value can only be used when the chroma format is 4:2:0. |
| {{3}9 | {{Four}Only four luma matrices and two chroma matrices are present in the output tensor, |
| | thus the number of channels is 6. This nnpfc_out_order_idc value can only be used when the |
| | chroma format is 4:2:0. |
| 4..255 | reserved |

TABLE 11
Process for deriving sample values in the filtered output sample arrays FilteredYPic,
FilteredCbPic, and FilteredCrPic from the output tensors outputTensor for a given
vertical sample coordinate cTop and a horizontal sample coordinate cLeft specifying
the top-left sample location for the patch of samples included in the input tensors

| nnpfc_out_{—} | Process StoreOutputTensors( ) for deriving sample values in the filtered |
|---|---|
| order_idc | picture from the output tensors |
| 0 | for( yP = 0; yP < outPatchHeight; yP++) |
| | for( xP = 0; xP < outPatchWidth; xP++ ) { |
| | yY = cTop * outPatchHeight / inpPatchHeight + yP |
| | xY = cLeft * outPatchWidth / inpPatchWidth + xP |
| | if ( yY < nnpfc_pic_height_in_luma_samples && xY < |
| | nnpfc_pic_width_in_luma_samples ) |
| | if( nnpfc_component_last_flag = = 0 ) |
| | FilteredYPic[ xY ][ yY ] = OutY( outputTensor[ 0 ][ 0 ][ yP ][ xP ] ) |
| | else |
| | FilteredYPic[ xY ][ yY ] = OutY( outputTensor[ 0 ][ yP ][ xP ][ 0 ] ) |
| | } |
| 1 | for( yP = 0; yP < outPatchCHeight; yP++) |
| | for( xP = 0; xP < outPatchCWidth; xP++ ) { |
| | xSrc = cLeft * horCScaling + xP |
| | ySrc = cTop * verCScaling + yP |
| | if ( ySrc < nnpfc_pic_height_in_luma_samples / outSubHeightC && |
| | xSrc < nnpfc_pic_width_in_luma_samples / outSubWidthC ) |
| | if( nnpfc_component_last_flag = = 0 ) |
| | FilteredCbPic[ xSrc ][ ySrc ] = OutC( outputTensor[ 0 ][ 0 ][ yP ][ xP ] ) |
| | else |
| | FilteredCbPic[ xSrc ][ ySrc ] = OutC( outputTensor[ 0 ][ yP ][ xP ][ 0 ] ) |
| | } |
| 2 | for( yP = 0; yP < outPatchCHeight; yP++) |
| | for( xP = 0; xP < outPatchCWidth; xP++ ) { |
| | xSrc = cLeft * horCScaling + xP |
| | ySrc = cTop * verCScaling + yP |
| | if ( ySrc < nnpfc_pic_height_in_luma_samples / outSubHeightC && |
| | xSrc < nnpfc_pic_width_in_luma_samples / outSubWidthC ) |
| | if( nnpfc_component_last_flag = = 0 ) |
| | FilteredCrPic[ xSrc ][ ySrc ] = OutC( outputTensor[ 0 ][ 0 ][ yP ][ xP ] ) |
| | else |
| | FilteredCrPic[ xSrc ][ ySrc ] = OutC( outputTensor[ 0 ][ yP ][ xP ][ 0 ] ) |
| | } |
| {{1}3 | for( yP = 0; yP < outPatchCHeight; yP++) |
| | for( xP = 0; xP < outPatchCWidth; xP++ ) { |
| | xSrc = cLeft * horCScaling + xP |
| | ySrc = cTop * verCScaling + yP |
| | if ( ySrc < nnpfc_pic_height_in_luma_samples / outSubHeightC && |
| | xSrc < nnpfc_pic_width_in_luma_samples / outSubWidthC ) |
| | if( nnpfc_component_last_flag = = 0 ) { |
| | FilteredCbPic[ xSrc ][ ySrc ] = OutC( outputTensor[ 0 ][ 0 ][ yP ][ xP ] ) |
| | FilteredCrPic[ xSrc ][ ySrc ] = OutC( outputTensor[ 0 ][ 1 ][ yP ][ xP ] ) |
| | } else { |
| | FilteredCbPic[ xSrc ][ ySrc ] = OutC( outputTensor[ 0 ][ yP ][ xP ][ 0 ] ) |
| | FilteredCrPic[ xSrc ][ ySrc ] = OutC( outputTensor[ 0 ][ yP ][ xP ][ 1 ] ) |
| | } |
| | } |
| 4 | for( yP = 0; yP < outPatchHeight; yP++) |
| | for( xP = 0; xP < outPatchWidth; xP++ ) { |
| | yY = cTop * outPatchHeight / inpPatchHeight + yP |
| | xY = cLeft * outPatchWidth / inpPatchWidth + xP |
| | yC = yY / outSubHeightC |
| | xC = xY / outSubWidth C |
| | yPc = ( yP / outSubHeightC ) * outSubHeightC |
| | xPc = ( xP / outSubWidthC ) * outSubWidthC |
| | if ( yY < nnpfc_pic_height_in_luma_samples && xY < |
| | nnpfc_pic_width_in_luma_samples) |
| | if( nnpfc_component_last_flag = = 0 ) { |
| | FilteredYPic[ xY ][ yY ] = OutY( outputTensor[ 0 ][ 0 ][ yP ][ xP ] ) |
| | FilteredCbPic[ xC ][ yC ] = OutC( outputTensor[ 0 ][ 1 ][ yPc ][ xPc ] ) |
| | } else { |
| | FilteredYPic[ xY ][ yY ] = OutY( outputTensor[ 0 ][ yP ][ xP ][ 0 ] ) |
| | FilteredCbPic[ xC ][ yC ] = OutC( outputTensor[ 0 ][ yPc ][ xPc ][ 1 ] ) |
| | } |
| | } |
| 5 | for( yP = 0; yP < outPatchHeight; yP++) |
| | for( xP = 0; xP < outPatchWidth; xP++ ) { |
| | yY = cTop * outPatchHeight / inpPatchHeight + yP |
| | xY = cLeft * outPatchWidth / inpPatchWidth + xP |
| | yC = yY / outSubHeightC |
| | xC = xY / outSubWidthC |
| | yPc = ( yP / outSubHeightC ) * outSubHeightC |
| | xPc = ( xP / outSubWidthC ) * outSubWidthC |
| | if ( yY < nnpfc_pic_height_in_luma_samples && xY < |
| | nnpfc_pic_width_in_luma_samples) |
| | if( nnpfc_component_last_flag = = 0 ) { |
| | FilteredYPic[ xY ][ yY ] = OutY( outputTensor[ 0 ][ 0 ][ yP ][ xP ] ) |
| | FilteredCrPic[ xC ][ yC ] = OutC( outputTensor[ 0 ][ 1 ][ yPc ][ xPc ] ) |
| | } else { |
| | FilteredYPic[ xY ][ yY ] = OutY( outputTensor[ 0 ][ yP ][ xP ][ 0 ] ) |
| | FilteredCrPic[ xC ][ yC ] = OutC( outputTensor[ 0 ][ yPc ][ xPc ][ 1 ] ) |
| | } |
| | } |
| {{2}6 | for( yP = 0; yP < outPatchHeight; yP++) |
| | for( xP = 0; xP < outPatchWidth; xP++ ) { |
| | yY = cTop * outPatchHeight / inpPatchHeight + yP |
| | xY = cLeft * outPatchWidth / inpPatchWidth + xP |
| | yC = yY / outSubHeightC |
| | xC = xY / outSubWidthC |
| | yPc = ( yP / outSubHeightC ) * outSubHeightC |
| | xPc = ( xP / outSubWidthC ) * outSubWidthC |
| | if ( yY < nnpfc_pic_height_in_luma_samples && xY < |
| | nnpfc_pic_width_in_luma_samples) |
| | if( nnpfc_component_last_flag = = 0 ) { |
| | FilteredYPic[ xY ][ yY ] = OutY( outputTensor[ 0 ][ 0 ][ yP ][ xP ] ) |
| | FilteredCbPic[ xC ][ yC ] = OutC( outputTensor[ 0 ][ 1 ][ yPc ][ xPc ] ) |
| | FilteredCrPic[ xC ][ yC ] = OutC( outputTensor[ 0 ][ 2 ][ yPc ][ xPc ] ) |
| | } else { |
| | FilteredYPic[ xY ][ yY ] = OutY( outputTensor[ 0 ][ yP ][ xP ][ 0 ] ) |
| | FilteredCbPic[ xC ][ yC ] = OutC( outputTensor[ 0 ][ yPc ][ xPc ][ 1 ] ) |
| | FilteredCrPic[ xC ][ yC ] = OutC( outputTensor[ 0 ][ yPc ][ xPc ][ 2 ] ) |
| | } |
| | } |
| 7 | for( yP = 0; yP < outPatchHeight; yP++ ) |
| | for( xP = 0; xP < outPatchWidth; xP++ ) { |
| | ySrc = cTop / 2 * outPatchHeight / inpPatchHeight + yP |
| | xSrc = cLeft / 2 * outPatchWidth / inpPatchWidth + xP |
| | if ( ySrc < nnpfc_pic_height_in_luma_samples / 2 && |
| | xSrc < nnpfc_pic_width_in_luma_samples / 2) |
| | if( nnpfc_component_last_flag = = 0 ) { |
| | FilteredYPic[ xSrc * 2 ][ ySrc * 2 ] = OutY( outputTensor[ 0 ][ 0 ][ yP ][ xP ] ) |
| | FilteredYPic[ xSrc * 2 + 1 ][ ySrc * 2 ] = OutY( outputTensor[ 0 ][ 1 ][ yP ][ xP ] ) |
| | FilteredYPic[ xSrc * 2 ][ ySrc * 2 + 1 ] = OutY( outputTensor[ 0 ][ 2 ][ yP ][ xP ] ) |
| | FilteredYPic[ xSrc * 2 + 1][ ySrc * 2 + 1 ] = |
| | OutY( outputTensor[ 0 ][ 3 ][ yP ][ xP ] ) |
| | FilteredCbPic[ xSrc ][ ySrc ] = OutC( outputTensor[ 0 ][ 4 ][ yP ][ xP ] ) |
| | } else { |
| | FilteredYPic[ xSrc * 2 ][ ySrc * 2 ] = OutY( outputTensor[ 0 ][ yP ][ xP ][ 0 ] ) |
| | FilteredYPic[ xSrc * 2 + 1 ][ ySrc * 2 ] = OutY( outputTensor[ 0 ][ yP ][ xP ][ 1 ] ) |
| | FilteredYPic[ xSrc * 2 ][ ySrc * 2 + 1 ] = OutY( outputTensor[ 0 ][ yP ][ xP ][ 2 ] ) |
| | FilteredYPic[ xSrc * 2 + 1][ ySrc * 2 + 1 ] = |
| | OutY( outputTensor[ 0 ][ yP ][ xP ][ 3 ] ) |
| | FilteredCbPic[ xSrc ][ ySrc ] = OutC( outputTensor[ 0 ][ yP ][ xP ][ 4 ] ) |
| | } |
| | } |
| 8 | for( yP = 0; yP < outPatchHeight; yP++ ) |
| | for( xP = 0; xP < outPatchWidth; xP++ ) { |
| | ySrc = cTop / 2 * outPatchHeight / inpPatchHeight + yP |
| | xSrc = cLeft / 2 * outPatchWidth / inpPatchWidth + xP |
| | if ( ySrc < nnpfc_pic_height_in_luma_samples / 2 && |
| | xSrc < nnpfc_pic_width_in_luma_samples / 2 ) |
| | if( nnpfc_component_last_flag = = 0 ) { |
| | FilteredYPic[ xSrc * 2 ][ ySrc * 2 ] = OutY( outputTensor[ 0 ][ 0 ][ yP ][ xP ] ) |
| | FilteredYPic[ xSrc * 2 + 1 ][ ySrc * 2 ] = OutY( outputTensor[ 0 ][ 1 ][ yP ][ xP ] ) |
| | FilteredYPic[ xSrc * 2 ][ ySrc * 2 + 1 ] = OutY( outputTensor[ 0 ][ 2 ][ yP ][ xP ] ) |
| | FilteredYPic[ xSrc * 2 + 1][ ySrc * 2 + 1 ] = |
| | OutY( outputTensor[ 0 ][ 3 ][ yP ][ xP ] ) |
| | FilteredCrPic[ xSrc ][ ySrc ] = OutC( outputTensor[ 0 ][ 4 ][ yP ][ xP ] ) |
| | } else { |
| | FilteredYPic[ xSrc * 2 ][ ySrc * 2 ] = OutY( outputTensor[ 0 ][ yP ][ xP ][ 0 ] ) |
| | FilteredYPic[ xSrc * 2 + 1 ][ ySrc * 2 ] = OutY( outputTensor[ 0 ][ yP ][ xP ][ 1 ] ) |
| | FilteredYPic[ xSrc * 2 ][ ySrc * 2 + 1 ] = OutY( outputTensor[ 0 ][ yP ][ xP ][ 2 ] ) |
| | FilteredYPic[ xSrc * 2 + 1][ ySrc * 2 + 1 ] = |
| | OutY( outputTensor[ 0 ][ yP ][ xP ][ 3 ] ) |
| | FilteredCrPic[ xSrc ][ ySrc ] = OutC( outputTensor[ 0 ][ yP ][ xP ][ 4 ] ) |
| | } |
| | } |
| {{3}9 | for( yP = 0; yP < outPatchHeight; yP++ ) |
| | for( xP = 0; xP < outPatchWidth; xP++ ) { |
| | ySrc = cTop / 2 * outPatchHeight / inpPatchHeight + yP |
| | xSrc = cLeft / 2 * outPatchWidth / inpPatchWidth + xP |
| | if ( ySrc < nnpfc_pic_height_in_luma_samples / 2 && |
| | xSrc < nnpfc_pic_width_in_luma_samples / 2 ) |
| | if( nnpfc_component_last_flag = = 0 ) { |
| | FilteredYPic[ xSrc * 2 ][ ySrc * 2 ] = OutY( outputTensor[ 0 ][ 0 ][ yP ][ xP ] ) |
| | FilteredYPic[ xSrc * 2 + 1 ][ ySrc * 2 ] = OutY( outputTensor[ 0 ][ 1 ][ yP ][ xP ] ) |
| | FilteredYPic[ xSrc * 2 ][ ySrc * 2 + 1 ] = OutY( outputTensor[ 0 ][ 2 ][ yP ][ xP ] ) |
| | FilteredYPic[ xSrc * 2 + 1][ ySrc * 2 + 1 ] = OutY( outputTensor[ 0 ][ 3 ][ yP ][ xP ] ) |
| | FilteredCbPic[ xSrc ][ ySrc ] = OutC( outputTensor[ 0 ][ 4 ][ yP ][ xP ] ) |
| | FilteredCrPic[ xSrc ][ ySrc ] = OutC( outputTensor[ 0 ][ 5 ][ yP ][ xP ] ) |
| | } else { |
| | FilteredYPic[ xSrc * 2 ][ ySrc * 2 ] = OutY( outputTensor[ 0 ][ yP ][ xP ][ 0 ] ) |
| | FilteredYPic[ xSrc * 2 + 1 ][ ySrc * 2 ] = OutY( outputTensor[ 0 ][ yP ][ xP ][ 1 ] ) |
| | FilteredYPic[ xSrc * 2 ][ ySrc * 2 + 1 ] = OutY( outputTensor[ 0 ][ yP ][ xP ][ 2 ] ) |
| | FilteredYPic[ xSrc * 2 + 1][ ySrc * 2 + 1 ] = OutY( outputTensor[ 0 ][ yP ][ xP ][ 3 ] ) |
| | FilteredCbPic[ xSrc ][ ySrc ] = OutC( outputTensor[ 0 ][ yP ][ xP ][ 4 ] ) |
| | FilteredCrPic[ xSrc ][ ySrc ] = OutC( outputTensor[ 0 ][ yP ][ xP ][ 5 ] ) |
| | } |
| | } |
| 4 . . . 255 | reserved |

A base post-processing filter for a cropped decoded output picture picA is the filter that is identified by the first neural-network post-filter characteristics SEI message, in decoding order, that has a particular nnpfc_id value within a CLVS.

If there is another neural-network post-filter characteristics SEI message that has the same nnpfc_id value, has nnpfc_mode_idc equal to 1, has different content than the neural-network post-filter characteristics SEI message that defines the base post-processing filter, and pertains to the picture picA, the base post-processing filter is updated by decoding the ISO/IEC 15938-17 bitstream in that neural-network post-filter characteristics SEI message to obtain a post-processing filter PostProcessingFilter( ) Otherwise, the post-processing processing filter PostProcessingFilter( ) is assigned to be the same as the base post-processing filter.

The following process is used to filter the cropped decoded output picture with the post-processing filter PostProcessingFilter( ) to generate the filtered picture, which contains Y, Cb, and Cr sample arrays FilteredYPic, FilteredCbPic, and FilteredCrPic, respectively, as indicated by nnpfc_out_order_idc.

```
if( nnpfc_inp_order_idc = = 0 )
  for( cTop = 0; cTop < CroppedHeight; cTop += inpPatchHeight )
    for( cLeft = 0; cLeft < CroppedWidth; cLeft += inpPatchWidth ) {
      DeriveInputTensors( )
      outputTensor = PostProcessingFilter( inputTensor )
      StoreOutputTensors( )
    }
else if( nnpfc_inp_order_idc = = 1 )
  for( cTop = 0; cTop < CroppedHeight / SubHeightC; cTop += inpPatchHeight )
    for( cLeft = 0; cLeft < CroppedWidth / SubWidthC; cLeft += inpPatchWidth ) {
      DeriveInputTensors( )
      outputTensor = PostProcessingFilter( inputTensor )
      StoreOutputTensors( )
    }
else if( nnpfc_inp_order_idc = = 2 )
  for( cTop = 0; cTop < CroppedHeight; cTop += inpPatchHeight) (85)
    for( cLeft = 0; cLeft < CroppedWidth; cLeft += inpPatchWidth) {
      DeriveInputTensors( )
      outputTensor = PostProcessingFilter( inputTensor )
      Store OutputTensors( )
    }
else if( nnpfc_inp_order_idc = = 3 )
  for( cTop = 0; cTop < CroppedHeight; cTop += inpPatchHeight * 2 )
    for( cLeft = 0; cLeft < CroppedWidth; cLeft += inpPatchWidth * 2 ) {
      DeriveInputTensors( )
      outputTensor = PostProcessingFilter( inputTensor )
      StoreOutputTensors( )
    }
```

### 6.3. Embodiment 3

This embodiment is for the case when a video unit is a picture for the embodiment item 4 summarized above in Section 5.

### Neural-Network Post-Filter Characteristics SEI Message Semantics

nnpfc_inp_order_idc indicates the method of ordering the sample arrays of a cropped decoded output picture as the input to the post-processing filter. Table 2 contains an informative description of nnpfc_inp_order_idc values. The semantics of nnpfc_inp_order_idc in the range of 0 to 3, inclusive, are specified in Table 12, which specifies a process for deriving the input tensors inputTensor for different values of nnpfc_inp_order_idc and a given vertical sample coordinate cTop and a horizontal sample coordinate cLeft specifying the top-left sample location for the patch of samples included in the input tensors. When the chroma format of the cropped decoded output picture is not 4:2:0, nnpfc_inp_order_idc shall not be equal to 3. The value of nnpfc_inp_order_idc shall be in the range of 0 to 255, inclusive. Values of nnpfc_inp_order_idc greater than 3 are reserved for future specification by ITU-T| ISO/IEC and shall not be present in bitstreams conforming to this version of this Specification. Decoders conforming to this version of this Specification shall ignore SEI messages that contain reserved values of nnpfc_inp_order_idc.

A patch is a rectangular array of samples from a component (e.g., a luma or chroma component) of a picture. nnpfc_constant_patch_size_flag equal to 0 specifies that the post-processing filter accepts any patch size that is a positive integer multiple of the patch size indicated by nnpfc_patch_width_minus1 and nnpfc_patch_height_minus1 as input. When nnpfc_constant_patch_size_flag is equal to 0 the patch size width shall be less than or equal to CroppedWidth. When nnpfc_constant_patch_size_flag is equal to 0 the patch size height shall be less than or equal to CroppedHeight. nnpfc_constant_patch_size_flag equal to 1 specifies that the post-processing filter accepts exactly the patch size indicated by nnpfc_patch_width_minus1 and nnpfc_patch_height_minus1 as input.

nnpfc_patch_width_minus1+1, when nnpfc_constant_patch_size_flag equal to 1, specifies the horizontal sample counts of the patch size required for the input to the post-processing filter. When nnpfc_constant_patch_size_flag is equal to 0, any positive integer multiple of (nnpfc_patch_width_minus1+1) may be used as the horizontal sample counts of the patch size used for the input to the post-processing filter. The value of nnpfc_patch_width_minus1 shall be in the range of 0 to Min (32766, CroppedWidth−1), inclusive.

nnpfc_patch_height_minus1+1, when nnpfc_constant_patch_size_flag equal to 1, specifies the vertical sample counts of the patch size required for the input to the post-processing filter. When nnpfc_constant_patch_size_flag is equal to 0, any positive integer multiple of (nnpfc_patch_height_minus1+1) may be used as the vertical sample counts of the patch size used for the input to the post-processing filter. The value of nnpfc_patch_height_minus1 shall be in the range of 0 to Min (32766, CroppedHeight−1), inclusive. nnpfc_overlap specifies the overlapping horizontal and vertical sample counts of adjacent input tensors of the post-processing filter. The value of nnpfc_overlap shall be in the range of 0 to 16383, inclusive. The variables inpPatch Width, inpPatchHeight, outPatchWidth, outPatchHeight, horCScaling, verCScaling, outPatchCWidth, outPatchCHeight, and overlapSize are derived as follows:

$$inpPatchWidth = nnpfc\_patch \_width \_minus1 + 1 \qquad ( 79 )$$

$$inpPatch Height = nnpfc\_patch \_ height \_minus1 + 1$$

$$outPatchWidth = ( nnpfc\_pic \_width \_in \_luma \_samples * inpPatchWidth ) / CroppedWidth$$

$$outPatchHeight = ( nnpfc\_pic \_height \_in \_luma \_samples * inpPatchHeight ) / CroppedHeight$$

$$horCScaling = SubWidthC / outSubWidthC$$

$$verCScaling = SubHeightC / outSubHeightC$$

$$outPatchCWidth = outPatchWidth * horCScaling$$

$$outPatchCHeight = outPatchHeight * verCScaling$$

$$overlapSize = nnpfc\_overlap$$

It is a requirement of bitstream conformance that outPatchWidth*CroppedWidth shall be equal to nnpfc_pic_width_in_luma_samples*inpPatchWidth and outPatchHeight*CroppedHeight shall be equal to nnpfc_pic_height_in_luma_samples*inpPatchHeight.

nnpfc_padding_type specifies the process of padding when referencing sample locations outside the boundaries of the cropped decoded output picture as described in Table 3. The value of nnpfc_padding_type shall be in the range of 0 to 15, inclusive.

nnpfc_luma_padding_val specifies the luma value to be used for padding when nnpfc_padding_type is equal to 4. nnpfc_cb_padding_val specifies the Cb value to be used for padding when nnpfc_padding_type is equal to 4. nnpfc_cr_padding_val specifies the Cr value to be used for padding when nnpfc_padding_type is equal to 4. The function InpSampleVal(y, x, picHeight, picWidth, croppedPic) with inputs being a vertical sample location y, a horizontal sample location x, a picture height picHeight, a picture width picWidth, and sample array croppedPic returns the value of sample Val derived as follows:

```
if( nnpfc_padding_type = = 0 )
  if( y < 0 || x < 0 || y >= picHeight || x >= picWidth )
    sampleVal = 0
  else
sampleVal = croppedPic[ x ][ y ] (80)
else if( nnpfc_padding_type = = 1 )
  sampleVal = croppedPic[ Clip3( 0, picWidth − 1, x ) ][ Clip3( 0, picHeight − 1, y ) ]
else if( nnpfc_padding_type = = 2 )
  sampleVal = croppedPic[ Reflect( picWidth − 1, x ) ][ Reflect( picHeight − 1, y ) ]
else if( nnpfc_padding_type = = 3 )
  if(y >= 0 && y < picHeight)
    sampleVal = croppedPic[ Wrap( picWidth − 1, x ) ][ y ]
else if( nnpfc_padding_type = = 4 )
  if( y < 0 || x <0 || y >= picHeight || x >= picWidth )
    sampleVal[ 0 ] = nnpfc_luma_padding_val
    sampleVal[ 1 ] = nnpfc_cb_padding_val
    sampleVal[ 2 ] = nnpfc_cr_padding_val
  else
    sampleVal = croppedPic[ x ][ y ]
```

TABLE 12
Process for deriving the input tensors inputTensor for a given vertical sample
coordinate cTop and a horizontal sample coordinate cLeft specifying the top-
left sample location for the patch of samples included in the input tensors

| nnpfc_inp_{—} | | |
|---|---|---|
| order_idc | Process DeriveInputTensors( ) for deriving input tensors | |
| 0 | for( yP = −overlapSize; yP < inpPatchHeight + overlapSize; yP++) | |
| | for( xP = −overlapSize; xP < inpPatchWidth + overlapSize; xP++ ) { | |
| | inpVal = InpY( InpSampleVal( cTop + yP, cLeft + xP, CroppedHeight, | |
| | | CroppedWidth, CroppedYPic ) ) |
| | if( nnpfc_component_last_flag = = 0 ) | |
| | | inputTensor[ 0 ][ 0 ][ yP + overlapSize ][ xP + overlapSize ] = inpVal |
| | else | |
| | | inputTensor[ 0 ][ yP + overlapSize ][ xP + overlapSize ][ 0 ] = inpVal |
| | if(nnpfc_auxiliary_inp_idc = = 1) { | |
| | | if( nnpfc_component_last_flag = = 0 ) |
| | | inputTensor[ 0 ][ 1 ][ yP + overlapSize ][ xP + overlapSize ] = 2^{(StrengthControlVal - 42)/6} |
| | | else |
| | | inputTensor[ 0 ][ yP + overlapSize ][ xP + overlapSize ][ 1 ] = 2^{(StrengthControlVal - 42)/6} |
| | } | |
| | } | |
| 1 | for( yP = −overlapSize; yP < inpPatchHeight + overlapSize; yP++) | |
| | for( xP = −overlapSize; xP < inpPatchWidth + overlapSize; xP++ ) { | |
| | inpCbVal = InpC( InpSampleVal( cTop + yP, cLeft + xP, CroppedHeight / SubHeightC, | |
| | | CroppedWidth / SubWidthC, CroppedCbPic ) ) |
| | inpCrVal = InpC( InpSampleVal( cTop + yP, cLeft + xP, CroppedHeight / SubHeightC, | |
| | | CroppedWidth / SubWidthC, CroppedCrPic ) ) |
| | if( nnpfc_component_last_flag = = 0 ) { | |
| | | inputTensor[ 0 ][ 0 ][ yP + overlapSize ][ xP + overlapSize ] = inpCbVal |
| | | inputTensor[ 0 ][ 1 ][ yP + overlapSize ][ xP + overlapSize ] = inpCrVal |
| | } else { | |
| | | inputTensor[ 0 ][ yP + overlapSize ][ xP + overlapSize ][ 0 ] = inpCbVal |
| | | inputTensor[ 0 ][ yP + overlapSize ][ xP + overlapSize ][ 1 ] = inpCrVal |
| | } | |
| | if(nnpfc_auxiliary_inp_idc = = 1) { | |
| | | if( nnpfc_component_last_flag = = 0 ) |
| | | inputTensor[ 0 ][ 2 ][ yP + overlapSize ][ xP + overlapSize ] = 2^{(StrengthControlVal - 42)/6} |
| | | else |
| | | inputTensor[ 0 ][ yP + overlapSize ][ xP + overlapSize ][ 2 ] = 2^{(StrengthControlVal - 42)/6} |
| | } | |
| | } | |
| 2 | for( yP = −overlapSize; yP < inpPatchHeight + overlapSize; yP++) | |
| | for( xP = −overlapSize; xP < inpPatchWidth + overlapSize; xP++ ) { | |
| | yY = cTop + yP | |
| | xY = cLeft + xP | |
| | yC = yY / SubHeightC | |
| | xC = xY / SubWidthC | |
| | inpYVal = InpY( InpSampleVal( yY, xY, CroppedHeight, | |
| | | CroppedWidth, CroppedYPic ) ) |
| | inpCbVal = InpC( InpSampleVal( yC, xC, CroppedHeight / SubHeightC, | |
| | | CroppedWidth / SubWidthC, CroppedCbPic ) ) |
| | inpCrVal = InpC( InpSampleVal( yC, xC, CroppedHeight / SubHeightC, | |
| | | CroppedWidth / SubWidthC, CroppedCrPic ) ) |
| | if( nnpfc_component_last_flag = = 0 ) { | |
| | | inputTensor[ 0 ][ 0 ][ yP + overlapSize ][ xP + overlapSize ] = inpYVal |
| | | inputTensor[ 0 ][ 1 ][ yP + overlapSize ][ xP + overlapSize ] = inpCbVal |
| | | inputTensor[ 0 ][ 2 ][ yP + overlapSize ][ xP + overlapSize ] = inpCrVal |
| | } else { | |
| | | inputTensor[ 0 ][ yP + overlapSize ][ xP + overlapSize ][ 0 ] = inpYVal |
| | | inputTensor[ 0 ][ yP + overlapSize ][ xP + overlapSize ][ 1 ] = inpCbVal |
| | | inputTensor[ 0 ][ yP + overlapSize ][ xP + overlapSize ][ 2 ] = inpCrVal |
| | } | |
| | if(nnpfc_auxiliary_inp_idc = = 1) { | |
| | | if( nnpfc_component_last_flag = = 0 ) |
| | | inputTensor[ 0 ][ 3 ][ yP + overlapSize ][ xP + overlapSize ] = 2^{(StrengthControlVal - 42)/6} |
| | | else |
| | | inputTensor[ 0 ][ yP + overlapSize ][ xP + overlapSize ][ 3 ] = 2^{(StrengthControlVal - 42)/6} |
| | } | |
| | } | |
| 3 | for( yP = −overlapSize; yP < inpPatchHeight + overlapSize; yP++) | |
| | for( xP = −overlapSize; xP < inpPatchWidth + overlapSize; xP++ ) { | |
| | yTL = cTop + yP *2 | |
| | xTL = cLeft + xP * 2 | |
| | yBR = yTL + 1 | |
| | xBR = xTL + 1 | |
| | yC = cTop / 2 + yP | |
| | xC = cLeft / 2 + xP | |
| | inpTLVal = InpY( InpSampleVal( yTL, xTL, CroppedHeight, | |
| | | CroppedWidth, CroppedYPic ) ) |
| | inpTRVal = InpY( InpSampleVal( yTL, xBR, CroppedHeight, | |
| | | CroppedWidth, CroppedYPic ) ) |
| | inpBLVal = InpY( InpSampleVal( yBR, xTL, CroppedHeight, | |
| | | CroppedWidth, CroppedYPic ) ) |
| | inpBRVal = InpY( InpSampleVal( yBR, xBR, CroppedHeight, | |
| | | CroppedWidth, CroppedYPic ) ) |
| | inpCbVal = InpC( InpSampleVal( yC, xC, CroppedHeight / 2, | |
| | | CroppedWidth / 2, CroppedCbPic ) ) |
| | inpCrVal = InpC( InpSampleVal( yC, xC, CroppedHeight / 2, | |
| | | CroppedWidth / 2, CroppedCrPic ) ) |
| | if( nnpfc_component_last_flag = = 0 ) { | |
| | | inputTensor[ 0 ][ 0 ][ yP + overlapSize ][ xP + overlapSize ] = inpTLVal |
| | | inputTensor[ 0 ][ 1 ][ yP + overlapSize ][ xP + overlapSize ] = inpTRVal |
| | | inputTensor[ 0 ][ 2 ][ yP + overlapSize ][ xP + overlapSize ] = inpBLVal |
| | | inputTensor[ 0 ][ 3 ][ yP + overlapSize ][ xP + overlapSize ] = inpBRVal |
| | | inputTensor[ 0 ][ 4 ][ yP + overlapSize ][ xP + overlapSize ] = inpCbVal |
| | | inputTensor[ 0 ][ 5 ][ yP + overlapSize ][ xP + overlapSize ] = inpCrVal |
| | {{ | inputTensor[ 0 ][ 6 ][ yP + overlapSize ][ xP + overlapSize ] = 2^{(StrengthControlVal - 42 )/6} }} |

} else {

inputTensor[ 0 ][ yP + overlapSize ][ xP + overlapSize ][ 0 ] = inpTLVal
inputTensor[ 0 ][ yP + overlapSize ][ xP + overlapSize ][ 1 ] = inpTRVal
inputTensor[ 0 ][ yP + overlapSize ][ xP + overlapSize ][ 2 ] = inpBLVal
inputTensor[ 0 ][ yP + overlapSize ][ xP + overlapSize ][ 3 ] = inpBRVal
inputTensor[ 0 ][ yP + overlapSize ][ xP + overlapSize ][ 4 ] = inpCbVal
inputTensor[ 0 ][ yP + overlapSize ][ xP + overlapSize ][ 5 ] = inpCrVal }

if(nnpfc_auxiliary_inp_idc = = 1) {

```
if( nnpfc_component_last_flag = = 0 )
  inputTensor[ 0 ][ 6 ][ yP + overlapSize ][ xP + overlapSize ] = 2^{(StrengthControlVal - 42)/6}
else
  inputTensor[ 0 ][ yP + overlapSize ][ xP + overlapSize ][ 6 ] = 2^{(StrengthControlVal - 42)/6}
```

| | |
|---|---|
| | } |
| | } |
| 4 . . . 255 | reserved |

nnpfc_complexity_idc greater than 0 specifies that one or more syntax elements that indicate the complexity of the post-processing filter associated with the nnpfc_id may be present. nnpfc_complexity_idc equal to 0 specifies that no syntax element that indicates the complexity of the post-processing filter associated with the nnpfc_id is present. The value nnpfc_complexity_idc shall be in the range of 0 to 255, inclusive. Values of nnpfc_complexity_idc greater than 1 are reserved for future specification by ITU-T|ISO/IEC and shall not be present in bitstreams conforming to this version of this Specification. Decoders conforming to this version of this Specification shall ignore SEI messages that contain reserved values of nnpfc_complexity_idc.

### 6.4. Embodiment 4

This embodiment is for the case when a video unit is a picture for the embodiment item 5 and its subitems summarized above in Section 5.

### Neural-Network Post-Filter Characteristics SEI Message Semantics

nnpfc_constant_patch_size_flag equal to 0 specifies that the post-processing filter accepts any patch size that is a positive integer multiple of the patch size indicated by nnpfc_patch_width_minus1 and nnpfc_patch_height_minus1 as input. When nnpfc_constant_patch_size_flag is equal to 0 the patch size width shall be less than or equal to CroppedWidth. When nnpfc_constant_patch_size_flag is equal to 0 the patch size height shall be less than or equal to CroppedHeight. nnpfc_constant_patch_size_flag equal to 1 specifies that the post-processing filter accepts exactly the patch size indicated by nnpfc_patch_width_minus1 and nnpfc_patch_height_minus1 as input.

nnpfc_patch_width_minus1+1, when nnpfc_constant_patch_size_flag equal to 1, specifies the horizontal sample counts of the patch size required for the input to the post-processing filter. When nnpfc_constant_patch_size_flag is equal to 0, any positive integer multiple of (nnpfc_patch_width_minus1+1) may be used as the horizontal sample counts of the patch size used for the input to the post-processing filter. The value of nnpfc_patch_width_minus1 shall be in the range of 0 to Min (32766, CroppedWidth−1), inclusive.

nnpfc_patch_height_minus1+1, when nnpfc_constant_patch_size_flag equal to 1, specifies the vertical sample counts of the patch size required for the input to the post-processing filter. When nnpfc_constant_patch_size_flag is equal to 0, any positive integer multiple of (nnpfc_patch_height_minus1+1) may be used as the vertical sample counts of the patch size used for the input to the post-processing filter. The value of nnpfc_patch_height_minus1 shall be in the range of 0 to Min (32766. CroppedHeight−1), inclusive.

Let the variables inpPatch Width and inpPatchHeight be the patch size width and the patch size height, respectively.

If nnpfc_constant_patch_size_flag is equal to 0, the following applies:
The values of inpPatchWidth and inpPatchHeight are provided by external means not specified in this document. For example, such external means may be an API that passes the values of inpPatch Width and inpPatchHeight to the decoder and render entity in a video application system, and the values may be configured by a user through a user interface of the application.
The value of inpPatch Width shall be a positive integer multiple of nnpfc_patch_width_minus1+1 and shall be less than or equal to CroppedWidth. The value of inpPatchHeight shall be a positive integer multiple of nnpfc_patch_height_minus1+1 and shall be less than or equal to CroppedHeight.

Otherwise (nnpfc_constant_patch_size_flag is equal to 1), the value of inpPatch Width is set equal to nnpfc_patch_width_minus1+1 and the value of inpPatchHeight is set equal to nnpfc_patch_height_minus1+1.

nnpfc_overlap specifies the overlapping horizontal and vertical sample counts of adjacent input tensors of the post-processing filter. The value of nnpfc_overlap shall be in the range of 0 to 16383, inclusive.

The variables {{inpPatchWidth, inpPatchHeight.}}outPatchWidth, outPatchHeight, horCScaling, verCScaling, outPatchCWidth, outPatchCHeight, and overlapSize are derived as follows:

$$\{ \{ inpPatchWidth = nnpfc\_patch \_width \_minus1 + 1 \qquad ( 79 )$$

$$inpPatch Height = nnpfc\_patch \_ height \_minus1 + 1 \} \}$$

$$outPatchWidth = ( nnpfc\_pic \_width \_in \_luma \_samples * inpPatchWidth ) / CroppedWidth$$

$$outPatchHeight = ( nnpfc\_pic \_height \_in \_luma \_samples * inpPatchHeight ) / CroppedHeight$$

$$horCScaling = SubWidthC / outSubWidthC$$

$$verCScaling = SubHeightC / outSubHeightC$$

$$outPatchCWidth = outPatchWidth * horCScaling$$

$$outPatchCHeight = outPatchHeight * verCScaling$$

$$overlapSize = nnpfc\_overlap$$

It is a requirement of bitstream conformance that outPatchWidth*CroppedWidth shall be equal to nnpfc_pic_width_in_luma_samples*inpPatchWidth and outPatchHeight*CroppedHeight shall be equal to nnpfc_pic_height_in_luma_samples*inpPatchHeight.

FIG. 5 illustrates a flowchart of a method 500 for video processing in accordance with embodiments of the present disclosure. The method 500 is implemented for a conversion between a current video unit of a video and a bitstream of the video. In some embodiments, the conversion between the current video unit and the bitstream may include encoding the current video unit into the bitstream. Alternatively, or in addition, the conversion may include decoding the current video unit from the bitstream.

At block 510, a neural network (NN) filter is applied to the current video unit at least based on auxiliary information associated with the current video unit. The auxiliary information includes at least one of: prediction information of the current video unit, partitioning information of the current video unit, or coding information of a previously coded video unit. For example, the neural network filter may be a neural network post-processing filter. In some example embodiments, the auxiliary information may further include quantization parameter-related data. That is, more auxiliary inputs other than the quantization parameter-related data may be input to the NN filter such as NN post-processing filter. At block 520, the conversion is performed based on the applying.

The method 500 enables applying the NN filter such as the NN post-processing filter based on more auxiliary input such as prediction information, partitioning information, and/or information from previously decoded video unit. In this way, such auxiliary information or auxiliary inputs may be very helpful in terms of improving the performance of the NN post-processing filtering. The coding efficiency and coding effectiveness for the video processing can thus be improved.

In some embodiments, the method 500 further comprises: determining whether a condition for excluding the auxiliary information from an input of the neural network is satisfied based on at least one syntax element in the bitstream; and in accordance with a determination that the condition is satisfied, applying the neural network to the current video unit without inputting the auxiliary information to the neural network filter.

In some embodiments, the at least one syntax element comprises: a first syntax element for indicating a rule of ordering sample arrays of a cropped decoded output picture as an input to the neural network filter, a second syntax element for specifying that a dimension in an input tensor to the neural network filter and an output tensor resulting from the neural network filter is used for a channel, and a third syntax element for indicating whether the auxiliary information is present in an input tensor of the neural-network filter. In some example embodiments, the condition is that the first syntax element is 3, the second syntax element is 0, and the third syntax element is 0. By way of example, if nnpfc_inp_order_idc is equal to 3, nnpfc_component_last_flag is equal to 0, and nnpfc_auxiliary_inp_idc is equal to 0, no auxiliary input matrix is used.

In some embodiments, the prediction information of the current video unit comprises at least one of: a prediction sample of the current video unit, or a prediction mode of the current video unit.

In some embodiments, the partitioning information of the current video unit comprises a partitioning boundary of the current video unit.

In some embodiments, the coding information of the previously coded video unit comprises: a sample of at least one of a collocated block or a motion compensated block in the previously coded video unit, the collocated block being collocated with a current video block in the current video unit, the motion compensated block being associated with the current video block. For example, the auxiliary input may include information from previously decoded pictures such as samples of collocated blocks or motion compensated blocks of current to-be-processed block in the previously decoded pictures.

In some embodiments, a first color component and a second color component of the current video unit share the same auxiliary information, or the first and second color components are allowed to share the same auxiliary information. That is, different color components share or are allowed to share the same auxiliary input.

In some embodiments, a first color component and a second color component of the current video unit use different auxiliary information, or the first and second color components are allowed to use different auxiliary information. That is, different color components use or are allowed to use different auxiliary inputs.

In some embodiments, a first chroma component and a second chroma component of the current video unit use or are allowed to use the same auxiliary information, and a luma component of the current video unit uses first auxiliary information different from second auxiliary information used by the first and second chroma components. For example, two chroma components use or allowed to use the same auxiliary input, which is different from the auxiliary input of the luma component.

In some embodiments, at least one matrix associated with the neural network filter comprises at least one of: a luma component, a first chroma component, or a second chroma component. That is, the matrices presented in the input and/or output tensor of an NN filter may include luma, and/or Cb, and/or Cr components, or any combination of these components.

In some embodiments, the at least one matrix comprises at least one of: an input matrix in an input tensor of the neural network filter, or an output matrix in an output tensor of the neural network filter.

In some embodiments, the at least one matrix comprises a chroma matrix, the number of channels of an input tensor or an output tensor of the neural network filter is 1. That is, only a chroma matrix is present in the input and/or output tensor, the number of channels is 1, and the component is Cb or Cr.

In some embodiments, the at least one matrix comprises a chroma matrix and a luma matrix including a luma component, the number of channels of an input tensor or an output tensor of the neural network filter is 2. That is, only a luma matrix and a chroma matrix are present in the input and/or output tensor, the number of channels is 2, and the components are luma and Cb or luma and Cr.

In some embodiments, the at least one matrix comprises a chroma matrix and four luma matrices including luma components, the number of channels of an input tensor or an output tensor of the neural network filter is 5. That is, only four luma matrices and one chroma matrix are present in the input and/or output tensor, the number of channels is 5, and the components are luma and Cb or luma and Cr.

In some embodiments, a chroma format of the current video unit is 4:2:0.

In some embodiments, the chroma matrix comprises one of: the first chroma component, or the second chroma component. By applying the NN filter to one of the two chroma components, the two chroma components can be processed separately.

In some embodiments, at least one type of visual quality improvement of the neural network filter is included in the bitstream. For example, one or more types of visual quality improvements may be defined.

In some embodiments, the at least one type is included in a neural network post-filter characteristics (NNPFC) supplemental enhancement information (SEI) message. That is, the visual quality improvement type of the NN filter with the visual quality improvement purpose may be signaled in the NNPFC SEI message.

In some embodiments, if a purpose of the neural network filter is visual quality improvement, the at least one type is included in the bitstream.

In some embodiments, the at least one type comprises at least one of: an objective-oriented type, a fidelity-oriented type, a subjective-oriented type, or a film grain-oriented type.

In some embodiments, the at least one type of visual quality improvement comprises the objective-oriented type or the fidelity-oriented type, and a fidelity of the current video unit is determined based on at least one of: a peak signal-to-noise ratio of the current video unit, or a multi scale structural similarity (Ms-SSIM) of the current video unit. That is, a type of visual quality improvement is defined as objective-oriented/fidelity-oriented, targeting at increasing the fidelity of the reconstructed picture after applying the neural-network post-processing filter. The fidelity may be measured by PSNR, Ms-SSIM, etc.

In some embodiments, the at least one type of visual quality improvement comprises the subjective-oriented type, and a subjective visual quality of the current video unit is determined based on at least one of: a learned perceptual image patch similarity (LPIPS) of the current video unit, or a mean opinion score (MOS) of the current video unit. That is, a type of visual quality improvement is defined as subjective-oriented, targeting at increasing the subjective visual quality of the reconstructed picture after applying the neural-network post-processing filter. The subjective visual quality may be measured by LPIPS, MOS, etc.

In some embodiments, the at least one type of visual quality improvement comprises the film grain-oriented type, and a film grain is obtained on a video unit reconstructed after applying the neural network filter to the current video unit. That is, a type of visual quality improvement is defined as film grain-oriented, with synthesizing film grain on the reconstructed picture after applying the neural-network post-processing filter.

In some cases, different video applications may prefer different types of visual quality improvements. For example, fidelity is important in surveillance scenario, but may not be so critical in some user-generated videos. By including the type of the visual quality improvement in the bitstream, the type of visual quality improvement can be identified by such as the decoder.

In some embodiments, the current video unit may be a picture, a slice or any other video unit.

In some embodiments, the method 500 further comprises: receiving a patch width and a patch height from an external source; and determining a patch size for an input of the neural network filter based on the patch width and the patch height. For example, the patch width (also be referred to as inpPatch Width) and the patch height (also referred to as inpPatchHeight) may be provided by external means not specified.

In some embodiments, the patch width and the patch height are received via an application programming interface. In some embodiments, the application programming interface is at a decoder associated with the conversion. In some embodiments, an entity associated with the video is rendered in a video application system, and the patch width and the patch height are configured by a user via a user interface of the video application system. For example, the external means may be an API that passes the values of inpPatch Width and inpPatchHeight to the decoder and render entity in a video application system, and the values may be configured by a user through a user interface of the application.

In some example embodiments, regardless of the value of nnpfc_constant_patch_size_flag, the patch size may be determined based on the received patch width and patch height. For example, regardless of the value of nnpfc_constant_patch_size_flag, the filtering process takes as input the patch size width inpPatch Width and the patch size height inpPatchHeight as specified below.

In some embodiments, the patch width is a positive integer multiple of a sum of a fourth syntax element in the bitstream and a predefined value such as 1, and the patch height is a positive integer multiple of a sum of a fifth syntax element in the bitstream and the predefined value.

In some embodiments, the fourth syntax element such as nnpfc_patch_width_minus1 indicates a horizontal sample count of a patch size required for inputting to the neural network filter. The fifth syntax element such as nnpfc_patch_height_minus1 indicates a vertical sample count of a patch size required for inputting to the neural network filter.

In some embodiments, the patch width is less than or equal to a threshold width, and the patch height is less than or equal to a threshold height.

In some embodiments, the threshold width such as CroppedWidth is a cropped coded output picture width of in units of luma samples, the threshold height such as CroppedHeight is a cropped coded output picture height in units of luma samples. The threshold width and the threshold height are included in the bitstream.

By way of example, the value of inpPatchWidth may be a positive integer multiple of nnpfc_patch_width_minus1+1 and may be less than or equal to CroppedWidth. The value of PatchSizeH may be a positive integer multiple of nnpfc_patch_height_minus1+1 and may be less than or equal to CroppedHeight.

In some embodiments, the method 500 further comprises: in accordance with a determination that a sixth syntax element such as nnpfc_constant_patch_size_flag in the bitstream is a first value such as 0, receiving the patch width and the patch height. That is, if nnpfc_constant_patch_size_flag is equal to 0, the patch size width, denoted by inpPatchWidth, and the patch size height, denoted by inpPatchHeight, are provided by external means.

In some embodiments, the method 500 further comprises: in accordance with a determination that the sixth syntax element is a second value such as 1, determining the patch width based on a fourth syntax element in the bitstream and a predefined value; and determining the patch height based on a fifth syntax element in the bitstream and the predefined value. For example, if nnpfc_constant_patch_size_flag is equal to 1, the value of inpPatch Width is set equal to nnpfc_patch_width_minus1+1 and the value of inpPatchHeight is set equal to nnpfc_patch_height_minus1+1.

In some embodiments, the sixth syntax element indicates that the neural network filter accepts a patch size being a positive integer multiple of a further patch size indicate by the fourth syntax element and the fifth syntax element.

In some embodiments, the fourth syntax element indicates a horizontal sample count of a patch size required for inputting to the neural network filter, and wherein the fifth syntax element indicates a vertical sample count of a patch size required for inputting to the neural network filter.

According to further embodiments of the present disclosure, a non-transitory computer-readable recording medium is provided. The non-transitory computer-readable recording medium stores a bitstream of a video which is generated by a method performed by an apparatus for video processing. In the method, a neural network filter is applied to a current video unit of the video at least based on auxiliary information associated with the current video unit. The auxiliary information includes at least one of: prediction information of the current video unit, partitioning information of the current video unit, or coding information of a previously coded video unit. The bitstream is generated based on the applying.

According to still further embodiments of the present disclosure, a method for storing bitstream of a video is provided. In the method, a neural network filter is applied to a current video unit of the video at least based on auxiliary information associated with the current video unit. The auxiliary information includes at least one of: prediction information of the current video unit, partitioning information of the current video unit, or coding information of a previously coded video unit. The bitstream is generated based on the applying. The bitstream is stored in a non-transitory computer-readable recording medium.

Implementations of the present disclosure can be described in view of the following clauses, the features of which can be combined in any reasonable manner.

Clause 1. A method for video processing, comprising: applying, for a conversion between a current video unit of a video and a bitstream of the video, a neural network filter to the current video unit at least based on auxiliary information associated with the current video unit, the auxiliary information including at least one of: prediction information of the current video unit, partitioning information of the current video unit, or coding information of a previously coded video unit; and performing the conversion based on the applying.

Clause 2. The method of clause 1, further comprising: determining whether a condition for excluding the auxiliary information from an input of the neural network is satisfied based on at least one syntax element in the bitstream; and in accordance with a determination that the condition is satisfied, applying the neural network to the current video unit without inputting the auxiliary information to the neural network filter.

Clause 3. The method of clause 2, wherein the at least one syntax element comprises: a first syntax element for indicating a rule of ordering sample arrays of a cropped decoded output picture as an input to the neural network filter, a second syntax element for specifying that a dimension in an input tensor to the neural network filter and an output tensor resulting from the neural network filter is used for a channel, and a third syntax element for indicating whether the auxiliary information is present in an input tensor of the neural-network filter, and wherein the condition is that the first syntax element is 3, the second syntax element is 0, and the third syntax element is 0.

Clause 4. The method of any of clauses 1-3, wherein the neural network filter comprises a neural network post-processing filter.

Clause 5. The method of any of clauses 1-4, wherein the prediction information of the current video unit comprises at least one of: a prediction sample of the current video unit, or a prediction mode of the current video unit.

Clause 6. The method of any of clauses 1-5, wherein the partitioning information of the current video unit comprises a partitioning boundary of the current video unit.

Clause 7. The method of any of clauses 1-5, wherein the coding information of the previously coded video unit comprises: a sample of at least one of a collocated block or a motion compensated block in the previously coded video unit, the collocated block being collocated with a current video block in the current video unit, the motion compensated block being associated with the current video block.

Clause 8. The method of any of clauses 1-7, wherein a first color component and a second color component of the current video unit share the same auxiliary information, or the first and second color components are allowed to share the same auxiliary information.

Clause 9. The method of any of clauses 1-7, wherein a first color component and a second color component of the current video unit use different auxiliary information, or the first and second color components are allowed to use different auxiliary information.

Clause 10. The method of any of clauses 1-7, wherein a first chroma component and a second chroma component of the current video unit use or are allowed to use the same auxiliary information, and a luma component of the current video unit uses first auxiliary information different from second auxiliary information used by the first and second chroma components.

Clause 11. The method of any of clauses 1-10, wherein at least one matrix associated with the neural network filter comprises at least one of: a luma component, a first chroma component, or a second chroma component.

Clause 12. The method of clause 11, wherein the at least one matrix comprises at least one of: an input matrix in an input tensor of the neural network filter, or an output matrix in an output tensor of the neural network filter.

Clause 13. The method of clause 11 or clause 12, wherein the at least one matrix comprises a chroma matrix, the number of channels of an input tensor or an output tensor of the neural network filter is 1.

Clause 14. The method of clause 11 or clause 12, wherein the at least one matrix comprises a chroma matrix and a luma matrix including a luma component, the number of channels of an input tensor or an output tensor of the neural network filter is 2.

Clause 15. The method of clause 11 or clause 12, wherein the at least one matrix comprises a chroma matrix and four luma matrices including luma components, the number of channels of an input tensor or an output tensor of the neural network filter is 5.

Clause 16. The method of clause 15, wherein a chroma format of the current video unit is 4:2:0.

Clause 17. The method of any of clauses 13-16, wherein the chroma matrix comprises one of: the first chroma component, or the second chroma component.

Clause 18. The method of any of clauses 1-17, wherein at least one type of visual quality improvement of the neural network filter is included in the bitstream.

Clause 19. The method of clause 18, wherein the at least one type is included in a neural network post-filter characteristics (NNPFC) supplemental enhancement information (SEI) message.

Clause 20. The method of clause 18 or clause 19, wherein if a purpose of the neural network filter is visual quality improvement, the at least one type is included in the bitstream.

Clause 21. The method of any of clauses 18-20, wherein the at least one type comprises at least one of: an objective-oriented type, a fidelity-oriented type, a subjective-oriented type, or a film grain-oriented type.

Clause 22. The method of clause 21, wherein the at least one type of visual quality improvement comprises the objective-oriented type or the fidelity-oriented type, and a fidelity of the current video unit is determined based on at least one of: a peak signal-to-noise ratio of the current video unit, or a multi scale structural similarity (Ms-SSIM) of the current video unit.

Clause 23. The method of clause 21, wherein the at least one type of visual quality improvement comprises the subjective-oriented type, and a subjective visual quality of the current video unit is determined based on at least one of: a learned perceptual image patch similarity (LPIPS) of the current video unit, or a mean opinion score (MOS) of the current video unit.

Clause 24. The method of clause 21, wherein the at least one type of visual quality improvement comprises the film grain-oriented type, and a film grain is obtained on a video unit reconstructed after applying the neural network filter to the current video unit.

Clause 25. The method of any of clauses 1-24, wherein the current video unit comprises a picture or a slice.

Clause 26. The method of any of clauses 1-25, further comprising: receiving a patch width and a patch height from an external source; and determining a patch size for an input of the neural network filter based on the patch width and the patch height.

Clause 27. The method of clause 26, wherein the patch width is a positive integer multiple of a sum of a fourth syntax element in the bitstream and a predefined value, and the patch height is a positive integer multiple of a sum of a fifth syntax element in the bitstream and the predefined value.

Clause 28. The method of clause 27, wherein the fourth syntax element indicates a horizontal sample count of a patch size required for inputting to the neural network filter, and wherein the fifth syntax element indicates a vertical sample count of a patch size required for inputting to the neural network filter.

Clause 29. The method of clause 27 or clauses 28, wherein the patch width is less than or equal to a threshold width, and the patch height is less than or equal to a threshold height.

Clause 30. The method of clause 29, wherein the threshold width is a cropped coded output picture width of in units of luma samples, the threshold height is a cropped coded output picture height in units of luma samples, and the threshold width and the threshold height are included in the bitstream.

Clause 31. The method of any of clauses 26-30, wherein the patch width and the patch height are received via an application programming interface.

Clause 32. The method of clause 31, wherein the application programming interface is at a decoder associated with the conversion.

Clause 33. The method of any of clauses 26-32, wherein an entity associated with the video is rendered in a video application system, and the patch width and the patch height are configured by a user via a user interface of the video application system.

Clause 34. The method of any of clauses 26-33, further comprising: in accordance with a determination that a sixth syntax element in the bitstream is a first value, receiving the patch width and the patch height.

Clause 35. The method of clause 34, further comprising: in accordance with a determination that the sixth syntax element is a second value, determining the patch width based on a fourth syntax element in the bitstream and a predefined value; and determining the patch height based on a fifth syntax element in the bitstream and the predefined value.

Clause 36. The method of clause 35, wherein the sixth syntax element indicates that the neural network filter accepts a patch size being a positive integer multiple of a further patch size indicate by the fourth syntax element and the fifth syntax element.

Clause 37. The method of clause 35 or clause 36, wherein the fourth syntax element indicates a horizontal sample count of a patch size required for inputting to the neural network filter, and wherein the fifth syntax element indicates a vertical sample count of a patch size required for inputting to the neural network filter.

Clause 38. The method of any of clauses 1-37, wherein the conversion includes encoding the current video unit into the bitstream.

Clause 39. The method of any of clauses 1-37, wherein the conversion includes decoding the current video unit from the bitstream.

Clause 40. An apparatus for video processing comprising a processor and a non-transitory memory with instructions thereon, wherein the instructions upon execution by the processor, cause the processor to perform a method in accordance with any of clauses 1-39.

Clause 41. A non-transitory computer-readable storage medium storing instructions that cause a processor to perform a method in accordance with any of clauses 1-39.

Clause 42. A non-transitory computer-readable recording medium storing a bitstream of a video which is generated by a method performed by an apparatus for video processing, wherein the method comprises: applying a neural network filter to a current video unit of the video at least based on auxiliary information associated with the current video unit, the auxiliary information including at least one of: prediction information of the current video unit, partitioning information of the current video unit, or coding information of a previously coded video unit; and generating the bitstream based on the applying.

Clause 43. A method for storing a bitstream of a video, comprising: applying a neural network filter to a current video unit of the video at least based on auxiliary information associated with the current video unit, the auxiliary information including at least one of: prediction information of the current video unit, partitioning information of the current video unit, or coding information of a previously coded video unit; generating the bitstream based on the applying; and storing the bitstream in a non-transitory computer-readable recording medium.

### Example Device

FIG. 6 illustrates a block diagram of a computing device 600 in which various embodiments of the present disclosure can be implemented. The computing device 600 may be implemented as or included in the source device 110 (or the video encoder 114 or 200) or the destination device 120 (or the video decoder 124 or 300).

It would be appreciated that the computing device 600 shown in FIG. 6 is merely for purpose of illustration, without suggesting any limitation to the functions and scopes of the embodiments of the present disclosure in any manner.

As shown in FIG. 6, the computing device 600 includes a general-purpose computing device 600. The computing device 600 may at least comprise one or more processors or processing units 610, a memory 620, a storage unit 630, one or more communication units 640, one or more input devices 650, and one or more output devices 660.

In some embodiments, the computing device 600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 600 can support any type of interface to a user (such as “wearable” circuitry and the like).

The processing unit 610 may be a physical or virtual processor and can implement various processes based on programs stored in the memory 620. In a multi-processor system, multiple processing units execute computer executable instructions in parallel so as to improve the parallel processing capability of the computing device 600. The processing unit 610 may also be referred to as a central processing unit (CPU), a microprocessor, a controller or a microcontroller.

The computing device 600 typically includes various computer storage medium. Such medium can be any medium accessible by the computing device 600, including, but not limited to, volatile and non-volatile medium, or detachable and non-detachable medium. The memory 620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 630 may be any detachable or non-detachable medium and may include a machine-readable medium such as a memory, flash memory drive, magnetic disk or another other media, which can be used for storing information and/or data and can be accessed in the computing device 600.

The computing device 600 may further include additional detachable/non-detachable, volatile/non-volatile memory medium. Although not shown in FIG. 6, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 640 communicates with a further computing device via the communication medium. In addition, the functions of the components in the computing device 600 can be implemented by a single computing cluster or multiple computing machines that can communicate via communication connections. Therefore, the computing device 600 can operate in a networked environment using a logical connection with one or more other servers, networked personal computers (PCs) or further general network nodes.

The input device 650 may be one or more of a variety of input devices, such as a mouse, keyboard, tracking ball, voice-input device, and the like. The output device 660 may be one or more of a variety of output devices, such as a display, loudspeaker, printer, and the like. By means of the communication unit 640, the computing device 600 can further communicate with one or more external devices (not shown) such as the storage devices and display device, with one or more devices enabling the user to interact with the computing device 600, or any devices (such as a network card, a modem and the like) enabling the computing device 600 to communicate with one or more other computing devices, if required. Such communication can be performed via input/output (I/O) interfaces (not shown).

In some embodiments, instead of being integrated in a single device, some or all components of the computing device 600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 600 may be used to implement video encoding/decoding in embodiments of the present disclosure. The memory 620 may include one or more video coding modules 625 having one or more program instructions. These modules are accessible and executable by the processing unit 610 to perform the functionalities of the various embodiments described herein.

In the example embodiments of performing video encoding, the input device 650 may receive video data as an input 670 to be encoded. The video data may be processed, for example, by the video coding module 625, to generate an encoded bitstream. The encoded bitstream may be provided via the output device 660 as an output 680.

In the example embodiments of performing video decoding, the input device 650 may receive an encoded bitstream as the input 670. The encoded bitstream may be processed, for example, by the video coding module 625, to generate decoded video data. The decoded video data may be provided via the output device 660 as the output 680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
applying, for a conversion between a current video unit of a video and a bitstream of the video, a neural network filter to the current video unit at least based on auxiliary information associated with the current video unit, the auxiliary information including at least one of:
prediction information of the current video unit,
partitioning information of the current video unit, or
coding information of a previously coded video unit; and
performing the conversion based on the applying.

2. The method of claim 1, further comprising:
determining whether a condition for excluding the auxiliary information from an input of the neural network is satisfied based on at least one syntax element in the bitstream; and
in accordance with a determination that the condition is satisfied, applying the neural network to the current video unit without inputting the auxiliary information to the neural network filter.

3. The method of claim 2, wherein the at least one syntax element comprises:
a first syntax element for indicating a rule of ordering sample arrays of a cropped decoded output picture as an input to the neural network filter,
a second syntax element for specifying that a dimension in an input tensor to the neural network filter and an output tensor resulting from the neural network filter is used for a channel, and
a third syntax element for indicating whether the auxiliary information is present in an input tensor of the neural network filter, and
wherein the condition is that the first syntax element is 3, the second syntax element is 0, and the third syntax element is 0.

4. The method of claim 1, wherein the neural network filter comprises a neural network post-processing filter.

5. The method of claim 1, wherein the prediction information of the current video unit comprises at least one of:
a prediction sample of the current video unit, or
a prediction mode of the current video unit.

6. The method of claim 1, wherein the partitioning information of the current video unit comprises a partitioning boundary of the current video unit.

7. The method of claim 1, wherein the coding information of the previously coded video unit comprises:
a sample of at least one of a collocated block or a motion compensated block in the previously coded video unit, the collocated block being collocated with a current video block in the current video unit, the motion compensated block being associated with the current video block.

8. The method of claim 1, wherein a first color component and a second color component of the current video unit share the same auxiliary information, or
the first and second color components are allowed to share the same auxiliary information.

9. The method of claim 1, wherein a first color component and a second color component of the current video unit use different auxiliary information, or
the first and second color components are allowed to use different auxiliary information.

10. The method of claim 1, wherein a first chroma component and a second chroma component of the current video unit use or are allowed to use the same auxiliary information, and
a luma component of the current video unit uses first auxiliary information different from second auxiliary information used by the first and second chroma components.

11. The method of claim 1, wherein at least one matrix associated with the neural network filter comprises at least one of: a luma component, a first chroma component, or a second chroma component,
wherein the at least one matrix comprises at least one of: an input matrix in an input tensor of the neural network filter, or an output matrix in an output tensor of the neural network filter, or
wherein the at least one matrix comprises a chroma matrix, the number of channels of an input tensor or an output tensor of the neural network filter is 1, or
wherein the at least one matrix comprises a chroma matrix and a luma matrix including a luma component, the number of channels of an input tensor or an output tensor of the neural network filter is 2, or
wherein the at least one matrix comprises a chroma matrix and four luma matrices including luma components, the number of channels of an input tensor or an output tensor of the neural network filter is 5, wherein a chroma format of the current video unit is 4:2:0.

12. The method of claim 1, wherein at least one type of visual quality improvement of the neural network filter is included in the bitstream,
wherein the at least one type is included in a neural network post-filter characteristics (NNPFC) supplemental enhancement information (SEI) message.

13. The method of claim 1, wherein the current video unit comprises a picture or a slice.

14. The method of claim 1, further comprising:
receiving a patch width and a patch height from an external source; and
determining a patch size for an input of the neural network filter based on the patch width and the patch height.

15. The method of claim 14, wherein the patch width is a positive integer multiple of a sum of a fourth syntax element in the bitstream and a predefined value, and
the patch height is a positive integer multiple of a sum of a fifth syntax element in the bitstream and the predefined value.

16. The method of claim 1, wherein the conversion includes encoding the current video unit into the bitstream.

17. The method of claim 1, wherein the conversion includes decoding the current video unit from the bitstream.

18. An apparatus for video processing comprising a processor and a non-transitory memory with instructions thereon, wherein the instructions upon execution by the processor, cause the processor to perform:
apply, for a conversion between a current video unit of a video and a bitstream of the video, a neural network filter to the current video unit at least based on auxiliary information associated with the current video unit, the auxiliary information including at least one of:
prediction information of the current video unit,
partitioning information of the current video unit, or
coding information of a previously coded video unit; and
perform the conversion based on the applying.

19. A non-transitory computer-readable storage medium storing instructions that cause a processor to perform a method comprising:
applying, for a conversion between a current video unit of a video and a bitstream of the video, a neural network filter to the current video unit at least based on auxiliary information associated with the current video unit, the auxiliary information including at least one of:
prediction information of the current video unit,
partitioning information of the current video unit, or
coding information of a previously coded video unit; and
performing the conversion based on the applying.

20. A non-transitory computer-readable recording medium storing a bitstream of a video which is generated by a method performed by an apparatus for video processing, wherein the method comprises:
applying a neural network filter to a current video unit of the video at least based on auxiliary information associated with the current video unit, the auxiliary information including at least one of:
prediction information of the current video unit,
partitioning information of the current video unit, or
coding information of a previously coded video unit; and
generating the bitstream based on the applying.
